(19) United States
(12) Patent Application Publication
(10) Pub. No.: US 2025/0279439 A1
(43) Pub. Date: Sep. 4, 2025

(54) HYBRID ELECTROCATALYST, ELECTRODE COMPRISING THE SAME AND THEIR METHOD OF MANUFACTURE

(71) Applicant: INSTITUT NATIONAL DE LA RECHERCHE SCIENTIFIQUE, QUEBEC CITY (CA)

(72) Inventors: MOHAMED MOHAMEDI, MONTREAL (CA); XIAOYING ZHENG, LONGUEIL (CA); ALONSO MORENO ZURIA, VERDUN (CA)

(21) Appl. No.: 18/858,746

(22) PCT Filed: Apr. 24, 2023
(86) PCT No.: PCT/CA2023/050552

§ 371 Date: Oct. 22, 2024

Related U.S. Application Data
(60) Provisional application No. 63/363,514, filed on Apr. 25, 2022.

(51) Int. Cl. H01M 4/90; H01M 4/88; H01M 8/10

(52) U.S. Cl. CPC H01M 4/9083; H01M 4/8867; H01M 4/8878; H01M 4/9016; H01M 4/9041; H01M 2008/1095

(57) ABSTRACT

Efficient and robust bifunctional electrocatalysts for both the oxygen reduction reaction and oxygen evolution reaction are required for renewable energy technologies such as fuel cells, water electrolysers and rechargeable metal-air batteries. To address this requirement an electrode is provided comprising carbon sphere chains (CSCs) upon a current collector, wherein the CSCs have a functionalized surface bearing oxygen-containing functional groups and manganese oxide (MnOx) nanorods attached to the functionalized surfaces of the CSCs. A manufacturing sequence for these electrodes is provided comprising providing a current collector having a surface that is catalytically active towards the growth of CSCs, growing CSCs on the catalytically active surface, functionalizing the surface of the CSCs, and growing MnOx nanorods on the functionalized surface.

### CROSS REFERENCE TO RELATED APPLICATIONS

This patent application claim the benefit of priority as a 371 national phase entry application of PCT/CA2023/050552 filed Apr. 24, 2023; which itself claims the benefit of priority to U.S. Provisional Patent Application 63/363,514 filed Apr. 25, 2022; the entire contents of each being incorporated herein by reference.

### FIELD OF THE INVENTION

The present invention relates to an electrocatalyst and an electrode comprising this electrocatalyst, as well as their method of manufacture. More specifically, the present invention is concerned with catalysts and electrodes that can catalyze both the oxygen reduction reaction (ORR) and the oxygen evolution reaction (OER).

### BACKGROUND OF THE INVENTION

Highly efficient and robust bifunctional electrocatalysts for both oxygen reduction reaction (ORR) and oxygen evolution reaction (OER) are urgently required for diverse renewable energy technologies such as fuel cells, water electrolysers and rechargeable metal-air batteries. Among metal-air batteries systems, rechargeable zinc-air batteries (ZABs) are increasingly attracting attention because of their high theoretical energy density of 1350 Wh/kg (O₂ excluded), low cost, environmental friendliness and high safety. However, the sluggish kinetics for ORR and OER at the air cathode greatly impedes their commercial application.

Several based-noble metal materials such as platinum (Pt), rubidium (Ru), and iridium (Ir) either in their pure states or in their oxidized ones have been widely investigated. Unfortunately, the limited reserves, high cost, and feeble durability of these noble-metal catalysts hinder their large-scale practical application, which cause the need to develop non-precious metal-based bifunctional ORR/OER electrocatalysts towards the deployment of ZAB technology.

To address this cost issue, several efforts are being made to investigate low content containing Pt or non-precious transition-metal alloy-, intermetallic-, nitride-, and phosphide-based materials such as platinum cobalt (PtCo), platinum nickel (PtNi), PtCoNi, iron cobalt (FeCo), NiCo, nitrogen doped nickel cobalt (NiCON) and phosphorous doped nickel cobalt (NiCoP) electrocatalysts for the ORR/OER.

Owing to their abundance, low toxicity, high resistance to corrosion, improved safety and low processing cost, transition metal oxides including spinel oxide, perovskite oxide, and rutile-type oxide can be excellent alternatives for ZAB cathodes. For example, manganese oxide (MnOₓ) has been tried, but its poor durability and low electrical conductivity prohibit its wide application in oxygen electrocatalysis. To remedy these problems, MnOₓ has been associated with Co or Ni and/or carbon nanostructures such as carbon nanotubes (CNTs) or graphene. However, MnOₓ species, not possessing sufficient OER active sites, hamper its utilization as a bi-functional catalyst.

Metal-free materials, such as carbon for example, have not been explored in depth with respect to provisioning bifunctional electrocatalysts for the oxygen reduction reaction (ORR) and oxygen evolution reaction (OER).

The state-of-the-art electrodes in rechargeable batteries are composite electrodes, i.e. made up of particles of an active material (electrocatalyst) in powder form, which is generally coated on a current collector (electrode substrate) using expensive polymer binders (such as Nafion or polytetrafluoroethylene) and other additives such as activated carbon as a conductivity enhancer, in particular when metal oxides are used as active materials. For film formation, the electrode components are mixed with a solvent and applied roll-to-roll onto the metal substrate in the form of a liquid film. In a subsequent drying step, the solvent is evaporated, leaving the structure of a porous film. This process is cumbersome, time consuming and expensive, and film homogeneity has always been a challenge. In addition, the presence of the polymer binder inexorably masks the active sites, limits the electronic conductance, reduces the mass transport, the destruction of the microstructure and a decrease in volume, as well as a deterioration in film stability due to degradation of the binder under operating conditions; all of which resulting in an overall decrease in efficiency and increased cost of manufacture.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to an electrocatalyst and an electrode comprising this electrocatalyst whilst providing for methods of their manufacture. More specifically, the present invention is concerned with catalysts and electrodes that can catalyze both the oxygen reduction reaction (ORR) and the oxygen evolution reaction (OER).

In accordance with the present invention, there is provided a material comprising:
an electrocatalyst comprising carbon sphere chains attached on a catalytically active surface of the current collector; wherein
the carbon sphere chains extend away from the catalytically active surface;
the carbon sphere chains have functionalized surfaces that bear oxygen-containing functional groups; and
nanorods are attached to the functionalized surfaces of the carbon sphere chains by an end and extend away from said functionalized surfaces.

In accordance with the present invention, there is provided a material comprising:
an electrocatalyst comprising carbon sphere chains attached on a catalytically active surface of a current collector; wherein
the carbon sphere chains extend away from the catalytically active surface;
the carbon sphere chains have functionalized surfaces that bear oxygen-containing functional groups;
nanorods are attached to the functionalized surfaces of the carbon sphere chains by an end and extend away from said functionalized surfaces; and
the oxygen-containing functional groups have an ID/IG ratio greater than the ID/IG ratio of non-functionalized carbon sphere chains.

In accordance with the present invention, there is provided a material comprising:
an electrocatalyst comprising carbon sphere chains attached on a catalytically active surface of a current collector; wherein
the carbon sphere chains extend away from the catalytically active surface;
the carbon sphere chains have functionalized surfaces that bear oxygen-containing functional groups; and
nanorods are attached to the functionalized surfaces of the carbon sphere chains by an end and extend away from said functionalized surfaces; and
the nanorods are formed from at least one of a non-noble oxide, a perovskite and a carbon nanotube.

In accordance with the present invention, there is provided a material comprising:
an electrocatalyst comprising carbon sphere chains attached on a catalytically active surface of a current collector; wherein
the carbon sphere chains extend away from the catalytically active surface;
the carbon sphere chains have functionalized surfaces that bear oxygen-containing functional groups;
nanorods are attached to the functionalized surfaces of the carbon sphere chains by an end and extend away from said functionalized surfaces; and
a catalyst is disposed upon the nanorods.

In accordance with an embodiment of the invention there is provided a method of manufacturing a material electrode comprising:
providing a current collector having a surface that is catalytically active towards the growth of carbon sphere chains;
growing carbon sphere chains on the surface that is catalytically active, wherein the carbon sphere chains (CSCs) extend away from the current collector;
functionalizing surfaces of the CSCs so said surfaces of the CSCs bears oxygen-containing functional groups; and
growing nanorods on said surfaces of the CSCs, wherein the nanorods have an end attached to said surface and extend away from the surfaces of the CSCs.

In accordance with an embodiment of the invention there is provided a method of manufacturing a material electrode comprising:
providing a current collector having a surface that is catalytically active towards the growth of carbon sphere chains;
growing carbon sphere chains on the surface that is catalytically active, wherein the carbon sphere chains (CSCs) extend away from the current collector;
functionalizing surfaces of the CSCs so said surfaces of the CSCs bears oxygen-containing functional groups;
growing nanorods on said surfaces of the CSCs, wherein the nanorods have an end attached to said surface and extend away from the surfaces of the CSCs; and
the nanorods are formed from at least one of a non-noble oxide, a perovskite and a carbon nanotube.

In accordance with an embodiment of the invention there is provided a method of manufacturing a material electrode comprising:
providing a current collector having a surface that is catalytically active towards the growth of carbon sphere chains;
growing carbon sphere chains on the surface that is catalytically active, wherein the carbon sphere chains (CSCs) extend away from the current collector;
functionalizing surfaces of the CSCs so said surfaces of the CSCs bears oxygen-containing functional groups; and
growing nanorods on said surfaces of the CSCs, wherein the nanorods have an end attached to said surface and extend away from the surfaces of the CSCs; and
a catalyst is disposed upon the nanorods.

In accordance with an embodiment of the invention there is provided an electrocatalyst comprising:
a plurality of carbon sphere chains, each carbon sphere chain having a functionalized surface comprising oxygen-containing functional groups; and
a plurality of nanorods, each nanorod having an end attached to a region of the functionalized surface of a carbon sphere chain of the plurality of carbon sphere chains and extending away from the functionalized surface.

In accordance with an embodiment of the invention there is provided a method of manufacturing an electrocatalyst comprising:
growing carbon sphere chains;
functionalizing surfaces of the CSCs of the CSCs such that the surfaces of the CSCs bear oxygen-containing functional groups; and
growing nanorods on said surfaces of the CSCs, wherein the nanorods have an end attached to a surface of said surfaces of the CSCs and extend away from the surface of the surfaces of CSCs.

In accordance with an embodiment of the invention there is provided an electrode comprising:
the electrocatalyst comprises carbon sphere chains attached on a catalytically active surface of the current collector;
the carbon sphere chains extend away from the catalytically active surface;
the carbon sphere chains have a functionalized surface that bear oxygen-containing functional groups having an I_{D}/I_{G} ratio greater than the I_{D}/I_{G} ratio of non-functionalized carbon sphere chains and manganese dioxide (MnOₓ) nanorods having two ends; and
the MnOₓ nanorods are attached to the functionalized surface of the carbon sphere chains by one of said ends and extend away from said functionalized surface.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the electrode forms part of one of a metal-air battery, a zinc-air battery, an air-breathing polymer electrolyte fuel cell and a water electrolyser.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the electrode is for use as at least one of an of any one of embodiments 1 to 3, being for use as an oxygen reduction reaction (ORR) electrode and an oxygen evolution reaction (OER) electrode.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the current collector further comprises a layer of a material that is catalytically active toward the growth of carbon sphere chains on a surface of the current collector.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the current collector further comprises a layer of a material that is catalytically active toward the growth of carbon sphere chains wherein the layer of the material has a thickness between about 1 nm and about 10 nm, preferably between about 3 nm and about 7 nm, more preferably between about 4 nm and about 6 nm, and most preferably of about 5 nm.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the carbon spheres in the carbon sphere chains have at least one of diameters of about 300 nm to about 1200 nm and a size distribution with about 80% having a size between about 600 nm and about 800 nm.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the carbon sphere chains have a specific surface area between about 1 and about 10 m²/g, preferably between about 5 about 9 m²/g, and more preferably of about 7 m²/g.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the oxygen-containing functionalized surfaces comprise oxygen-containing functional groups are at least one of hydroxyl groups, quinonyl groups and carboxyl groups.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the MnOₓ nanorods are between about 0.4 mm and about 3 mm in length and/or between about 10 nm and about 200 nm in diameter.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the oxygen-containing functionalized surfaces are concealed by the MnOₓ nanorods.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the MnO₂ nanorods have at least one of an α-MnO₂ crystalline structure, an α-MnO₂ crystalline structure with potassium and are KMn₈O₁₆ with an α-MnO₂ crystalline structure.

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the electrocatalyst comprises manganese (Mn), oxygen (O), potassium (K) and carbon (C).

In accordance with the present invention there is provided such an electrode comprising a current collector and electrocatalyst on the current collector comprising carbon sphere chains with oxygen-containing functionalized surfaces and MnOₓ nanorods attached to said functionalized surfaces where the MnOₓ nanorods contain potassium (K) with an atomic ratio of Mn/K between 5.65 and about 8.

In accordance with the present invention there is provided such a method of manufacturing an electrode comprising a current collector and electrocatalyst on the current collector comprising carbon sphere chains with oxygen-containing functionalized surfaces and MnOₓ nanorods attached to said functionalized surfaces where the method comprises the steps of:
providing a current collector having a surface that is catalytically active towards the growth of carbon sphere chains;
growing carbon sphere chains on the surface that is catalytically active, wherein the carbon sphere chains (CSCs) extend away from the current collector;
functionalizing the surface of the CSCs so said surface of the CSCs bears oxygen-containing functional groups and have an I_{D}/IG ratio greater than the I_{D}/I_{G} ratio of non-functionalized carbon sphere chains; and
growing MnOₓ nanorods on said surface of the CSCs, wherein the nanorods have two ends, are attached to said surface by one of said ends and extends away from the surface of the CSCs.

In accordance with the present invention there is provided such a method of manufacturing an electrode comprising a current collector and electrocatalyst on the current collector comprising carbon sphere chains with oxygen-containing functionalized surfaces and MnOₓ nanorods attached to said functionalized surfaces where the current collector does not have a natural catalytically active surface and the method comprises depositing a layer of a material that is catalytically active toward the growth of carbon sphere chains on a surface of the current collector prior to growing carbon sphere chains so as to provide a current collector with a surface that is catalytically active towards the growth of the carbon sphere chains.

In accordance with the present invention there is provided such a method of manufacturing an electrode comprising a current collector and electrocatalyst on the current collector comprising carbon sphere chains with oxygen-containing functionalized surfaces and MnOₓ nanorods attached to said functionalized surfaces where the method comprises the steps of:
providing a current collector;
depositing a layer of a material that is catalytically active toward the growth of carbon sphere chains onto a surface of the current collector; and
growing carbon sphere chains on the surface that is catalytically active, wherein the carbon sphere chains (CSCs) extend away from the current collector; wherein
at least one of the layer of material is deposited by pulsed laser deposition (PLD) and the carbon sphere chains are grown by chemical vapor deposition (CVD).

In accordance with the present invention there is provided such a method of manufacturing an electrode comprising a current collector and electrocatalyst on the current collector comprising carbon sphere chains with oxygen-containing functionalized surfaces and MnOₓ nanorods attached to said functionalized surfaces where the method comprises the steps of:
providing a current collector having a surface that is catalytically active towards the growth of carbon sphere chains;
growing carbon sphere chains on the surface that is catalytically active, wherein the carbon sphere chains (CSCs) extend away from the current collector; and
functionalizing the surface of the CSCs so said surface of the CSCs bears oxygen-containing functional groups and have an ID/I_{G} ratio greater than the I_{D}/I_{G} ratio of non-functionalized carbon sphere chains; wherein
the functionalization of the surface of the CSCs is via at least one of electrochemical oxidation and electrochemical oxidation via a cyclic voltammetry (CV) process.

In accordance with the present invention there is provided such a method of manufacturing an electrode comprising a current collector and electrocatalyst on the current collector comprising carbon sphere chains with oxygen-containing functionalized surfaces and MnOₓ nanorods attached to said functionalized surfaces where the method comprises the steps of:
providing a current collector having a surface that is catalytically active towards the growth of carbon sphere chains;
growing carbon sphere chains on the surface that is catalytically active, wherein the carbon sphere chains (CSCs) extend away from the current collector;
functionalizing the surface of the CSCs so said surface of the CSCs bears oxygen-containing functional groups and have an I_{D}/I_{G} ratio greater than the I_{D}/I_{G} ratio of non-functionalized carbon sphere chains; and
growing MnOₓ nanorods on said surface of the CSCs, wherein the nanorods have two ends, are attached to said surface by one of said ends and extends away from the surface of the CSCs; wherein
the MnOₓ nanorods are grown on the CSCs by hydrothermal synthesis.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1A and 1B depict scanning electron microscope (SEM) images of a coral-like carbon sphere chain (CSC) as viewed in a three-quarter view and from the top respectively;

FIGS. 2A and 2B depict an SEM image and transmission electron microscope (TEM) image of a pristine CSC respectively;

FIGS. 3A and 3B depict TEM images of pristine CSCs;

FIGS. 4A and 4B respectively depict an SEM image of a TEM image of a functionalized CSCs (Func CSCs-0.2M) respectively;

FIGS. 5A and 5B depict TEM images of Func CSCs-0.2M;

FIGS. 6A and 6B depict a Raman spectrum and X-ray photoelectron spectra (XPS) of C 1s for Func CSCs-0.2M respectively;

FIGS. 7A and 7B depict a Raman spectrum and X-ray photoelectron spectra (XPS) of O 1s of Func CSCs-0.2M and XPS survey spectra of CSCs-based substrates respectively;

FIGS. 8A and 8B depict SEM images of CSCs with manganese oxide (MnOₓ) nanorods (CSCs-MnOx);

FIGS. 9A and 9B depict SEM images of Func CSCs-0.2M/MnOₓ;

FIGS. 10A and 10B depict SEM images of Func CSCs-2M/MnOₓ

FIGS. 11A and 11B depict XRD patterns and Raman spectra respectively for different Func CSCs/MnOₓ;

FIGS. 12A and 12B depict XPS spectra of Mn 2p_{3/2} and O 1s. respectively for different Func CSCs/MnOₓ;

FIG. 13 energy-dispersive X-ray spectroscopy (EDS) mappings of carbon (C), potassium (K), manganese (Mn) and oxygen (O) for CSC/MnOₓ, Func CSCs-0.2M/MnOₓ and Func CSCs-2M/MnOₓ CSCs respectively;

FIGS. 14A and 14B depict XPS survey spectra and XPS Mn 2p spectra of hybrid CSCs-based MnOₓ:

FIG. 15A depicts XPS Mn 3s spectra of hybrid CSCs-based MnOₓ:

FIG. 15B depicts cyclic voltammograms (CVs) for an oxygen reduction reaction (ORR) CSCs electrode within a static electrolyte;

FIG. 16A depicts linear sweep voltammetry (LSV) curves recorded on a rotating ring-disk electrode (RRDE) at 1600 rpm;

FIG. 16B depicts the determined electron transfer number;

FIG. 17A the determined percentage of intermediate peroxides;

FIG. 17B depicts the oxygen evolution reaction (OER) performance via capacitance-corrected voltammetry profiles;

FIG. 18A depicts Tafel plots of OER performance for CSCs-based substrates electrodes;

FIG. 18B depicts CVs for an ORR CSCs-based/MnOₓ electrode within a static electrolyte;

FIG. 19A depicts linear sweep voltammetry (LSV) curves recorded on a RRDE at 1600 rpm;

FIG. 19B depicts the determined electron transfer number;

FIG. 20A the determined percentage of intermediate peroxides;

FIG. 20B depicts the OER performance via capacitance-corrected voltammetry profiles;

FIG. 21A depicts Tafel plots of OER performance for CSCs-based/MnOₓ substrates electrodes;

FIG. 21B depicts discharge and charge polarization curves for a Zn-air battery performance based on CSCs-based substrates cathodes;

FIGS. 22A and 22B depict power density and galvanostatic charge/discharge (GCD) cycling curves at 0.5 mA cm⁻² for a Zn-air battery performance based on CSCs-based substrates cathodes;

FIG. 23A depicts discharge and charge polarization curves for a Zn-air battery (ZAB) performance based on CSCs-based/MnOₓ hybrid cathodes;

FIGS. 23B and 24A depict power density and galvanostatic charge/discharge (GCD) cycling curves at 0.5 mA cm⁻² for a Zn-air battery performance based on CSCs-based/MnOₓ hybrid cathodes;

FIG. 24B depicts plots of specific capacity of hybrid CSCs-based/MnOₓ ZABs;

FIGS. 25A and 25B depicts measurements of open circuit voltage (OCV) for a single ZAB and two series connected ZABs respectively;

FIG. 25C depicts voltage as a function of time for a single ZAB powering a laboratory timer up to 17 days;

FIGS. 25D and 25E depicts photographs of LED bulbs with INRS logo powered and unpowered;

FIGS. 25F and 25G depicts measurements performed with a pair of series connected ZABs powering a multimeter to measure a resistor as high as 10 k≤2;

FIGS. 26A and 26B depict SEM images of CSC/MnOₓ cathodes;

FIGS. 27A and 27B depict SEM images of Func CSCs-0.2M/MnOₓ cathodes;

FIGS. 28A and 28B depict SEM images of Func CSCs-2M/MnOₓ cathodes after battery cycling;

FIG. 29 depicts a Raman spectra of cathodes after battery cycling;

FIG. 30 depicts SEM images of cobalt-doped Func CSCs-2M/MnOx;

FIG. 31 depicts EDS spectra of cobalt-doped Func CSCs-2M/MnOx;

FIG. 32 depicts SEM images of nickel-doped Func CSCs-2M/MnOx;

FIG. 33 depicts EDS images of nickel-doped Func CSCs-2M/MnOx;

FIGS. 34A and 34B depicts EDS spectra of cobalt-doped and nickel-doped Func CSCs-2M/MnOx;

FIG. 35A depicts CVs for ORR CSCs-based/MnOx at different cobalt doping levels;

FIG. 35B depicts linear sweep voltammetry (LSV) curves recorded on a RRDE for CSCs-based/MnOx at different cobalt doping levels;

FIG. 36A depicts the determined electron transfer number for CSCs-based/MnOx at different cobalt doping levels;

FIG. 36B the determined percentage of intermediate peroxides for CSCs-based/MnOx at different cobalt doping levels;

FIG. 37A depicts the OER performance via capacitance-corrected voltammetry profiles for CSCs-based/MnOx at different cobalt doping levels;

FIG. 37B depicts Tafel plots of OER performance for CSCs-based/MnOx at different cobalt doping levels;

FIG. 38A depicts CVs for ORR CSCs-based/MnOx at different nickel doping levels;

FIG. 38B depicts linear sweep voltammetry (LSV) curves recorded on a RRDE for CSCs-based/MnOx at different nickel doping levels;

FIG. 39A depicts the determined electron transfer number for CSCs-based/MnOx at different nickel doping levels;

FIG. 39B the determined percentage of intermediate peroxides for CSCs-based/MnOx at different nickel doping levels;

FIG. 40A depicts the OER performance via capacitance-corrected voltammetry profiles for CSCs-based/MnOx at different nickel doping levels;

FIG. 40B depicts Tafel plots of OER performance for CSCs-based/MnOx at different nickel doping levels;

FIGS. 41A and 41B depict ORR/OER performance comparison of cobalt doped Func CSCs-2M/Co_{y}MnOₓ and nickel doped Func CSCs-2M/Ni_{y}MnOₓ based on E½ and E10 relative to undoped Func CSCs-2M/MnOₓ;

FIGS. 42A, 42B and 42C depict discharge and charge polarization curves, power density as a function of current density and specific capacity for Zn-air batteries employing undoped, cobalt doped and nickel doped Func CSCs-2M/MnOₓ;

FIGS. 43A, 43B, 43C and 43D depict GCD cycling tests based upon undoped, cobalt doped and nickel doped Func CSCs-2M/MnOₓ cathodes;

FIG. 44A depicts images of 39 LEDs driven by a pair of series connected ZABs using cobalt doped Func CSCs-2M/MnOₓ cathodes at different points over a 214 hour test; and

FIG. 44B depicts the stable voltage of the pair of series connected ZABs using cobalt doped Func CSCs-2M/MnOₓ cathodes over the 214 hour test.

Other aspects and features of the present invention will become apparent to those ordinarily skilled in the art upon review of the following description of specific embodiments of the invention in conjunction with the accompanying figures.

### DETAILED DESCRIPTION OF THE INVENTION

The present invention is directed to an electrocatalyst and an electrode comprising this electrocatalyst whilst providing for methods of their manufacture. More specifically, the present invention is concerned with catalysts and electrodes that can catalyze both the oxygen reduction reaction (ORR) and the oxygen evolution reaction (OER).

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

Within the following specification a novel electrode is presented which comprises a current collector and an electrocatalyst on the current collector where the electrocatalyst comprises carbon sphere chains attached on a catalytically active surface of the current collector with the carbon sphere chains extend away from the catalytically active surface. These carbon sphere chains have a functionalized surface that bears oxygen-containing functional groups and have an I_{D}/I_{G} ratio greater than the I_{D}/I_{G} ratio of non-functionalized carbon sphere chains. Manganese dioxide (MnOₓ) nanorods having two ends are attached to the functionalized surface of the carbon sphere chains by one of said ends and extend away from said functionalized surface.

The inventive electrocatalyst and electrode are bifunctional, meaning that they catalyze both the oxygen reduction reaction (ORR) and the oxygen evolution reaction (OER). The inventive electrode supporting use as an ORR electrode, an OER electrode, or an ORR and OER electrode.

Therefore, the electrode of the invention is suitable as a cathode in metal-air batteries, which must be capable of catalyzing the sluggish oxygen reduction reaction (ORR) during battery discharge, and the oxygen evolution reaction (OER) and decreasing the considerable high overpotential at the cathode during battery charging.

The inventive electrode may form an electrode of a metal-air battery, for example a zinc-air battery, or it may form an electrode within other devices such as air-breathing polymer electrolyte fuel cells and water electrolysers for example. Within air-breathing polymer electrolyte fuel cell applications the electrode may be employed within hydrogen (H₂), methanol, ethanol and formic acid fuel cells for example.

Further, as described below the electrocatalyst comprises carbon sphere chains with MnOx nanorods may be undoped or doped. When doped, the dopant may be a metal such as iron, cobalt or nickel for example.

The inventive electrocatalyst within the electrode of the invention is referred to as hybrid electrocatalyst as it contains two materials: the carbon sphere chains (CSCs) and the manganese dioxide (MnOx) nanorods (NRs).

Beneficially, the inventive electrocatalyst in the electrodes according to embodiments of the invention is non-precious metal-based, i.e., it does not require using the conventional expensive noble metals such as platinum (Pt), rubidium (Ru), and iridium (Ir) for example.

In embodiments of the invention, the electrocatalyst and the electrode of the invention are self-supporting (i.e. binderless). This means that they maintain their shape without a binder to bind the electrocatalyst particles together and to the substrate/current collector. This is possible because the carbon sphere chains are grown directly on the current collector and therefore are attached to the current collector. Also, the spheres within each CSC are connected to each other. This avoids the disadvantages of binders such as masking the active sites, limiting the electronic conductance, reducing the mass transport, destroying the microstructure and decreasing the volume, as well as a deteriorating the film stability due to degradation of the binder under operating conditions. The electrocatalyst and electrode of the invention result in an overall increase in efficiency with reduced manufacturing cost.

Because they are self-supporting, the electrocatalyst and the electrode of the invention have improved mechanical stability. Also, the final electrode weight of the electrode is reduced by about 10-40%, as compared to electrodes comprising binders. This also reduces the cost of manufacturing the cathode.

Further, the strong interactions between the CSCs and the current collector reduce interface resistance and are thus expected to have a major effect in improving the performance and extending the life of metal-air batteries.

The electrocatalyst in the electrode of the invention is highly functional, electrocatalytically stable and highly efficient, which can meet the required demand of the air electrode and overcome the shortcomings of powder catalysts.

The electrode of the invention, when integrated by the inventors within a simple zinc-air battery (ZAB), demonstrated an open circuit voltage (OCV) as high as ˜1.46 V and ˜2.92 V for one and two ZABs connected in series, respectively as outlined in the Examples section below.

Proof of concept tests for various handheld electronic applications were performed to demonstrate the feasibility of CP/CSC/MnO₂ as cathodes in a ZAB, see the Examples section below. First, a single ZAB successfully operated a 1.5 V alkaline battery-powered laboratory timer with a voltage of about 1.4 V for 17 days, and a 3V multimeter which could measure high resistance of 10 KW. The prototype ZAB achieved a specific capacity of 801.1 mAh/g/n, close to the theoretical value of 820 mAh/g/n.

As shown in the examples below, the functionalization in CSCs substrates enhanced the OER activity, and the MnOₓ in combination with the functionalized CSCs efficiently improved the OER performance. Also, after functionalization the CSCs displayed a lower charge voltage and a higher discharge voltage, and thus a smaller voltage gap. Further, as outlined in the subsequent optimization doping of the CSCs with MnOx NRs with cobalt and nickel, for example, can improve performance further.

It is believed that the CSCs were hydrophilic after functionalization, which results in easier contact with MnOx and easier grow of MnOx during the nanorod synthesis. Notably, a battery with an electrode of the invention had a very stable discharge voltage, recharge voltage, as well as voltage gap, which we attribute to the enhanced OER of the functionalized CSCs and the strong connection between the CSCs and the MnOx nanorods.

For ORR, an electron transfer number remarkably close to 4 and a small percentage of peroxides where observed. Both indicated an apparent 4-electron reduction route initiated by a two-electron reduction pathway from single oxygen molecular to a hydroperoxide and followed by a second two-electron reduction from hydroperoxide to hydroxide.

Comparing the ORR results of the CSCs with and without the MnOx nanorods, it was observed that the hybrid electrocatalyst (CSCs+MnOx nanorods) exhibited a strong synergetic effect between the CSCs and the directly grown nanorods arrays, which greatly enhanced the ORR activity including:
a positive shift CV peak potential in static CV profiles,
an efficiently high limiting current density,
a high electron transfer number, and
a significant decline in the intermediate of peroxides.

The increased functionalization of CSCs increased the peak density, and the MnOx coupled CSCs showed a synergetic effect in enhancing the battery discharge performance.

Finally, both the morphology of the electrodes and the α-MnOx structure of the nanorods remained almost unchanged after 100 charge/discharge cycle, demonstrating their excellent stability.

### Substrate and Current Collector

The current collector can be any current collector known in the art to make electrodes for OER or ORR. For example, the current collector may be a carbon paper, a carbon cloth, a nickel foil, a titanium foil, a copper foil, a silicon substrate, or a metal grid. In some embodiments, the current collector is a carbon paper e.g., Toray carbon paper (CP, TGP-H-60). Carbon paper is made of carbon microporous fibers. Commercially available carbon paper is typically made of microfibers, randomly aligned or stacked, ranging between about 7 to about 10 mm.

As will be apparent from the method of manufacture below, the carbon sphere chains are grown on the current collector. Therefore, the current collector must have a surface that is catalytically active towards the growth of carbon sphere chains (hereinafter, a “catalytically active surface”).

Some of the above current collectors may naturally have a catalytically active surface. However, when the current collector does not have such a natural catalytically active surface, a surface of the current collector can be modified to become catalytically active. For example, a layer of a material that is catalytically active toward the growth of carbon sphere chains can be deposited on a surface of the current collector.

Hence, in embodiments, the current collector bears a layer of a material that is catalytically active toward the growth of carbon sphere chains. Non-limiting examples of materials that are catalytically active toward the growth of carbon sphere chains include nickel (Ni), iron (Fe), cobalt (Co), and Ni—Co alloy. In some embodiments of the invention, the material that is catalytically active toward the growth of carbon sphere chains is nickel.

The layer of the material that is catalytically active toward the growth of carbon sphere chains can have a thickness between about 1 nm and about 10 nm, preferably between about 3 nm and about 7 nm, more preferably between about 4 nm and about 6 nm, and most preferably of about 5 nm. Accordingly, in some embodiments, the current collector is carbon paper bearing a layer of nickel, said layer being about 5 nm thick.

### Carbon Sphere Chains

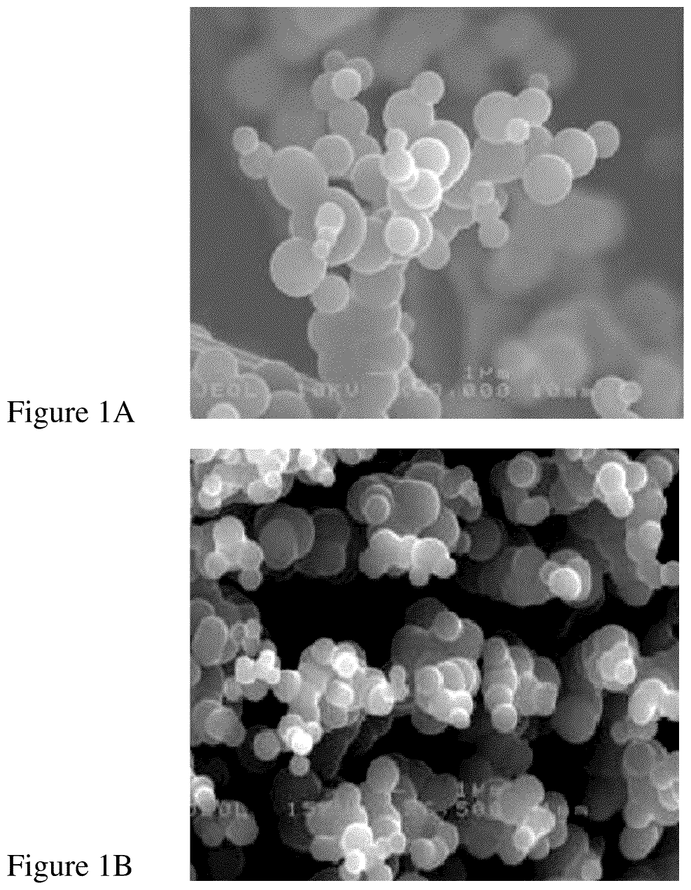

A carbon sphere chain is a chainlike compounds of carbon spheres connected to one another. In embodiments, a majority of the carbon spheres are attached to two other carbon spheres (thus forming a main chain). Some carbon spheres are typically attached to more than two (e.g., 3 or 4, preferably 3) other carbon spheres thereby creating branches of a main chain. In embodiments, these branches are much shorter than the main chain. Therefore, the carbon sphere chains can be coral-like or tree-like in shape, see FIG. 1A.

The main chains and branches are not necessarily straight, rather they typically zigzag. In all cases, the carbon sphere chains are not spheres randomly arranged in all directions. Rather, they form thin long chains. The carbon spheres are well attached to one another. In embodiments, the spheres are partially fused together.

The carbon sphere chains generally extend away from the current collector, see FIG. 1B. However, it should be understood that the carbon sphere chains do not necessarily extend perpendicularly from the substrate, they may be at a slight angle.

In embodiments, the carbon spheres have diameters of about 300 nm to about 1200 nm. Within embodiments of the invention the carbon spheres have diameters of about 300 nm to about 1200 nm with approximately 80% having a size between about 600 nm and about 800 nm.

In embodiments, the carbon spheres have a sphericity Y′ close to 1, preferably about 0.95 or more, more preferably about 0.98 or more, and most more preferably about 0.99 or more. The sphericity being as defined by Wadell in 1935 in Wadell, Hakon (1935). “Volume, Shape, and Roundness of Quartz Particles”. The Journal of Geology. 43 (3): 250-280, herein incorporated by reference in its entirety.

In embodiments, the carbon sphere chains have a specific surface area between about 1 and about 10 m²/g, preferably between about 5 m²/g about 9 m²/g, and more preferably of about 7 m²/g.

When produced according to a manufacturing process outlined below, the attachment of the CSCs to the current collector is strong and they cannot be detached from the current collector, even after extensive sonication or solvent exposure for e.g., Brunauer-Emmett-Teller (BET) sample preparation.

In embodiments, the carbon sphere chains are as described in Z. Hamoudi, B. Aissa, M. A. El Khakani, M. Mohamedi, Synthesis, Characterization, and Electrocatalytic Properties of Ultra Highly Densely Packed Carbon Sub-Micrometer Sphere Chains and Sheathed Carbon Microfiber Composites, J. Phys. Chem. C 2010, 114, 1885, incorporated herein by reference in its entirety.

### Functionalization of the Carbon Sphere Chains

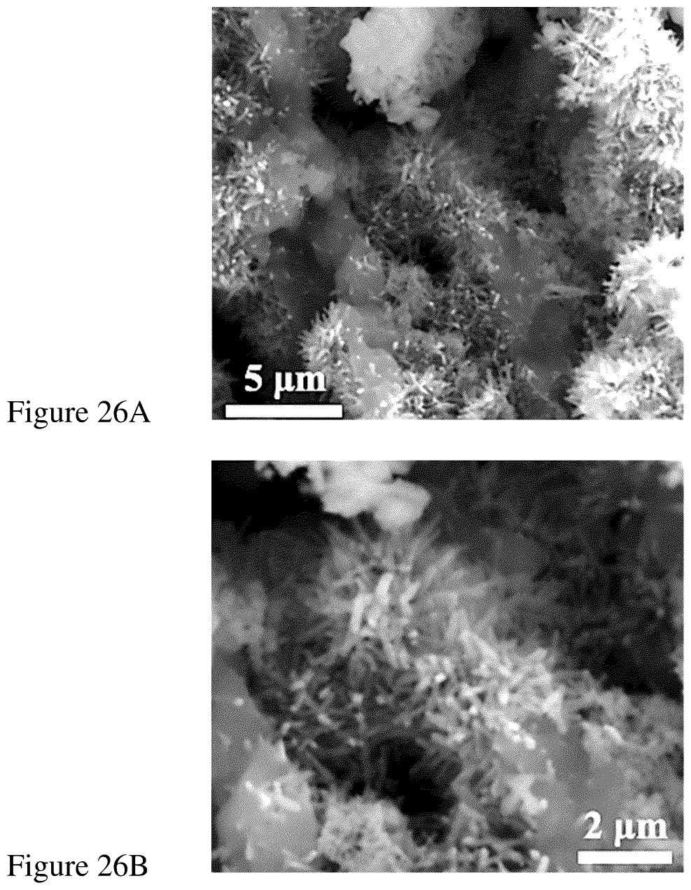

As noted, the surface of the carbon sphere chains is functionalized, more specifically by oxidation, and this functionalized surface is thus an oxidized surface. The inventors have found that such surface functionalization was necessary for the durable attachment of the MnOx nanorods to the carbon sphere chains. Without functionalization, parts of the MnOx nanorods detach from the CSC and fall into the electrolyte. This can be clearly seen from FIGS. 26A and 26B respectively, showing some CSCs without nanorods.

As mentioned above, the functionalized surface of the carbon sphere chains bears oxygen-containing functional groups. Non-limiting examples of oxygen-containing functional groups include hydroxyl, quinonyl, and carboxyl groups.

Also as mentioned above, the carbon sphere chains with the functionalized surface have an I_{D}/I_{G} ratio greater than the I_{D}/I_{G} ratio of non-functionalized carbon sphere chains. In preferred embodiment, the carbon sphere chains with the functionalized surface have an I_{D}/I_{G} ratio greater than 2.0, preferably greater than 2.1, and more preferably greater than 2.2. The I_{D}/I_{G} ratio is the ratio of the intensity of the D-Raman peak (at about 1330 cm⁻¹) around and the G-Raman peak (at about 1600 cm⁻¹) in the spectrum of the carbon sphere chains. The higher this ratio, the more structural defects in the CSC structure. In other words, The higher this ratio, the rougher (or less structurally perfect) the surface the CSCs and their surface. Hence, the surface of the functionalized carbon sphere chains is “rough” i.e., rougher than the surface of non-functionalized carbon sphere chains (which is smooth).

Herein, “non-functionalized carbon sphere chains” are identical to the functionalized carbon sphere chains except for the fact that they have not been functionalized. For example, the roughness and various parameters of the surface of the carbon sphere chains can easily be compared by characterizing the carbon sphere chains before and after their functionalization.

In preferred embodiments, the functionalized surface of the carbon sphere chains further bears carbon nanobuds. Herein, “carbon nanobuds” are irregularly shaped carbon protrusions on the surface of the carbon sphere chains. Generally, carbon nanobuds are about 30 to 100 nm in diameter and about 6 to 20 nm in height.

In embodiments, the carbon sphere chains with the functionalized surface comprise (preferably consist of) two elements, carbon and oxygen, as measured by XPS survey.

### Manganese Oxide Nanorods

As noted above, MnOx nanorods are attached to the functionalized surface of the carbon sphere chains. Herein, “MnOx nanorods” refers to thin needle shaped nanostructures made of MnOx, and that are typically between about 0.4 mm and about 3 mm, preferably about 1 to about 1.6 mm in length, and/or between about 10 nm and about 200 nm, preferably between about 100 nm and about 170 nm, and more preferably about 135 nm in diameter.

Within this specification MnOx refers to a material which is nominally manganese dioxide (MnO₂) although the exact composition may vary slightly according to the manufacturing process, manufacturing variations, doping levels, dopants etc.

Within this specification α-MnOx refers to the α-polymorph which can incorporate a variety of suitably dimensioned atoms and/or molecules within “tunnels” or “channels” between the overall structure of MnOx octahedra.

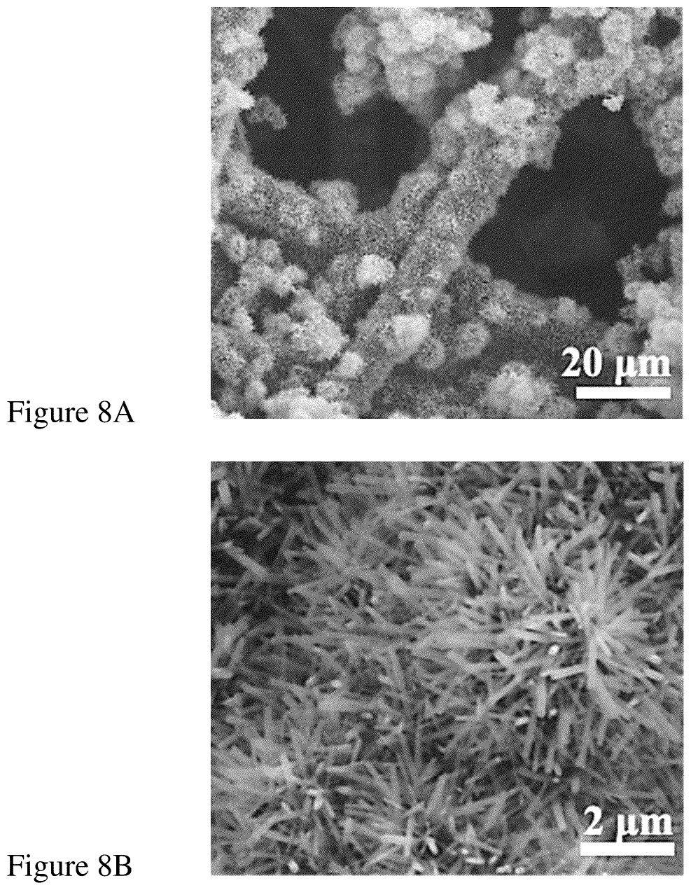

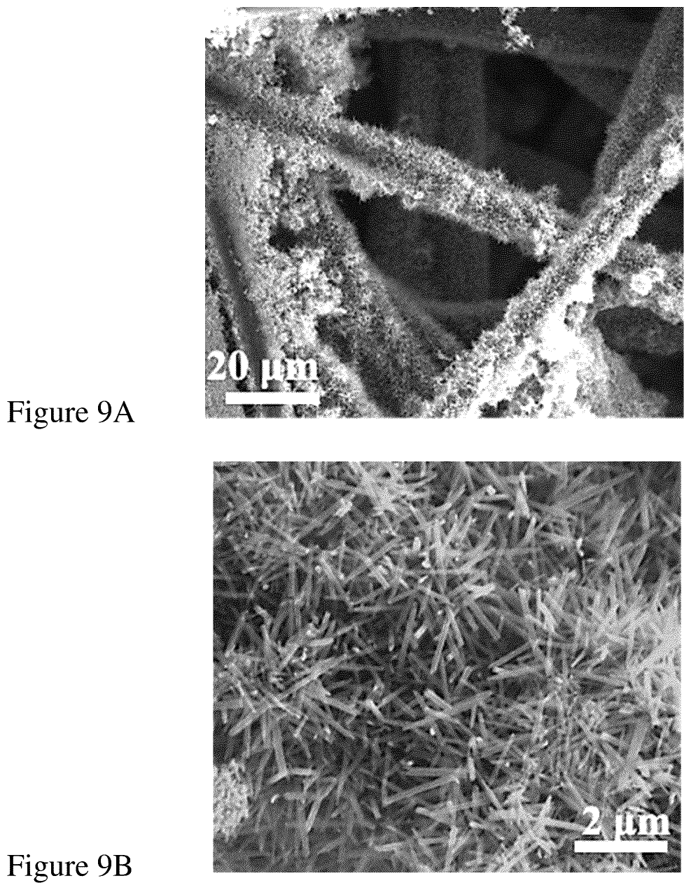

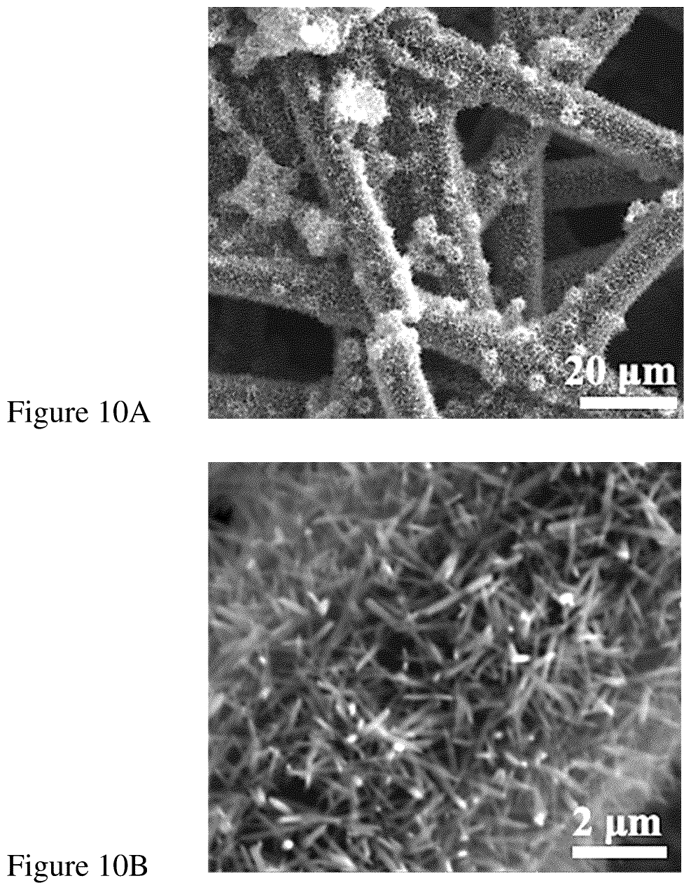

The nanorods do not necessarily extend orthogonally from the functionalized surface, rather they extend away from said functionalized surface at various angles from the surface. In preferred embodiments, when observed by SEM, the functionalized surface bearing MnOx nanorods appear as a surface of sea urchin i.e., with very densely packed needles (see FIGS. 8B, 9B and 10B).

Typically, the whole functionalized surface of the carbon sphere chains bears nanorods with the optional exception of the part of the surface where two spheres are touching, which, in some cases, may be not accessible to the nanorods growth reagents.

The MnOx nanorods are densely packed on the functionalized surface, as evident from FIGS. 8B, 9B and 10B for example. In some embodiments, when observed by SEM, the functionalized surface is totally concealed by the MnOx nanorods. In embodiments, the MnOx nanorods are present in a density of 3 or more nanorods per square μm², preferably 5 or more nanorods per square μm², and most preferably 10 or more nanorod per square μm².

In embodiments, the MnOx in the MnOx nanorods has an α-MnO₂ crystalline structure. The α-polymorph of MnOx has a very open structure with “channels” or “tunnels” between the manganese oxide octahedra, which can accommodate various metal atoms. α-MnOx is often called hollandite, after a closely related mineral. In preferred embodiments, the α-MnO2 crystalline structure of the MnOx nanorods comprises potassium. In a preferred embodiment, the α-MnO2 crystalline structure is KMn₈O₁₆. KMn₈O₁₆ is a typical α-MnOx phase in which K⁺ is located in the 2×2 tunnels to stabilize the α phase crystalline structure.

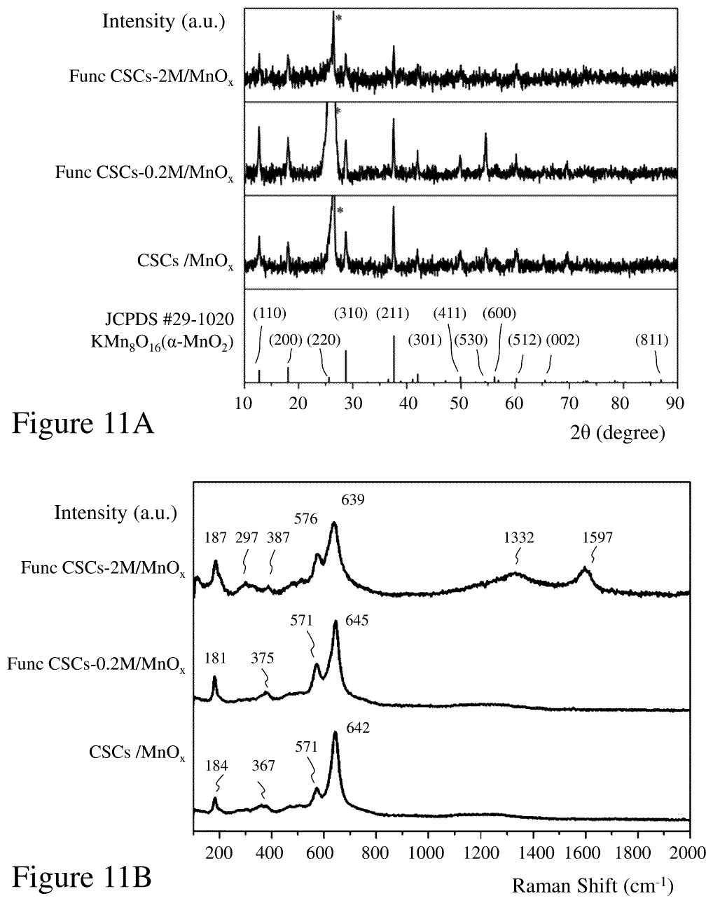

In embodiments, the MnOx nanorods have an XRD pattern comprising the peaks at 2θ of 12.7°, 18.1°, 25.6°, 28.7°, 37.6°, 42.0°, 49.9°, 54.6°, 60.2°, and 65.3°. In embodiments, the MnOx nanorods have an XRD pattern as shown in FIG. 11A top curve labelled “Func. SCSs-2M/MnOx” or middle curve labelled “Func CSCs-0.2M/MnOx”. In preferred embodiments, the MnOx nanorods have an XRD pattern as shown in FIG. 11 top curve labelled “Func. SCSs-2M/MnOx”.

In embodiments, the atomic ratio Mn/K in the electrocatalyst is between 5.65 and about 8, preferably between 5.65 and about 7.5.

In embodiments, the catalyst comprises, and may preferably consist of, four elements, Mn, O, K, and C, as measured by XPS survey. In some embodiments, the MnOx nanorods are doped with a doping metal, preferably Fe, Ni or Co. Results of doping optimization are presented below with respect to Ni and Co dopants.

### Method of Manufacture

The inventors have established a method of manufacture of the electrode of the invention. This inventive electrode comprising a current collector and an electrocatalyst on the current collector where the electrocatalyst comprises carbon sphere chains attached on a catalytically active surface of the current collector with the carbon sphere chains extend away from the catalytically active surface. These carbon sphere chains have a functionalized surface that bears oxygen-containing functional groups and have an ID/IG ratio greater than the ID/IG ratio of non-functionalized carbon sphere chains. Manganese dioxide (MnOx) nanorods having two ends are attached to the functionalized surface of the carbon sphere chains by one of said ends and extend away from said functionalized surface.

Accordingly, the inventors employed the following method in fabricating the electrocatalyst according to embodiments of the invention although it would be evident that other methods, processes and processing conditions etc. may be employed without departing from the scope of the invention as defined by the claims with respect to the formation of the inventive electrocatalyst.

This method employed by the inventors comprises the steps of:
providing a current collector having a surface that is catalytically active towards the growth of carbon sphere chains;
growing carbon sphere chains on the surface that is catalytically active, wherein the carbon sphere chains (CSCs) extend away from the current collector;
functionalizing the surface of the CSCs so said surface of the CSCs bears oxygen-containing functional groups and have an I_{D}/I_{G} ratio greater than the I_{D}/I_{G} ratio of non-functionalized carbon sphere chains; and
growing MnOx nanorods on said surface of the CSCs, wherein the nanorods have two ends, are attached to said surface by one of said ends and extends away from the surface of the CSCs.

This synthesis advantageously does not require using binding agents or templates. The flexibility afforded by this manufacturing approach also eliminate the need to control the CSCs concentration, thus allowing optimized CSCs dispersion processes. Finally, the CSCs network is formed independently of the nanorods, which makes the synthesis process useful for making composites or hierarchical layered materials.

### Step A

The current collector is as defined above. Since the carbon sphere chains are grown on the current collector at Step B, the current collector should have a surface that is catalytically active towards the growth of carbon sphere chains (hereinafter referred to as a “catalytically active surface”).

Some current collectors naturally have a catalytically active surface. However, in embodiments in which the current collector does not have such a natural catalytically active surface, step A further comprises the step of depositing a layer of a material that is catalytically active toward the growth of carbon sphere chains on a surface of the current collector, so as to obtain a current collector with a surface that is catalytically active.

The layer of material that is catalytically active and said material are as defined above. In some embodiments, the layer of a material that is catalytically active is deposited by pulsed laser deposition (PLD) although the exact process may vary according to the material employed as well as upon other factors such as the mechanical geometry of the current collector upon which the material is to be disposed upon.

In an embodiment of the invention, a nickel layer is deposited by ablating under vacuum, a pure (99.95%) polycrystalline nickel target by means of a pulsed krypton fluoride (KrF) excimer laser (wavelength=248 nm), pulse duration≈14 ns, repetition rate of 20 Hz) with a fluence of 5 J/cm². To obtain a uniform ablation over the target surface, the target is continuously rotated and translated. The current collectors were placed at 50 mm from the target, and the deposition was performed at room temperature.

### Step B

Step B of the process takes advantage of the fact that CSCs can be grown directly on planar current collectors, such as carbon paper for example. In an embodiment of the invention the carbon sphere chains are grown on the on the surface that is catalytically active by chemical vapor deposition (CVD). However, other growth processes or formation processes for the CSCs may be employed without departing from the scope of the invention.

In a process employed by the inventors the chemical vapor deposition (CVD) uses acetylene as a carbon source (at a flow rate of 25 sccm, for example). Within the CVD process argon may be employed as a carrier gas (preferably at a flow rate of 20 sccm, for example) in conjunction with the acetylene. The CVD process may be carried out, for example, at 700° C.

In more preferred embodiments, the carbon sphere chains are grown according to the method described in Z. Hamoudi, B. Aissa, M. A. El Khakani, M. Mohamedi, Synthesis, Characterization, and Electrocatalytic Properties of Ultra Highly Densely Packed Carbon Sub-Micrometer Sphere Chains and Sheathed Carbon Microfiber Composites, J. Phys. Chem. C 2010, 114, 1885, incorporated herein by reference in its entirety.

### Step C

Step C of the process comprises functionalizing the surface of the CSCs by electrochemical oxidation with a cyclic voltammetry (CV) procedure. As is well-known to the skilled person, a cyclic voltammetry (CV) procedure comprises at least charge/discharge cycles at a given scan rate in a given potential window. Within initial processes employed by the inventors to fabricate initial inventive electrocatalysts the electrochemical oxidation employed a three-electrode system comprising a reference electrode (e.g. Ag/AgCl (4.0 M KCl)), a counter electrode (e.g. a Pt wire), and the current collector with the CSCs as a working electrode.

Within initial processes employed by the inventors between 7 and 20 CV cycles were typically employed, more commonly 15 CV cycles were carried out. The potential window for a CV cycle was typically from about 0.15 to about 2.0 V, preferably from about 0.15 to about 2.0 V. The scan rate was typically between 5 mV s⁻¹ to about 50 mV s⁻¹, with a preference to the upper side at 50 mV s⁻¹.

In preferred embodiment, the electrolyte is an HNO3 aqueous solution. In more preferred embodiments, the HNO3 aqueous solution has a HNO3 concentration between about 0.1 M to about 2 M, preferably between about 0.2 M to about 2 M, and more preferably has a HNO3 concentration of 2 M.

### Step D

Step D of the process comprises growing MnOₓ nanorods on said surface of the CSCs by hydrothermal synthesis. For example, hydrothermal synthesis of MnOₓ nanorods may be employed comprising placing the current collector with the CSCs in a manganese-containing aqueous solution, e.g. deionized water, and then heating the aqueous solution. The aqueous solution may be a potassium permanganate (KMnO₄) aqueous solution. Where doped nanorods are required, a sulfate salt of the doping metal can be added to the manganese-containing aqueous solution.

Within fabrication sequences the KMnO₄ aqueous solution comprises KMnO₄ at a concentration of about 0.01 mol/L to about 0.1 mol/L, preferably of about 0.05 mol/L to about 0.1 mol/L, preferably of about 0.08 mol/L to about 0.1 mol/L, and most preferably at a concentration of about 0.09 mol/L, such as 0.087 mol/L.

Within fabrication sequences, the KMnO₄ aqueous solution comprises HCl, preferably at a concentration of about 0.1 mol/L to about 0.35 mol/L, preferably of about 0.2 mol/L to about 0.3 mol/L, and most preferably at a concentration of about 0.25 mol/L, such as 0.26 mol/L.

Within fabrication sequences, the KMnO₄ aqueous solution with current collector with the CSCs is subjected (preferably in an autoclave) to a temperature of from about 80° C. to about 200° C., preferably from about 100° C. to about 180° C., more preferably from about 120° C. to about 160° C., and most preferably at a temperature of about 140° C., for about 10 to about 24 hours, preferably for about 10 to about 18 hours, more preferably for about 10 to about 14 hours, and most preferably for 12 hours.

Within fabrication sequences, the hydrothermal synthesis further comprises taking the current collector with the CSCs out of the manganese-containing aqueous solution and annealing the current collector with the CSCs, preferably at a temperature of from about 300° C. to about 400° C., preferably at a temperature of about 300° C., for about 1 to about 2 hours, preferably for about 1 hour.

### DESCRIPTION OF ILLUSTRATIVE EMBODIMENTS

The present invention is illustrated in further detail by the following non-limiting examples.

### Example 1—Self-Supported Hybrid Functionalized Carbon Sphere Chains-MnOx Nanorods as Efficient Bifunctional Oxygen Electrocatalyst for Rechargeable Zinc-Air Batteries

Herein, a hybrid α-MnOx nanorods (NRs)/carbon spheres chains (CSCs)/carbon paper (CP) structure is reported for the first time. We show that individually electrochemically functionalized CSCs exhibit high OER activity, while MnOx performs better towards the ORR. The combination of these two materials resulted in a synergistic beneficial effect towards the ORR/OER processes.

Carbon spheres chains (CSCs) are relatively new carbon materials. They allow avoidance of the use of binders or templates because they are intimately connected. A further significant advantage of the CSCs is that they can be grown directly on planar current collectors such as the carbon paper (CP) on which they are vertically aligned mimicking natural tree branches. Such unique features make CSCs possess multiple points of electrical conductivity and excellent dispersions characteristics when used as catalyst supports.

CSCs proved to be advantageous compared to monodispersed carbon spheres, which are difficult to immobilize onto planar electrode surfaces without resorting to the use of templates or polymer binders such as Nafion or the formation of chemical bonds between the carbon microparticle and the electrode surface.

Ultra-high density of α-MnOx NRs were directly grown via hydrothermal technique on CSCs, themselves produced by chemical vapor deposition (CVD) onto a micro-fibrous CP current collector. This synthesis advantageously did not require using binding agents or templates. The flexibility afforded by our manufacturing approach also eliminates the need to control CSCs concentration, thus allowing optimized CSCs dispersion processes. Finally, the CSCs network is formed independently of the active material (MnOx), which makes the synthesis process very useful for making composites or hierarchical layered materials.

### EXPERIMENTAL SECTION

### Synthesis of CSCs

CSCs were grown on a commercial Toray carbon paper (CP, TGP-H-60) substrate through a chemical vapor deposition (CVD) method following a previously reported procedure.^{[A21]} Typically, a 5 nm Ni thin film covered CP produced by pulsed laser deposition (PLD) technique was used to grow CSCs on the CP (CP/CSCs) at 700° C. with a mixed gas flows of acetylene and argon gases with flow rates of 25, and 20 sscm, respectively, where Ni film, acetylene, and argon served as the catalyst, carbon source, and gas carrier, respectively.

### Electrochemical Functionalization of CSCS

Surface functionalization was carried out via an electrochemical oxidation method with cyclic voltammetry (CV) procedure which was conducted in a three-electrode system. A piece of CP/CSCs sample (abbreviated as CSCs hereafter), the Ag/AgCl (4.0 M KCl), and a Pt wire working electrode, reference electrode, and counter electrode, respectively. The electrolyte was 0.2 M or 2 M HNO3 aqueous solution. The CV functionalization was conducted with a potential window of 0.15-2.0 V for 15 cycles with a scan rate of 50 mV s⁻¹. The samples after functionalization were labeled as Func CSCs-0.2M and Func CSCS-2M, where 0.2M and 2M represented the molarity of the electrolyte.

### Hydrothermal Synthesis of MnOx on CSCs-based Substrates

The hydrothermal synthesis of the MnOx was performed according to a previously reported procedure.^{[B1]} Briefly, 0.266 g (1.67 mmol) KMnO₄ (Sigma-Aldrich, 99%) was dissolved in 18.75 mL the deionized water (Millipore Milli-Q, resistivity 18.2 MΩ·cm) for 15 min under stirring. After complete dissolution, 0.42 mL of concentrated hydrochloride acid (HCl, Sigma-Aldrich, 37%) was added to the abovementioned solution and kept continually stirred for 2 min. A piece of pristine or functionalized CSCs sample was placed into a 25 mL Teflon-lined stainless-steel autoclave and followed with a careful transfer of the abovementioned solution into the autoclave reactor. The autoclave was subjected to 140° C. for 12 hours. After it cooled down to room temperature the sample was taken out and carefully rinsed with deionized water. The sample was then annealed at 300° C. in the air for 1 hour. The samples were labeled as CSCs/MnOx, Func CSCs-0.2M/MnOx, and Func CSCs-2M/MnOx, respectively.

### Materials Characterization

A Bruker D8 X-ray diffraction (XRD) diffractometer which was equipped with a Cu Kα source was used to study the crystalline structure of the as-prepared samples. The working voltage and current values of the generator were 40 kV and 40 mA. All XRD spectra were acquired in the 2θ range of 10-90 degrees with a step size of 0.04° (2 s acquisition time per step). Micro-Raman spectroscopy (Renishaw, in Via Reflex) was used for the structural confirmation of the as-prepared samples. Raman spectra were acquired with a 532 nm laser at a low laser power of 0.1 mW (1%×10 mW), to avoid the burning of the MnOx samples. The spectra were collected in the range of 100-2000 cm⁻¹ with a spot size of 2 μm. Three scans for each spectrum and a 50 s acquisition time for each scan were applied. Scanning electron microscopy (SEM, TESCAN VEGA3) at 20.0 kV was analyzed the morphology of the samples. X-ray photoelectron spectroscopy (XPS) was to determine the surface composition and chemical states of the as-prepared samples with a VG Escalab 220i-XL spectrometer which was equipped with a Mono Al Kα source (1486.6 eV). Survey spectra were obtained in the binding energy range of 0-1300 eV with a pass energy of 100 eV, while the high-resolution spectra of the targeted element (Mn 2p, Mn 3s, O 1s, C 1s, etc.) were collected at a pass energy of 20 eV. The XPS data were analyzed with CasaXPS software. The hydrocarbon component (284.6 eV) of C Is core level of accidental carbon impurity, an internal reference, was used to calibrated the binding energy of all XPS data. The deconvolution of the core level spectra was done after a Shirley background removal.

### ORR and OER Electrochemical Measurements

Half-cell activities of ORR and OER were evaluated with a rotating ring-disk electrode (RRDE) on a Pine Biopotentiostat of AFCBP1. An Ag/AgCl (4 M KCl) electrode, a Pt wire served as the reference electrode and counter electrode, respectively, and 0.1 M KOH aqueous solution as the electrolyte. A circular shape with a diameter of 4.9 mm of the on-substrate samples was attached to glassy carbon (5.61 mm in diameter) of an RRDE using Nafion solution and dried in air for 5 min.

For the ORR studies, CV curves were obtained at the RRDE in a static solution, for which the potential window for disk electrode was 0.2˜−0.7 V vs. Ag/AgCl, while the ring electrode was fixed at 0.6 V vs. Ag/AgCl. Then, linear sweep voltammograms (LSVs) were recorded at a scan rate of 5 mV s⁻¹ with a rotation speed of 1600 rpm. After CV and LSV measurements in the O₂-saturated electrolyte, the electrodes were carefully transferred to an N₂-saturated electrolyte to record CV and LSV curves to determine the capacitance background. The capacitance background in LSV curves was removed by using the current in the O₂-saturated electrolyte to subtract the current in the N₂-saturated electrolyte. At least three independent experiments were done to check the repeatability for each sample.

As to the OER studies, CV curves of the samples were recorded at 5 mV s⁻¹ for 3 cycles at a rotation speed of 1600 rpm in O₂-saturated electrolyte. The disk electrode was scanned in a potential window of 0˜0.8 V vs. Ag/AgCl, while the ring electrode was fixed at −0.5 V vs. Ag/AgCl. The capacitance background of OER was calibrated by taking an average of the positive and negative scans of the CV curves. Thus, all LSV curves in ORR and voltammograms in OER in this work only contain the Faradaic current related to ORR or OER. All potentials herein are reported versus the RHE reference electrode.

The electron transfer number (n) and the percentage of peroxides intermediates were calculated using Equations (1) and (2) where I_{d} and Iᵣ are the disk current and the ring current, respectively. The theoretical value of N, the collection efficiency of the RRDE, is 0.37. However, since the diameter of our circular sample was 4.9 mm, which was less than the diameter of the glassy carbon disk electrode (5.6 mm), the N was corrected as 0.346 due to the slight geometry change.

$$n = 4 \frac{{I}_{d}}{{I}_{d} + {I}_{r} / N} \qquad ( 1 )$$

$$Peroxides ( \% ) = 200 \frac{{I}_{r} / N}{{I}_{d} + {I}_{r} / N} \qquad ( 2 )$$

All the potential hereafter in half-cell ORR and OER part was converted to the values versus the reversible hydrogen electrode (RHE) according to the Nernst equation, i.e., Equation (3) where E_{RHE}. E_{AG/AgCl} and E⁰_{AG/AgCl} represent the applied potential vs. RHE, the applied potential versus Ag/AgCl (4 M KCl) reference electrode, and the standard electrode potential of the Ag/AgCl (4 M KCl, 0.197 V at 25° C.), respectively.

$${E}_{RHE} = {E}_{Ag / AgCl} + 0.0 \; 59 pH + {E}_{Ag / AgCl}^{0} \qquad ( 3 )$$

### Zn-Air Battery Performances Evaluation

The performance of the cathodes was studied in a homemade Zn-air battery (ZAB). First, the CSCs-based on-substrate samples served as the air-breathing cathodes. A piece of water-proofed CP (Toray, TGP-H-090) with the same size as the CSCs-based samples as a backing layer was placed next to the cathode but located towards the airside to avoid the leakage problem of electrolyte. The effective area of the cathode which was exposed to the electrolyte and the air was 0.785 cm⁻². A thickness of 0.38 mm Zn foil was polished to remove the surface ZnO layer before the battery assembly. Stainless steel mesh was applied as the current collector for cathode, and filter paper was the separator. The electrolyte of 6.0 M KOH with 0.2 M zinc acetate solution with a volume of 1.4 mL was injected into the electrolyte chamber.

An Autolab potentiostat/galvanostat (Model: PGSTAT302) was applied to measure the ZAB performances. Discharge and charge polarization curves were recorded at a current scan of 10⁻⁴ A s⁻¹. The specific capacity of the ZAB was measured by full discharging at a current density of 2 mA cm⁻² with a galvanostatic method. The cut-off voltage values for galvanostatic testing were 0.6 V (for discharge) and 3.0 V (for the charge). The stability of CSCs/MnOx-based batteries was measured with galvanostatic charge and discharge (GCD) method at the current density of 2 mA cm⁻² (10 min for a discharge and 10 min for a charge in each cycle) for 100 cycles, while the bare substrates-based (like CSCs, Func CSCs) batteries were recorded at a smaller current density of 0.5 mA cm⁻².

### Results and Discussion

### Morphology and Structure

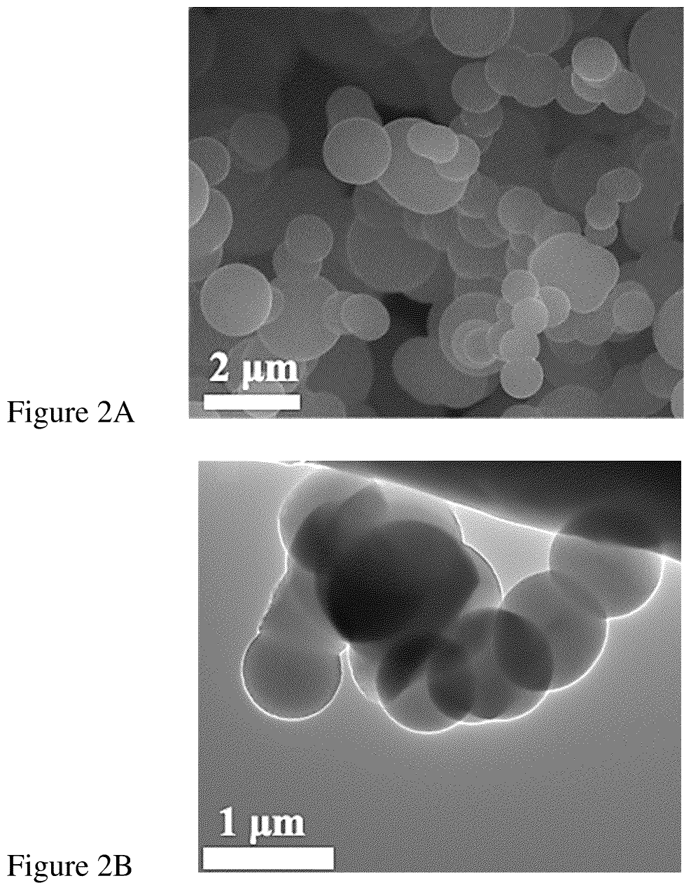

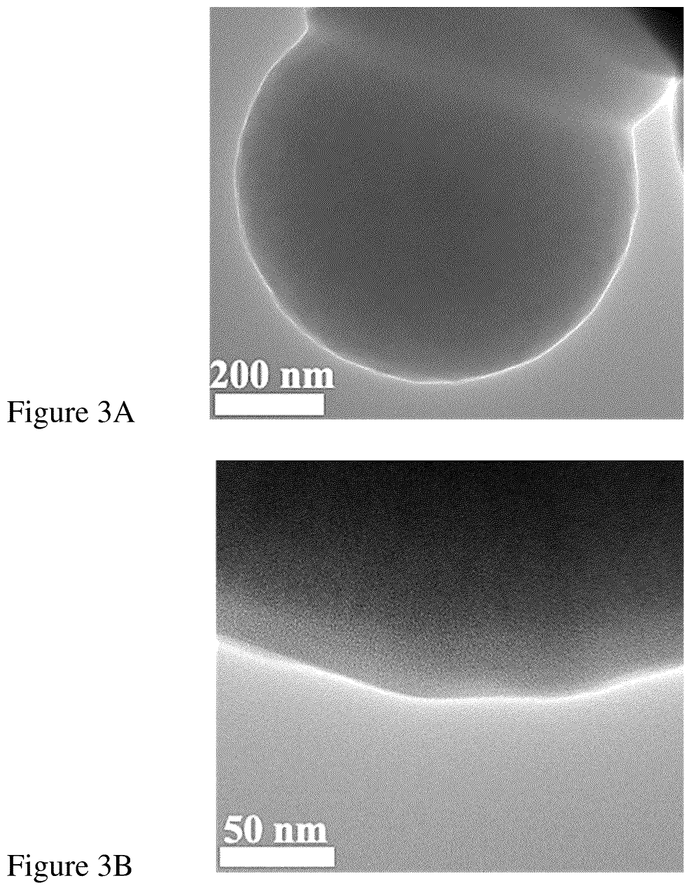

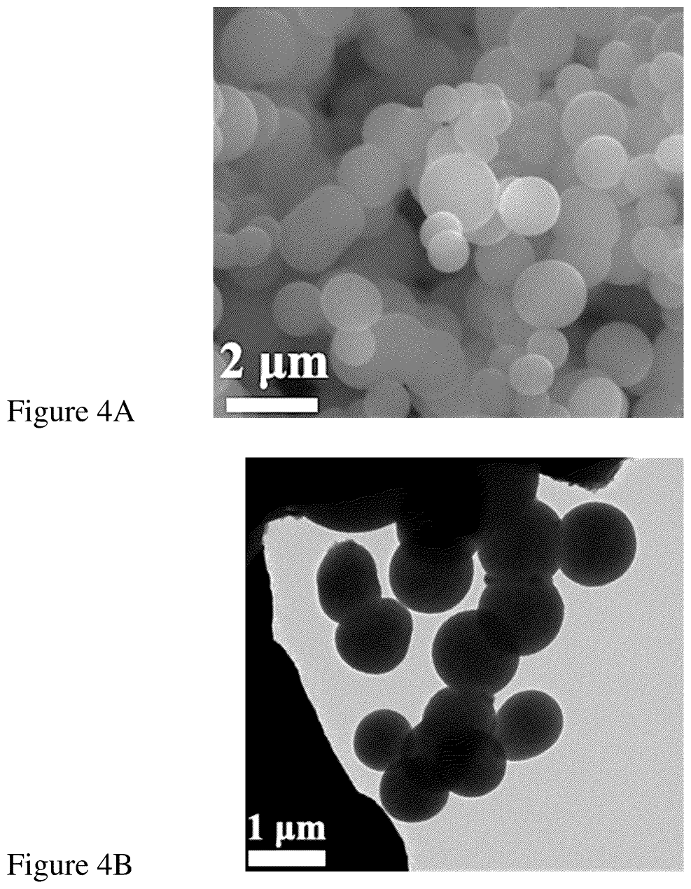

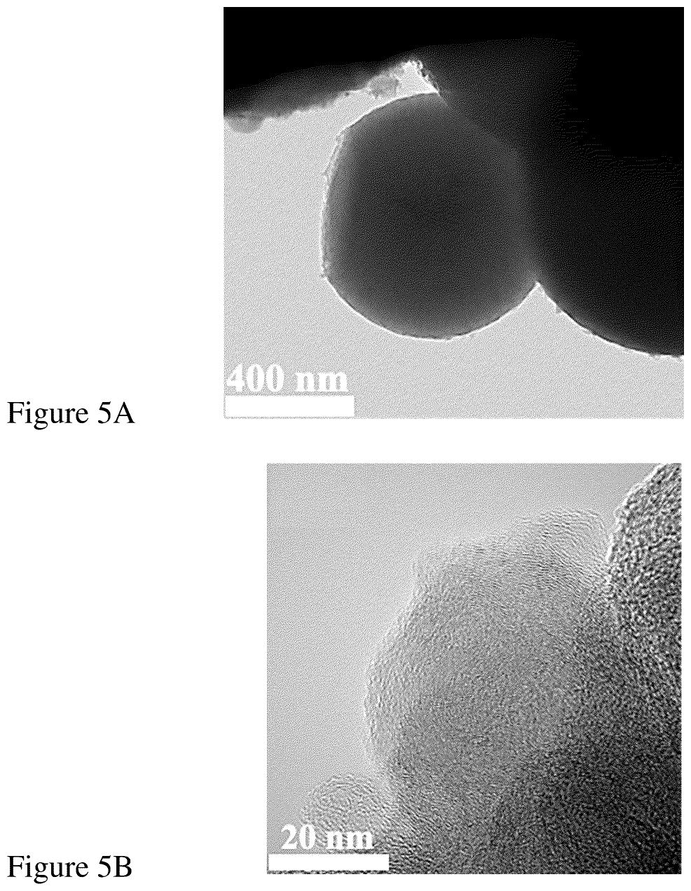

The SEM image in FIG. 2A shows that pristine CSCs are connected carbon sphere chains. After the functionalization procedure, the morphology of Func CSCs-2M (as shown in FIG. 4A) is almost unchanged. The TEM images in FIGS. 2B, 3A and 3B show that the surface of the carbon spheres in pristine CSCs is smooth. In contrast, the TEM images of carbon spheres Func CSCs-2M (FIGS. 4B to 5B) show rough spheres. Also, it is clear in FIGS. 5A and 5B show that nanobuds were introduced on the surface of carbon spheres after functionalization in a high concentration of HNO₃ as 2 M.

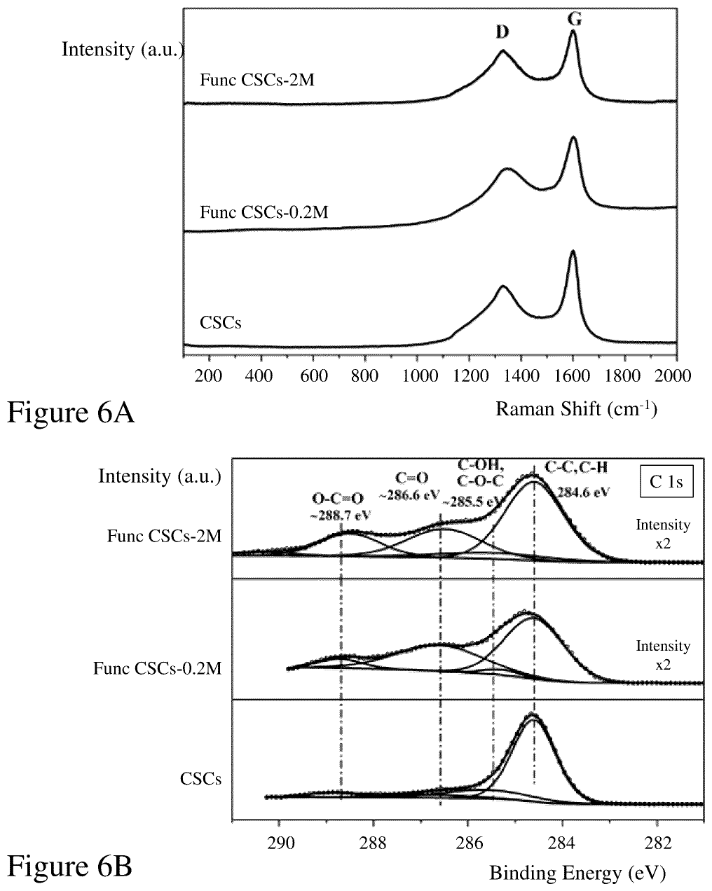

The Raman spectra of pristine CSCs and functionalized CSCs are shown in FIG. 6A. The two peaks around 1330 and 1600 cm⁻¹ were ascribed to the D and G bands, respectively, which relate to the edge or defect sites of carbon and the sp² carbon.^{[A25]} The ratios of I_{D}/I_{G} (based on the deconvolution area) of the pristine CSCs, Func CSCs-0.2M, and Func CSCs-2M are 1.97, 1.91, and 2.28. The obvious enhancement of the ratio of I_{D}/I_{G} of Func CSCs-2M suggests the effectiveness of rich edges and defects is successfully created after functionalization in high molarity of nitric acid, while a moderate functionalization in Func CSCs-0.2M has a similar ratio of I_{D}/I_{G} as the pristine CSCs.

The XPS survey spectra of pristine CSCs, Func CSCs-0.2M, and Func CSCs-2M, as shown in FIG. 6B, reveal only two element: C and O. The atomic ratio of O element based on the survey spectra of the pristine CSCs, Func CSCs-0.2M, and Func CSCs-2M are 14.24, 25.29, and 27.08%, respectively. This indicates that there are more defects in Func CSCs-2M resulting from more surface oxygen-containing functionalities (like hydroxyl groups, quinonyl, or carboxyl).

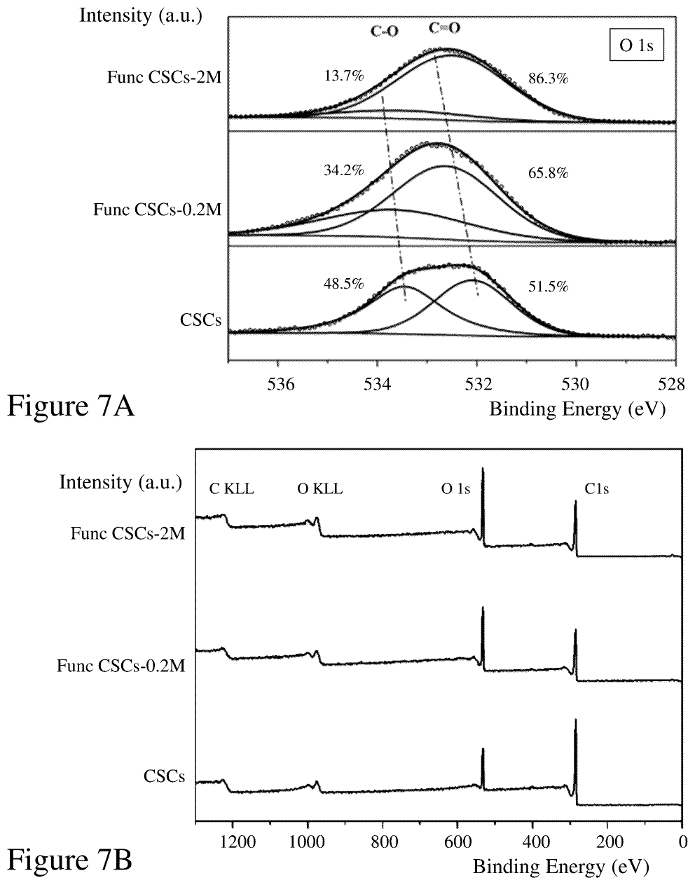

The high-resolution XPS of C1s spectra of these substrate (in FIG. 6B) clearly show an increased fraction of C═O at approximately 286.6 eV and O−C=O at ˜288.7 eV in functionalized CSCs. The high-resolution XPS spectra of O1s in FIG. 7A also show an increased fraction of C—O as a high degree of functionalization.

The SEM images in FIGS. 8A to 10B respectively depict the morphology after growth of MnOx on the above CSCs substrate. This morphology consists of MnOx nanorods covering the surface the pristine and functionalized CSCs substrates. The nanorods exhibit a similar morphology on each of the substrates.

The XRD patterns in FIG. 11A suggest that the MnOx nanorods, on each substrate, are made of α-MnOx. The peak marked with an asterisk at 26.5° of 2θ corresponds to the graphite carbon substrate. The other peaks at 2θ of 12.7°, 18.1°, 25.6°, 28.7°, 37.6°, 42.0°, 49.9°, 54.6°, 60.2°, and 65.3° were well-indexed to (110), (200), (220), (310), (211), (301), (411), (530), (521), and (002) planes of cryptomelane-type manganese oxide (KMn₈O₁₆) (Joint Committee on Powder Diffraction Standards, JCPDS 29-1020), a typical α-MnOx phase which K⁺ is located in its 2×2 tunnel to stabilize the α phase crystalline structure. This indicates that α-MnOx nanorods were successfully grown on the pristine CSCs and Func CSCs substrate.

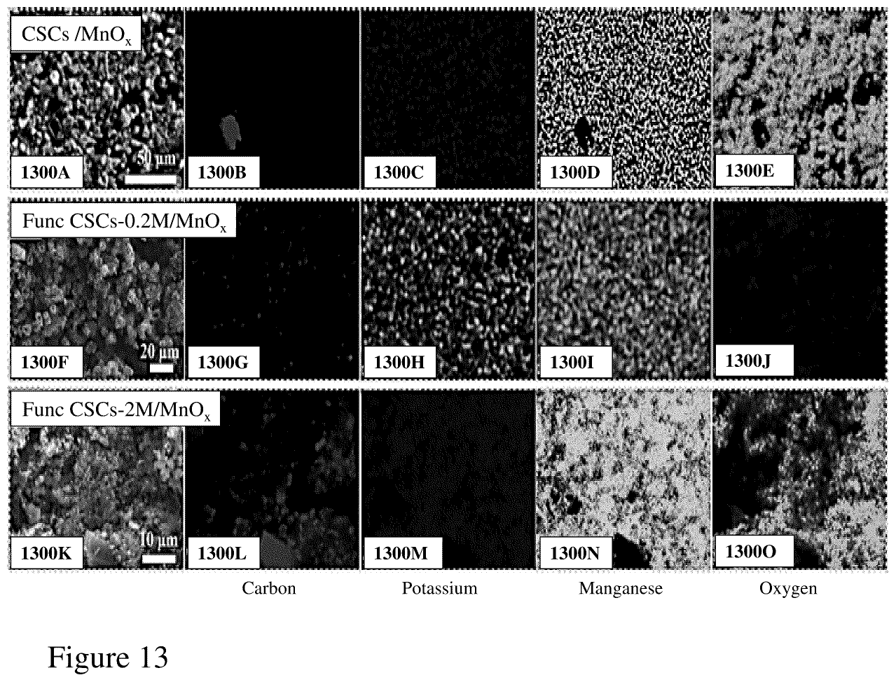

The EDS mapping based on SEM is depicted in FIG. 13 comprising first to fifteenth Images 1300A to 13000 respectively. First to fifth Images 1300A to 1300E being SEM image and EDS images of C, K, Mn, and O respectively for CSCs/MnOx. Sixth to tenth Images 1300F to 1300J being SEM image and EDS images of C, K, Mn and O respectively for 0.2 molar ratio Func CSCs-0.2M/MnOx. Eleventh to fifteenth Images 1300K to 13000 being SEM image and EDS images of C, K, Mn and O respectively for 2.0 molar ratio CSCs-2M/MnOx. The magnifications for the SEM and EDS images of CSCs/MnOx, Func CSCs-0.2M/MnOx and Func CSCs-2M/MnOx being at different magnifications as evident from the size markers within the SEM images, namely first Image 1300A, sixth Image 1300F and eleventh Image 1400K respectively.

From these EDS images it is evident that there is a uniform distribution of elements of K, Mn, and O further confirming the structures as comprising KMn₈O₁₆.

The Raman spectra was used to confirm the crystalline structure of the as-prepared electrodes. As shown in FIG. 11B, the three as-prepared samples displayed four Raman peaks around ˜184, ˜370, ˜571, and ˜642 cm⁻¹, which were identified as the characteristic peaks of manganese oxides. The two strongest peaks at ˜571, and ˜642 cm⁻¹, both of A_{1g} symmetry spectroscopic modes according to Factor group analysis, are regarded to the vibration in [MnO₆] octahedral. The former peak is ascribed to the stretching vibration mode of Mn—O bond along the direction of [MnO₆] double chains; while the latter is related to the symmetric stretching vibration mode of Mn—O bond in [MnO₆] octahedral. The peak at around 370 cm⁻¹ is ascribed to the bending vibration of the Mn—O bond. The intense peak at 184 cm⁻¹ is the translational vibration mode effect of [MnO₆] octahedral with the tunnel cation of K.

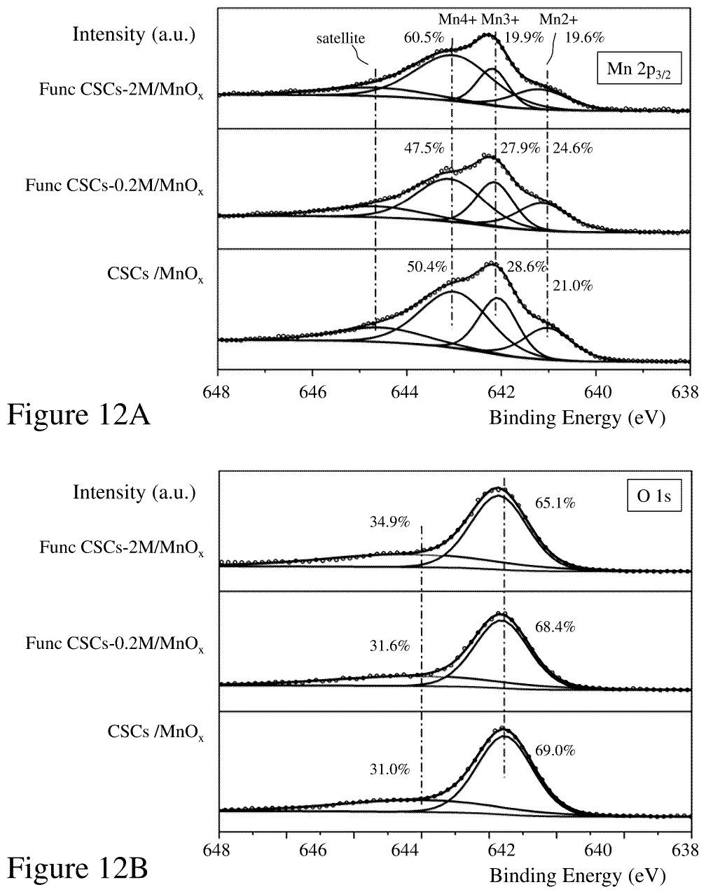

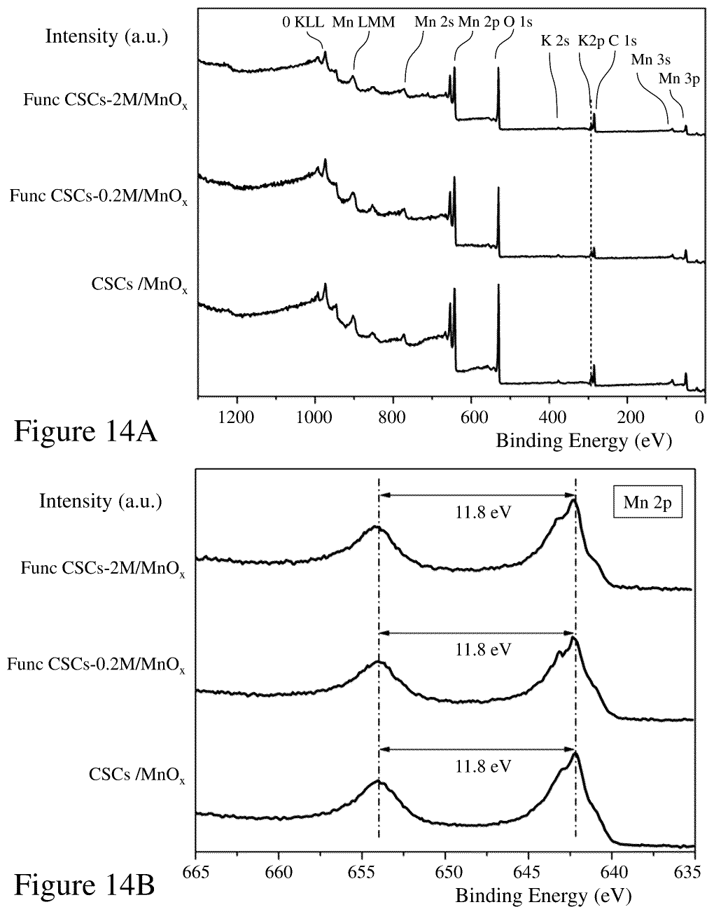

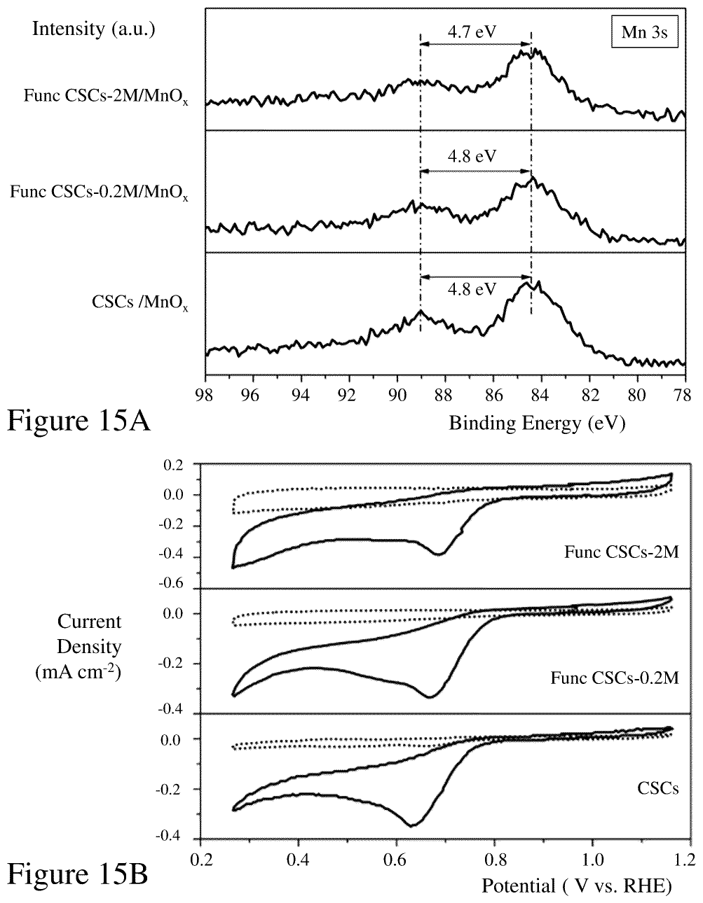

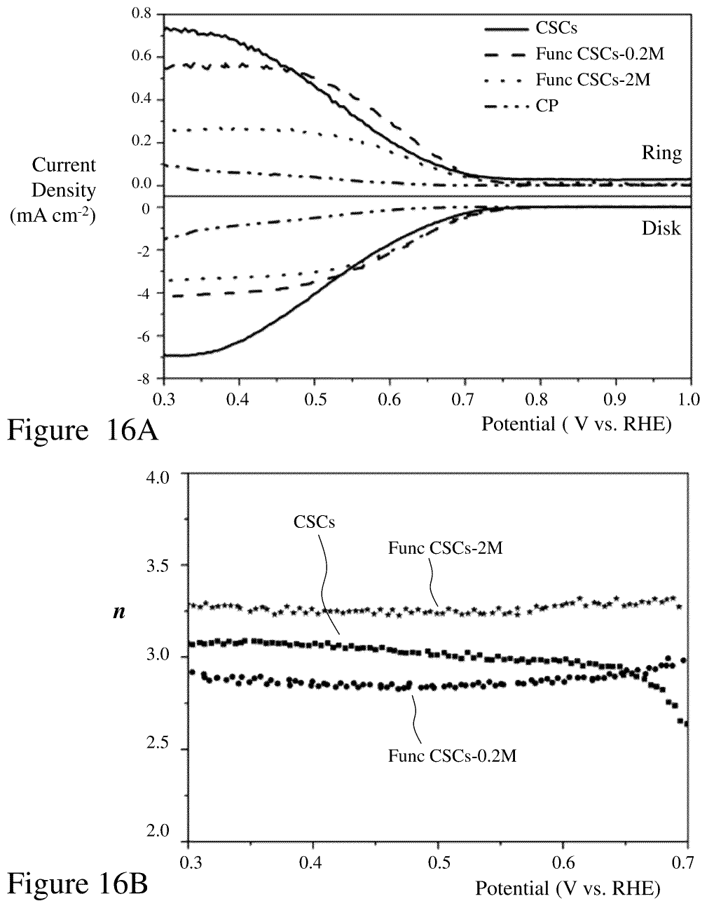

The XPS spectra of MnOx on CSCs-based substrates are shown in FIGS. 12A-12B and FIG. 16A. The survey spectra of as-prepared MnOx samples as reported in FIGS. 14A, 14B and 15A reveal the presence of elements Mn, O, K, and C. The atomic ratios of these four elements based on the survey spectra are reported in Table 1. The ratios of Mn/K of as-prepared samples of CSCs/MnOx, Func CSCs-0.2M/MnOx, and Func CSCs-2M/MnOx are 5.56, 7.53, and 5.67, respectively, which is smaller than 8 from the structure of KMn₈O₁₆.

TABLE 1
The atom ratio of XPS results based on the
survey spectra of hybrid CSCs-based/MnOx.

| Element | CSCs/MnOx | Func CSCs-0.2M/MnOx | Func CSCs-2M/MnOx |
|---|---|---|---|
| K | 3.34 | 3.19 | 2.73 |
| Mn | 18.58 | 24.01 | 15.48 |
| O | 50.51 | 52.14 | 45.28 |
| C | 27.56 | 20.66 | 36.52 |

Mn 2p core-level spectra in FIG. 145B composed of two peaks attributed to the spin doublet Mn 2p_{3/2} and Mn 2p_{1/2}, show a spin energy separation of 11.8 eV indicating the typical structure of MnOx, which is in agreement with the bulk structure as revealed in XRD. As shown in FIG. 2f, the deconvolution of the high resolution of Mn 2p_{3/2} displays four peaks. Among them, three peaks located at around 641.0, 642.1, and 643.0 eV are attributed to the main types of chemical states of Mn²⁺, Mn³⁺, and Mn⁴⁺, respectively. The fourth peak at around 644.6 eV is a shake-up satellite peak, which results from the surface species of Mn²⁺. The detailed atomic concentration of Mn²⁺, Mn³⁺, and Mn⁴⁺ species in these three MnOx samples (based on the peak area ratio) is summarized in Table 2.

TABLE 2
XPS results for Mn 2p, Mn 3s and O 1s of hybrid CSCs-based/MnOx.

| | | Mn 2p_{3/2} | | | | | | Mn 3s | | | | O 1s | | | |
|---|---|---|---|---|---|---|---|---|---|---|---|---|---|---|---|
| | Mn 2p | BE (eV) | | | Area (%) | | | BE (eV) | | | | BE (eV) | | Area (%) | |
| Sample | ΔE 2p | Mn²⁺ | Mn³⁺ | Mn⁴⁺ | Mn²⁺ | Mn³⁺ | Mn⁴⁺ | Peak 1 | Peak 2 | ΔE₃ₛ | AOS ^{a} | Oₗₐₜₜ | O_{ads} | Oₗₐₜₜ | O_{ads} |
| CSCs/MnOx | 11.8 | 641.0 | 642.1 | 643.0 | 21.0 | 28.6 | 50.4 | 84.26 | 89.02 | 4.8 | 3.53 | 529.8 | 531.0 | 69.0 | 31.0 |
| Func CSCs-0.2M/MnOx | 11.8 | 641.1 | 642.1 | 643.1 | 24.6 | 27.9 | 47.5 | 84.29 | 89.11 | 4.8 | 3.53 | 529.8 | 531.0 | 68.4 | 31.6 |
| Func CSCs-2M/MnOx | 11.8 | 641.2 | 642.2 | 643.0 | 19.6 | 19.9 | 60.5 | 84.34 | 89.04 | 4.7 | 3.64 | 529.9 | 531.1 | 65.1 | 34.9 |

The main valence of Mn⁴⁺ in the three as-prepared samples ranged from a portion of 47.5 to 60.5%, while the Mn³⁺ species accounts for 28.6, 27.9, and 19.9% for samples of CSCs/MnOx, Func CSCs-0.2M/MnOx, and Func CSCs-2M/MnOx, respectively. The core-level spectra of Mn 3s displayed common doublet separation peaks which resulted from the parallel spin coupling between the Mn 3s electron and Mn 3d electron in the photoelectron ejection process. The increase in the energy separation (ΔE₃ₛ) of the doublet peak will lead to the decrease of the average oxidation state (AOS) of Mn according to an experimental formula of AOS=8.95−1.13×ΔE₃ₛ. As the values summarized in Table 2, the ΔE₃ₛ of the samples of CSCs/MnOx, Func CSCs-0.2M/MnOx, and Func CSCs-2M/MnOx are 4.8, 4.8, and 4.7 eV, respectively. The very close of the ΔE₃ₛ leads to the ignorable Mn valence increase.

The high-resolution O 1s spectra (FIG. 12B) can be deconvoluted into two peaks at around ˜529.8 and 531.0 eV, which are ascribed to the lattice oxygen (Mn—O—Mn, Oₗₐₜₜ) and the chemical adsorbed oxygen (O_{ads}). The concentration of O_{ads} of CSCs/MnOx, Func CSCs-0.2M/MnOx, and Func CSCs-2M/MnOx are 31.0, 31.6, 34.9%, respectively.

### ORR and OER Studies

The ORR and OER electrochemical performances of the CSCs-based electrodes were studied in an RRDE half-cell configuration in the electrolyte of 0.1 M KOH. The ORR and OER electrochemical results of bare CSCs substrates (pristine and Func CSCs) are shown in FIGS. 15B to 18A respectively and summarized in Tables 3 and 4. Table 3 also presents a comparison with results reported in the literature.

In N₂-saturated 0.1M KOH electrolyte, both pristine CSCs and Func CSCs exhibit peakless CV curves (FIG. 15B), attributed to the double-layer capacitance. While in the O₂-saturated electrolyte, all CSC-based substrates displayed an evident broad peak that result from oxygen reduction reaction.

Turning now to the peak potentials summarized in Table 4, the more positive oxygen reduction peak potential was observed in the high degree of electrochemical functionality of CSCs substrate, and a 60 mV positive peak potential shift was obtained for Func CSCs-2M compared to the pristine CSCs.

TABLE 1
RRDE results comparison of ORR and OER in 0.1M KOH electrolyte.

| | | ORR | Limiting | | OER onset | | |
|---|---|---|---|---|---|---|---|
| | Peak | half-wave | current | electron | potential | OER Tafel | |
| | potential | potential | density | transfer | at 0.1 | slopes/mV | |
| Catalyst | in CV/V | (E_{1/2})/V | (j_{L})/mA cm⁻² | number (n) | mA cm⁻²/V | dec⁻¹ | Reference |
| CSCs/MnOx | 0.81 | 0.68 | 8.86 | 3.90 | 1.15 | 185 | This work |
| Func CSCs-0.2M/MnOx | 0.82 | 0.61 | 11.4 | 3.97 | 1.06 | 148 | This work |
| Func CSCs-2M/MnOx | 0.78 | 0.62 | 8.54 | 3.90 | 1.53 | 71 | This work |
| CNTs/MnOx | 0.79 | 0.75 | 4.66 | 3.82-3.95 | 1.57 | 93 | B1 |
| Func CNTs-7/MnOx | 0.80 | 0.78 | 5.16 | 3.91-3.96 | 1.55 | 92 | B1 |
| Func CNTs-15/MnOx | 0.81 | 0.79 | 5.43 | 3.93-3.98 | 1.53 | 84 | B1 |
| α-MnOx-H₂ (composite) | ~0.77 | 0.73 | 4.70 | ~4.0 | — | 199.6 | B2 |
| α-MnOx-air (composite) | ~0.62 | 0.58 | 4.58 | — | — | 258.3 | B2 |
| A-MnOx/TiC (composite) | 0.69 | 0.80 | ~5.40 | 3.66-3.96 | 1.45 | 110 | B3 |
| α-MnOx-SF (composite) | 0.86 | 0.79 | ~4.8 | 4.2 | — | 77.5 | B4 |
| α-MnOx-HT (composite) | 0.86 | 0.81 | ~4.2 | 3.7 | — | 87.7 | B4 |
| h-MnOxP_{0.21} (composite) | — | 0.85 | 5.6 | 3.99 | — | 74.1 | B5 |
| np-MnOx-ns (composite) | 0.77 | 0.73 | 5.8 | 3.92 | — | — | B6 |
| Ni SAs-Pd@NC (2:1) | ~0.82 | 0.84 | ~5.96 | ~3.90 | — | 79 | B7 |
| (composite) | | | | | | | |
| Fe porphyrin 1/CNT | ~0.78 | 0.84 | ~5.25 | 3.97 | 1.56 | 84 | B8 |
| (somposite) | | | | | | | |
| NPMC-1000 (composite) | ~0.86 | 0.85 | ~4 | >3.85 | — | — | B9 |
| Co-BTC-IMI (composite) | — | 0.80 | 5.00 | 3.75 | 1.50 | 88 | B10 |
| CMO/20N-rGO | — | 0.79 | ~5.25 | 3.9-4 | — | 80.2 | B11 |
| (composite) | | | | | | | |
| MS-LSC (composite) | 0.65 | 0.683 | 4.90 | 3.70-4.0 | 1.612 | — | B12 |
| CoZn-NC-700 (composite) | ~0.81 | 0.84 | 4.93 | ~3.97 | — | 77 | B13 |
| MnFe₂O₄/NiCo₂O₄ hybrid | 0.770 | 0.767 | 5.01 | ~4.0 | — | 46.7 | B14 |
| (composite) | | | | | | | |
| CoMn₂O₄—MnOOH NR | ~0.70 | 0.80 | ~5.10 | 3.88 | — | — | B15 |
| hybrid (composite) | | | | | | | |
| Co₃O₄/NHPC (composite) | — | 0.835 | 6.0 | 3.91 | — | 132 | B16 |
| CoS₂(400)/N,S-GO | ~0.78 | 0.79 | ~4.3 | 3.81 | — | 75 | B17 |
| (composite) | | | | | | | |
| CoFe/S-N-C (composite) | — | 0.855 | ~4.8 | 3.82-3.87 | — | 259 | B18 |
| Co-CoO/N-rGO | — | 0.78 | ~5.6 | 3.7-3.9 | — | 68 | B19 |
| (composite) | | | | | | | |
| Co₂P@CNF (free- | ~0.78 | 0.803 | 5.27 | ~3.6-3.9 | — | 113.21 | B20 |
| standing) | | | | | | | |
| FeP/Fe₂O₃@NPCA | 0.814 | 0.838 | 5.78 | — | — | 86 | B21 |
| (composite) | | | | | | | |
| NiSₓ freestanding | ~0.74 | 0.49 | ~4.8 | ~3.6 | — | 29 | B22 |
| holey film (FHF) | | | | | | | |
| (free-standing) | | | | | | | |

B1. Zheng, X.; Mohammadi, N.; Moreno Zuria, A.; Mohamedi, M. Advanced Zinc-Air Batteries with Free-Standing Hierarchical Nanostructures of the Air Cathode for Portable Applications. ACS Appl. Mater. Interfaces 2021, 13 (51), 61374-61385, DOI: 10.1021/acsami.1c22371.
B2. Zhuang, Q.; Ma, N.; Yin, Z.; Yang, X.; Yin, Z.; Gao, J.; Xu, Y.; Gao, Z.; Wang, H.; Kang, J.; Xiao, D.; Li, J.; Li, X.; Ma, D. Rich Surface Oxygen Vacancies of Mn02 for Enhancing Electrocatalytic Oxygen Reduction and Oxygen Evolution Reactions. Advanced Energy and Sustainability Research 2021, 2 (8), 2100030, DOI: 10.1002/aesr.202100030.
B3. Song, S.; Li, W.; Deng, Y.-P.; Ruan, Y.; Zhang, Y.; Qin, X.; Chen, Z. TiC supported amorphous MnOx as highly efficient bifunctional electrocatalyst for corrosion resistant oxygen electrode of Zn-air batteries. Nano Energy 2020, 67, 104208, DOI: 10.1016/j.nanoen.2019.104208.
B4. Meng, Y.; Song, W.; Huang, H.; Ren, Z.; Chen, S.; Suib, S. L. Structure-Property Relationship of Bifunctional MnO2 Nanostructures: Highly Efficient, Ultra-Stable Electrochemical Water Oxidation and Oxygen Reduction Reaction Catalysts Identified in Alkaline Media. J. Am. Chem. Soc. 2014, 136 (32), 11452-11464, DOI: 10.1021/ja505186m.
B5. Zhang, T.; Zhang, S.; Cao, S.; Yao, Q.; Lee, J. Y. A Self-Templating Redox-Mediated Synthesis of Hollow Phosphated Manganese Oxide Nanospheres as Noble-Metal-like Oxygen Electrocatalysts. Chem. Mater. 2018, 30 (22), 8270-8279, DOI: 10.1021/acs.chemmater.8b03681.
B6. Zhang, T.; Ge, X.; Zhang, Z.; Tham, N. N.; Liu, Z.; Fisher, A.; Lee, J. Y. Improving the Electrochemical Oxygen Reduction Activity of Manganese Oxide Nanosheets with Sulfurization-Induced Nanopores. ChemCatChem 2018, 10 (2), 422-429
B7. Wang, S.; Lin, Z.; Li, M.; Yu, Z.; Zhang, M.; Gong, M.; Tang, Y.; Qiu, X. Coupling isolated Ni single atoms with sub-10 nm Pd nanocrystals embedded in porous carbon frameworks to boost oxygen electrocatalysis for Zn-air batteries. J. Mater. Chem. A 2021, DOI: 10.1039/d1ta06897k.
B8. Xie, L.; Zhang, X. P.; Zhao, B.; Li, P.; Qi, J.; Guo, X.; Wang, B.; Lei, H.; Zhang, W.; Apfel, U. P.; Cao, R. Enzyme-Inspired Iron Porphyrins for Improved Electrocatalytic Oxygen Reduction and Evolution Reactions. Angew. Chem. Int. Ed. 2021, 60 (14), 7576-7581, DOI: 10.1002/anie.202015478.
B9. Zhang, J.; Zhao, Z.; Xia, Z.; Dai, L. A metal-free bifunctional electrocatalyst for oxygen reduction and oxygen evolution reactions. Nat. Nanotechnol. 2015, 10 (5), 444-452, DOI: 10.1038/nnano.2015.48.
B10. Wang, H.; Zhang, X.; Yin, F.; Chu, W.; Chen, B. Coordinately unsaturated metal-organic framework as an unpyrolyzed bifunctional electrocatalyst for oxygen reduction and evolution reactions. J. Mater. Chem. A 2020, 8 (42), 22111-22123, DOI: 10.1039/d0ta04331a.
B11. He, X. B.; Yin, F. X.; Yuan, S.; Liu, N.; Huang, X. F. Hybrid Spinel Oxides/N-Doped Reduced Graphene Oxide as Highly Active Bifunctional Electrocatalysts for Oxygen Reduction/Evolution Reactions. Chemelectrochem 2016, 3 (7), 1107-1115, DOI: 10.1002/celc.201600061.
B12. Bie, S. Y.; Zhu, Y. Q.; Su, J. M.; Jin, C.; Liu, S. H.; Yang, R. Z.; Wu, J. One-pot fabrication of yolk-shell structured La0.9Sr0.1Co03 perovskite microspheres with enhanced catalytic activities for oxygen reduction and evolution reactions. J. Mater. Chem. A 2015, 3 (44), 22448-22453, DOI: 10.1039/c5ta05271h.
B13. Chen, B.; He, X.; Yin, F.; Wang, H.; Liu, D. J.; Shi, R.; Chen, J.; Yin, H. MO—Co@ N-Doped Carbon (M = Zn or Co): Vital Roles of Inactive Zn and Highly Efficient Activity toward Oxygen Reduction/Evolution Reactions for Rechargeable Zn-Air Battery. Adv. Funct. Mater. 2017, 27 (37), 1700795.
B14. Zhang, Y. Q.; Li, M.; Hua, B.; Wang, Y.; Sun, Y. F.; Luo, J. L. A strongly cooperative spinel nanohybrid as an efficient bifunctional oxygen electrocatalyst for oxygen reduction reaction and oxygen evolution reaction. Appl. Catal. B-Environ. 2018, 236, 413-419, DOI: 10.1016/j.apcatb.2018.05.047.
B15. Wang, Y.; Hu, T. J.; Liu, Q.; Zhang, L. M. CoMn2O4 embedded in MnOOH nanorods as a bifunctional catalyst for oxygen reduction and oxygen evolution reactions. Chem. Commun. 2018, 54 (32), 4005-4008, DOI: 10.1039/c8cc00870a.
B16. Guan, J. L.; Zhang, Z. P.; Ji, J.; Dou, M. L.; Wang, F. Hydrothermal Synthesis of Highly Dispersed Co3O4 Nanoparticles on Biomass-Derived Nitrogen-Doped Hierarchically Porous Carbon Networks as an Efficient Bifunctional Electrocatalyst for Oxygen Reduction and Evolution Reactions. ACS Appl. Mater. Interfaces 2017, 9 (36), 30662-30669, DOI: 10.1021/acsami.7608533.
B17. Ganesan, P.; Prabu, M.; Sanetuntikul, J.; Shanmugam, S. Cobalt Sulfide Nanoparticles Grown on Nitrogen and Sulfur Codoped Graphene Oxide: An Efficient Electrocatalyst for Oxygen Reduction and Evolution Reactions. ACS Catal. 2015, 5 (6), 3625-3637, DOI: 10.1021/acscatal.5b00154.
B18. Li, G.; Tang, Y.; Fu, T.; Xiang, Y.; Xiong, Z.; Si, Y.; Guo, C.; Jiang, Z. S,N co-doped carbon nanotubes coupled with CoFe nanoparticles as an efficient bifunctional ORR/OER electrocatalyst for rechargeable Zn-air batteries. Chemical Engineering Journal 2022, 429, DOI: 10.1016/j.cej.2021.132174.
B19. Liu, X.; Liu, W.; Ko, M.; Park, M.; Kim, M. G.; Oh, P.; Chae, S.; Park, S.; Casimir, A.; Wu, G.; Cho, J. Metal (Ni, Co)-Metal Oxides/Graphene Nanocomposites as Multifunctional Electrocatalysts. Adv. Funct. Mater. 2015, 25 (36), 5799-5808, DOI: 10.1002/adfm.201502217.
B20. Gao, J.; Wang, J.; Zhou, L.; Cai, X.; Zhan, D.; Hou, M.; Lai, L. Co2P@N,P-Codoped Carbon Nanofiber as a Free-Standing Air Electrode for Zn-Air Batteries: Synergy Effects of CoNx Satellite Shells. ACS Appl. Mater. Interfaces 2019, 11 (10), 10364-10372, DOI: 10.1021/acsami.8b20003.
B21. Wu, K.; Zhang, L.; Yuan, Y.; Zhong, L.; Chen, Z.; Chi, X.; Lu, H.; Chen, Z.; Zou, R.; Li, T.; Jiang, C.; Chen, Y.; Peng, X.; Lu, J. An Iron-Decorated Carbon Aerogel for Rechargeable Flow and Flexible Zn-Air Batteries. Adv. Mater. 2020, 32 (32), 2002292, DOI: 10.1002/adma.202002292.
B22. Marcus, K.; Liang, K.; Niu, W. H.; Yang, Y. Nickel Sulfide Freestanding Holey Films as Air-Breathing Electrodes for Flexible Zn-Air Batteries. Journal of Physical Chemistry Letters 2018, 9 (11), 2746-2750, DOI: 10.1021/acs.jpclett.8b00925.

TABLE 4
Comparison of ORR performance (RRDE) of CSCs-based electrodes

| | Peak | Half-wave | Limiting | Electron | |
|---|---|---|---|---|---|
| | potential | potential | current density | transfer | Peroxides |
| Catalyst | in CV/V | (E_{1/2})/V | (j_{L})/mA cm⁻² | number (n) | % |
| CSCs | 0.63 | 0.52 | 6.94 | 2.64-3.09 | 45.5-68.1 |
| CSCs/MnOx | 0.81 | 0.66 | 8.86 | 3.82-3.97 | 1.72-9.06 |
| Func CSCs-0.2M | 0.67 | 0.60 | 4.20 | 2.83-2.99 | 50.4-58.7 |
| Func CSCs-0.2M/MnOx | 0.82 | 0.60 | 11.4 | 3.97-3.98 | 0.78-1.63 |
| Func CSCs-2M | 0.69 | 0.63 | 3.40 | 3.23-3.32 | 34.0-38.7 |
| Func CSCs-2M/MnOx | 0.78 | 0.61 | 8.54 | 3.86-3.94 | 3.23-6.87 |

As shown in FIG. 16A, the LSVs curves of the disk electrode show that as a high degree of functionalization went by, the more positive half-wave potential was observed. However, the limiting current density (J_{L}) was decreased with Func CSCs.

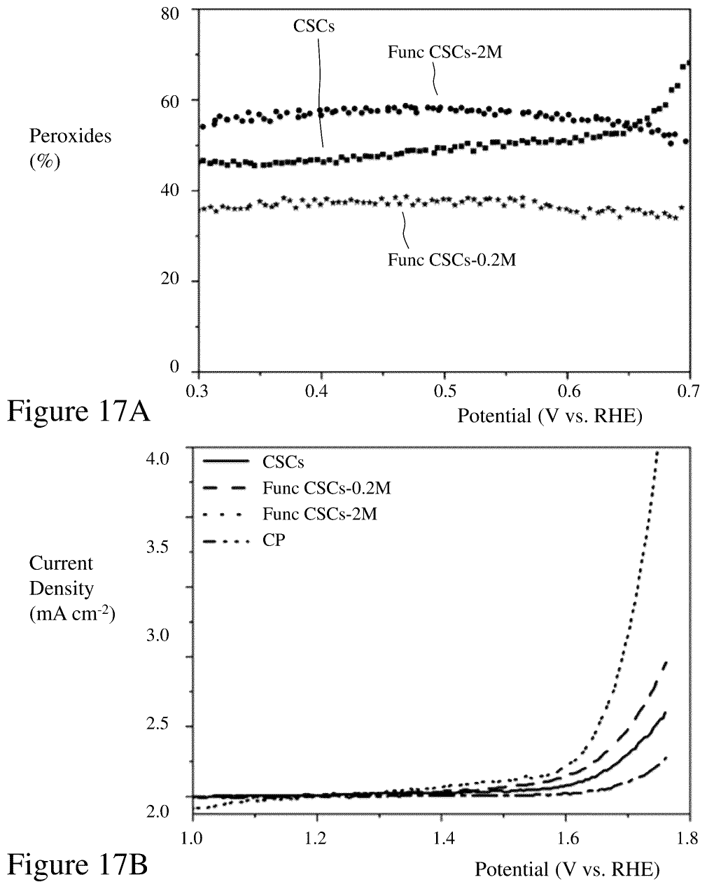

The electron transfer number (n) and the yield of intermediate peroxides were calculated from the ring and disk current of LSVs and are shown in FIGS. 16B and 17A respectively. The electron transfer number of around 3 and a high percentage of peroxides indicates a mixed 2-electron and 4-electron reduction pathway, in which oxygen molecular to hydroperoxide (HO₂⁻) dominated ORR. The substrate of Func CSCs-2M showed an obvious enhancement of the electron transfer number with an effective decrease of the intermediate peroxides which are unfavorable for ORR.

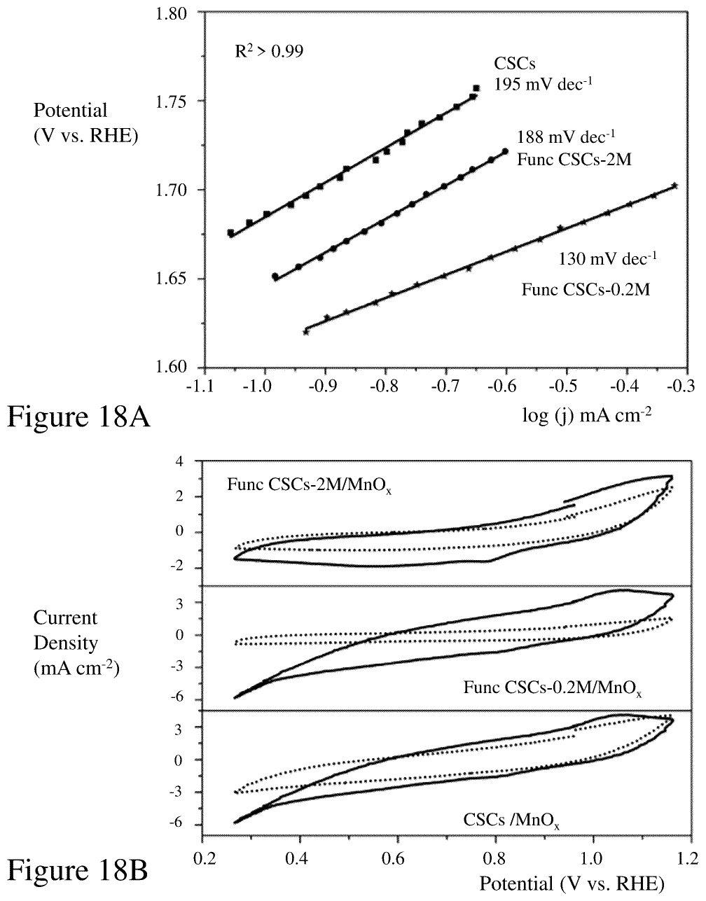

The capacitance-corrected voltammetry curves of OER towards CSC-based substrates in FIG. 17B showed that with a higher degree of functionalization, the lower onset potential, as well as high faradaic current, was observed. The further Tafel analysis, FIG. 18A, shows that within a quite high overpotential region of 380-530 mV, pristine CSCs have the highest Tafel slope of 195 mV dec⁻¹ while Func CSCs-2M has the lowest value of 130 mV dec⁻¹. The evaluation of the ORR and OER activities of pristine and Func CSCs will give a better understanding of the CSCs substrates in the below hybrid electrodes.

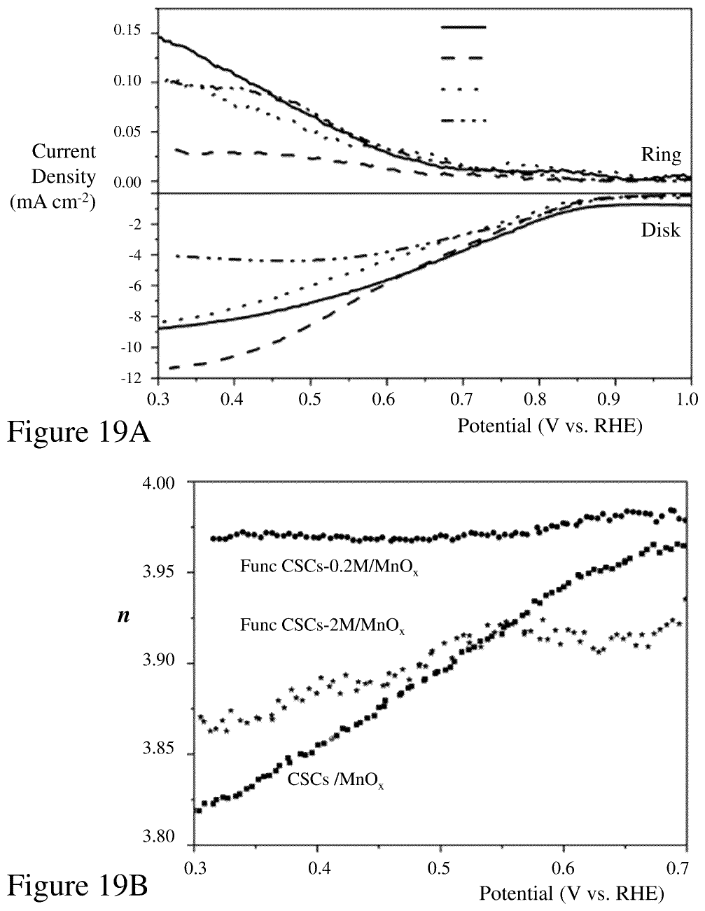

The ORR and OER activities of hybrid CSCs-based/MnOx catalysts are shown in FIGS. 19A-21A respectively and Table 4. The CVs in the O₂-saturated electrolyte in FIG. 19A show a small oxygen reduction peak at a small scan rate as slow as 5 mV s⁻¹, which is probably attributed to the high capacitance of the hybrid electrodes. Of these hierarchical MnOx samples, CSCs/MnOx, Func CSCs-0.2M/MnOx, and Func CSCs-2M/MnOx delivered an ORR peak centered at 0.81, 0.82, and 0.78 V, respectively, indicating their excellent ORR activities.

The LSV curves as reported in FIG. 19A showed that the j_{L} of CSCs-based MnOx was much higher than those of pristine CSCs or Func CSCs counterparts in FIG. 3b and the CP/MnOx we previous published.^{[A5]} The super high limiting current density is attributed to the fairly rough surface as discussed in SEM analysis.

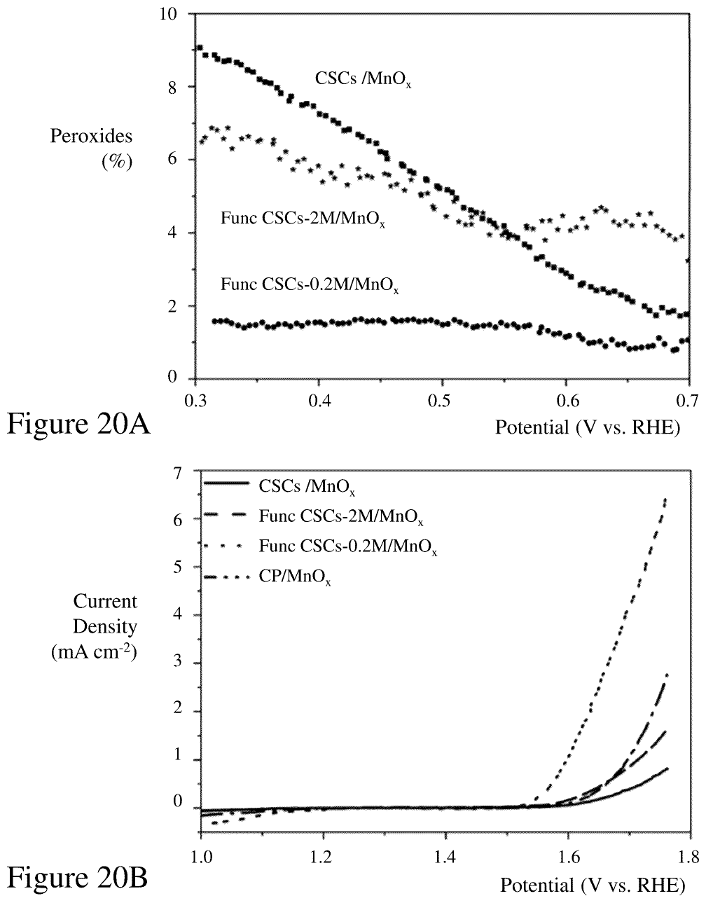

The electron transfer number and the intermediate peroxides percentage results are shown in FIGS. 19B and 20A respectively. Within the potential region of 0.3-0.7 V, the electron transfer number of all the hierarchical CSCs-based MnOx electrodes are above 3.8, and over 3.97 for Func CSCs-0.2M/MnOx indicates the rather high electron efficiency in oxygen reduction and a truly close to 4, the theoretical limit of oxygen reduction. Within the same potential region, the percentage of peroxides of all hierarchical CSCs-based MnOx electrodes were lower than 9.06%, especially for Func CSCs-0.2M/MnOx (less than 1.63%).

Based on the above analysis, a remarkable close to 4 electron transfer number and a smaller percentage of peroxides indicates an apparent 4-electron reduction route for the CSCs/MnOx-based electrocatalysts, which was initiated by a two-electron reduction pathway from single oxygen molecular to a hydroperoxide and followed by a second two-electron reduction from hydroperoxide to hydroxide. This is in accord with the ORR pathway of α-MnOx catalyst in alkaline media (0.1 M KOH) in the literature.^{[A7, A33]}

Comparing these ORR results with those of CSCs-based substrates, a hybrid with intimately connected CSCs and MnOx results in a strong synergetic effect between the CSCs substrates and the directly grown MnOx nanorods arrays, which greatly enhance the ORR activity including a positive shift CV peak potential in static CV profiles, an efficiently high limiting current density, a high electron transfer number, and a significant decline in the intermediate of peroxides.

The capacitance-corrected voltammetry curves of OER towards hybrid CSCs-based/MnOx in FIG. 20B suggested that the faradaic current density of CSCs/MnOx, Func CSCs-0.2M/MnOx, and Func CSCs-2M/MnOx were 0.81, 1.64, and 6.49 mA cm⁻², respectively at the maximum potential of 1.76 V. The onset potential of CSCs/MnOx, Func CSCs-0.2M/MnOx, and Func CSCs-2M/MnOx were 1.62, 1.58 and 1.53 V, respectively.

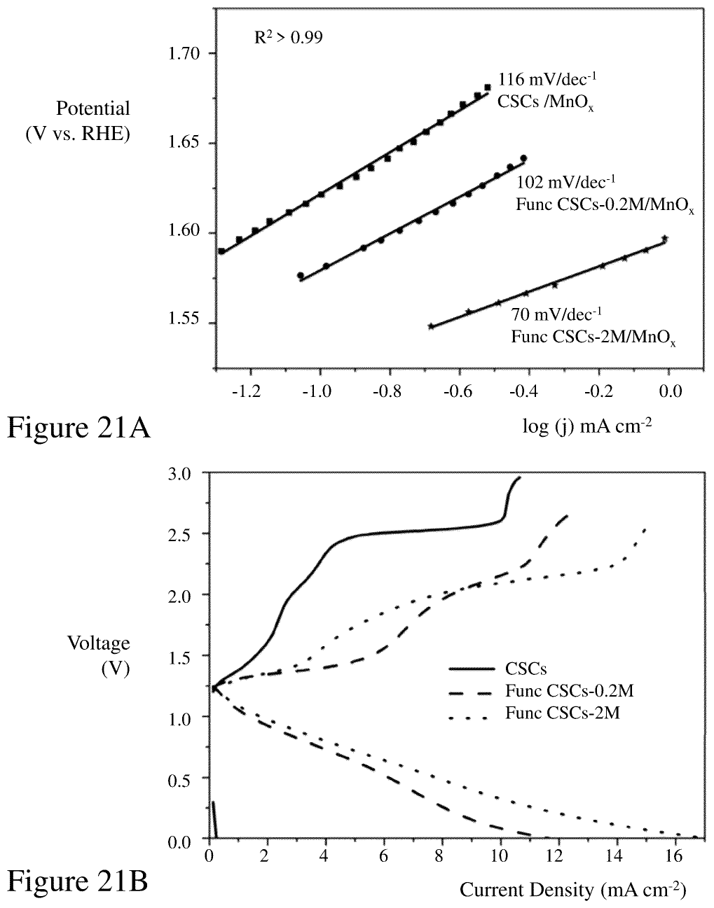

Tafel plots derived from the capacitance-corrected voltammetry curves of FIG. 20B are displayed in FIG. 21A and Table 5. Within a quite high overpotential region of 310-460 mV, the Tafel slope of CSCs/MnOx, Func CSCs-0.2M/MnOx, and Func CSCs-2M/MnOx were 116, 102, and 70 mV dec⁻¹, respectively. A smaller value of Tafel slope in Func CSCs-2M/MnOx indicates the more rapid in OER kinetics. Both the analysis of overpotential and Tafel slope suggests the functionalization in CSCs substrates can enhance the OER activity, and the MnOx in combination with the Func CSCs can efficiently improve the OER performance.

TABLE 5
Comparison of OER performance of CSCs-based electrodes.

| | Potential | Current | |
|---|---|---|---|
| | at current | density | |
| | density of 0.8 | at 1.76 V/ | Tafel slope |
| Catalyst | mA cm⁻²/V | mA cm⁻² | (mV dec⁻¹) |
| CSCs | 1.69 | 0.24 | 195 |
| CSCs/MnOx | 1.62 | 0.81 | 116 |
| Func CSCs-0.2M | 1.65 | 0.38 | 188 |
| Func CSCs-0.2M/MnOx | 1.58 | 1.64 | 102 |
| Func CSCs-2M | 1.61 | 0.98 | 130 |
| Func CSCs-2M/MnOx | 1.53 | 6.49 | 70 |

Within the preceding description an electrode employing an electrocatalyst has been described. The electrocatalyst comprising a plurality of carbon sphere chains, each carbon sphere chain having a functionalized surface comprising oxygen-containing functional groups and a plurality of MnOx nanorods, each MnOx nanorod having an end attached to a region of the functionalized surface of a carbon sphere chain of the plurality of carbon sphere chains and extending away from the functionalized surface.

The plurality of carbon sphere chains forming the electrocatalyst are attached to a surface of a current collector and the carbon sphere chains extend away from the surface. The oxygen-containing functional groups of the electrocatalyst have an I_{D}/I_{G} ratio greater than the I_{D}/I_{G} ratio of non-functionalized carbon sphere chains.

The electrode comprising the electrocatalyst forms part of one of a metal-air battery, a zinc-air battery, an air-breathing polymer electrolyte fuel cell and a water electrolyser. The electrode comprising the electrocatalyst is one of an oxygen reduction reaction (ORR) electrode, an oxygen evolution reaction (OER) electrode and a bifunctional ORR and OER electrode.

### Zn-Air Battery Performance Studies

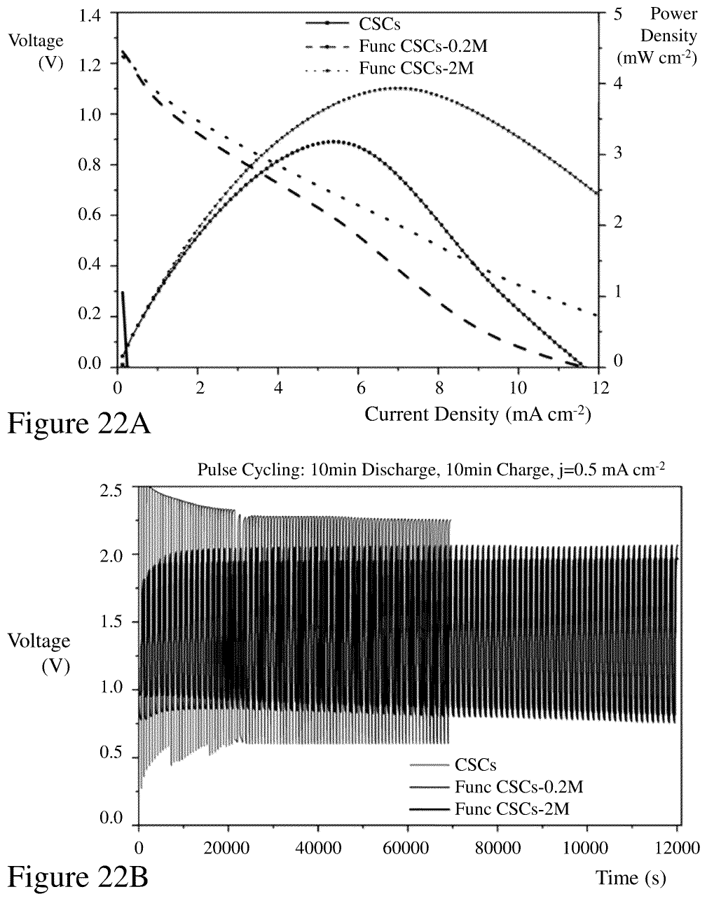

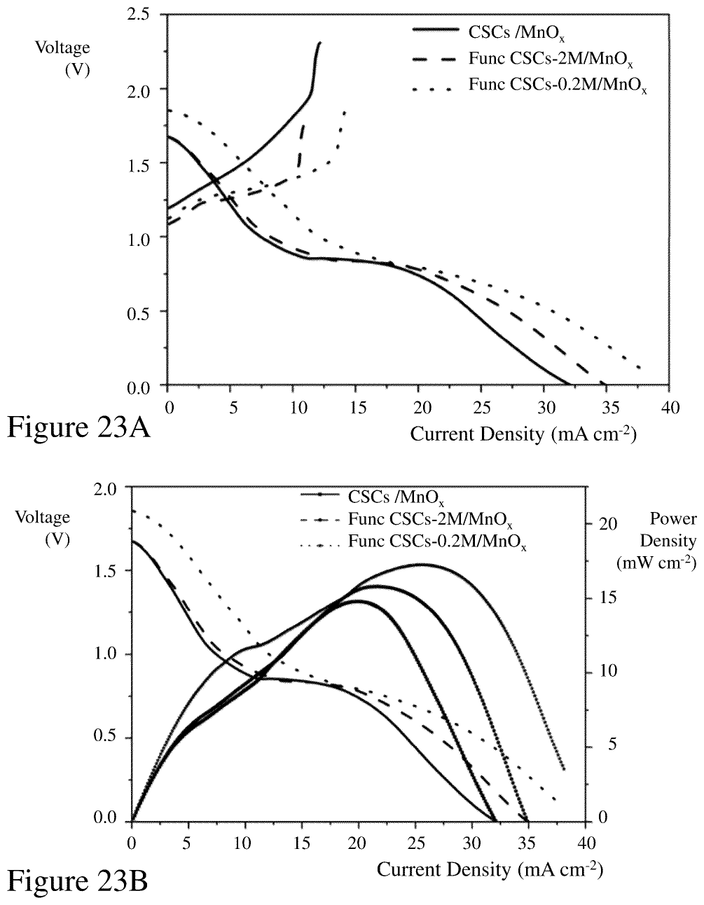

The Zn-air batteries performance were evaluated in a homemade battery setup, see “Advanced Zinc-Air Batteries with Free-Standing Hierarchical Nanostructures of the Air Cathode for Portable Applications” (ACS Appl. Mater. Interfaces 2021, 13, 51, 61374-61385). The polarization curves of discharge and charge are shown in FIGS. 21B and 23A respectively. The power density derived from the discharge polarization curves was displayed in FIGS. 22A and 23B respectively. The pristine CSCs, Func CSCs-0.2M, and Func CSCs-2M substrates exhibited the highest power density of 0.038, 3.18, and 3.93 mA cm⁻² at the current density of 0.128, 5.39, and 6.93 mA cm⁻², respectively. While the Func CSCs-2M/MnOx Zn-air battery achieved the peak power density of 17.3 mW cm⁻² at the current density of 25.7 mA cm⁻². While the Func CSCs-0.2M/MnOx Zn-air battery had the highest power density of 15.8 mW cm⁻² (at the current density of 21.7 mA cm⁻²), and CSCs/MnOx Zn-air battery exhibited a peak power density of 14.8 mW cm 2 at the current density of 19.9 mA cm⁻². The peak power density was substantially enhanced after a combination of MnOx with CSCs substrates.

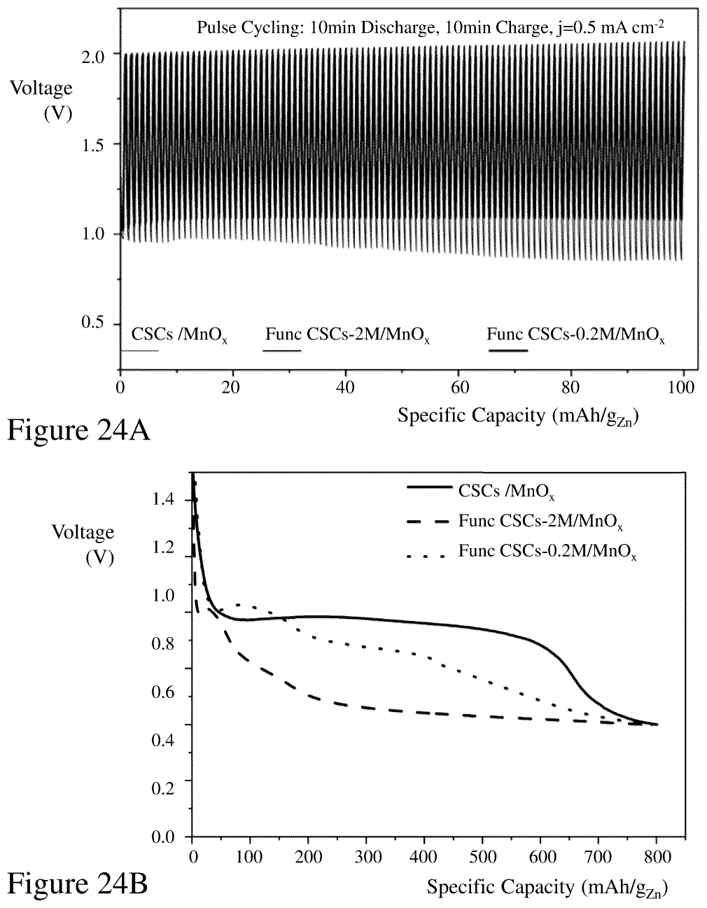

The increased functionalization of CSCs increased the peak density, and the MnOx coupled CSCs showed a synergetic effect in enhancing the battery discharge performance. As shown in FIG. 24B, based on the consumed Zn, the specific capacities of the Zn batteries based on the cathode of CSC/MnOx, Func CSCs-0.2M/MnOx, and Func CSCs-2M/MnOx were 801.1, 780.9, and 792.0 mAh g_{Zn}⁻¹, respectively, which are very close to the theoretical value of 820 mAh g_{Zn}⁻¹.^{[A34]} The energy density (oxygen excluded) of the Zn batteries based on the cathode of CSC/MnOx, Func CSCs-0.2M/MnOx. and Func CSCs-2M/MnOx were 729.0, 541.2, and 657.4 Wh kg_{Zn}⁻¹, respectively.

The cyclic stability of the Zn-air batteries was studied with the method of galvanostatic charge and discharge (GCD) for 100 cycles, which did not require the disassembly to the battery to replace the Zn plate or the cathode during the cyclic test. As shown in FIG. 22B, CSCs substrates could bear a small current density of 0.5 mA cm⁻². Since pristine CSCs is very hydrophobic that it was not fully in contact with the electrolyte and cause mass transport difficulty with the reactive species (especially dissolved oxygen molecular in the discharge process), it quickly reaches the cutoff value of 0.6 V for battery discharge. After functionalization of CSCs substrate, Func CSCs-0.2M and Func CSCs-2M substrates displayed a lower charge voltage and a higher discharge voltage, and thus a smaller voltage gap.

As shown in Table 6, the voltage gap at the 100^{th} cycle of Func CSCs-2M battery (1.16 V) decreased 130 mV compared to Func CSCs-0.2M substrate (1.29 V), and the corresponding round-trip efficiency increased from 37.2% and 41.3%.

The GCD curves of CSCs-based/MnOx at a current density of 2 mA cm⁻² were shown in FIG. 24A. After the 100^{th} cycle test, the gap of charge and discharge voltage of CSC/MnOx, Func CSCs-0.2M/MnOx. and Func CSCs-2M/MnOx batteries were 1.18, 0.98, and 0.89 V, respectively. And the round-trip efficiency at the 100^{th} cycle of these batteries was 42.4, 52.4, and 55.1%, separately. The lower voltage gap and the higher round-trip efficiency in the Func CSC/MnOx could be explained as a more adequate combination of CSCs with MnOx. Since CSCs were hydrophobic but Func CSCs were hydrophilic after electrochemical functionalization,^{[A35]} which result in more easy contact and to grow with MnOx during hydrothermal synthesis. Notably, the Func CSCs-2M/MnOx battery had a very stable discharge voltage, recharge voltage, as well as voltage gap, which might be attributed to the enhanced OER of Func CSCs substrate and the strong connection between the Func CSCs substrate and the MnOx.

TABLE 6
Comparison of Zn-air batteries performance of hybrid CSCs-based/MnOx.

| | Peak | | Discharge | Charge | | Round-trip | Discharge | Charge | | Round-trip |
|---|---|---|---|---|---|---|---|---|---|---|
| | power | Specific | voltage | voltage | Voltage | efficiency | voltage | voltage | Voltage | efficiency |
| | density/ | capacity/ | at 1^{st} | at 1^{st} | gap at 1^{st} | of 1^{st} | at 100^{th} | at 100^{th} | gap at 100^{th} | of 100^{th} |
| Catalyst | mW cm⁻² | mAh g⁻¹_{Zn} | cycle/V | cycle/V | cycle/V | cycle/% | cycle/V | cycle/V | cycle/V | cycle/% |
| CP | 0.0329 | — | — | 2.67 | — | — | 0.654 | 2.17 | 1.52 | 30.1 |
| CP/MnOx | 10.8 | 804.3 | 1.02 | 1.92 | 0.90 | 53.1 | 1.11 | 2.04 | 0.93 | 54.4 |
| Func CP | 6.35 | — | 1.12 | 1.7 | 0.58 | 65.9 | 0.97 | 2.03 | 1.06 | 47.8 |
| Func | 8.47 | 814.2 | 1.00 | 2.00 | 1.00 | 50.0 | 0.641 | 2.03 | 1.39 | 31.6 |
| CP/MnOx | | | | | | | | | | |
| CSCs | 0.0380 | — | — | 2.6 | — | — | — | 2.25 | — | — |
| CSCs/MnOx | 14.8 | 801.1 | 0.983 | 1.91 | 0.93 | 51.5 | 0.864 | 2.04 | 1.18 | 42.4 |
| Func CSCs | 3.18 | — | 0.787 | 1.77 | 0.98 | 44.5 | 0.767 | 2.06 | 1.29 | 37.2 |
| Func | 15.8 | 780.9 | 1.02 | 1.98 | 0.96 | 51.5 | 1.08 | 2.06 | 0.98 | 52.4 |
| CSCs/MnOx | | | | | | | | | | |

Notes:
^{a} Geometric area of electrode (0.785 cm²).
^{b} The applied current density for measuring the specific capacity is 2 mA cm⁻².
^{c-f} Charge and discharge voltage for bare substrate was cycled at 0.5 mA cm⁻², while those for MnOx was cycled at 2 mA cm⁻².

### Portable Electronic Applications

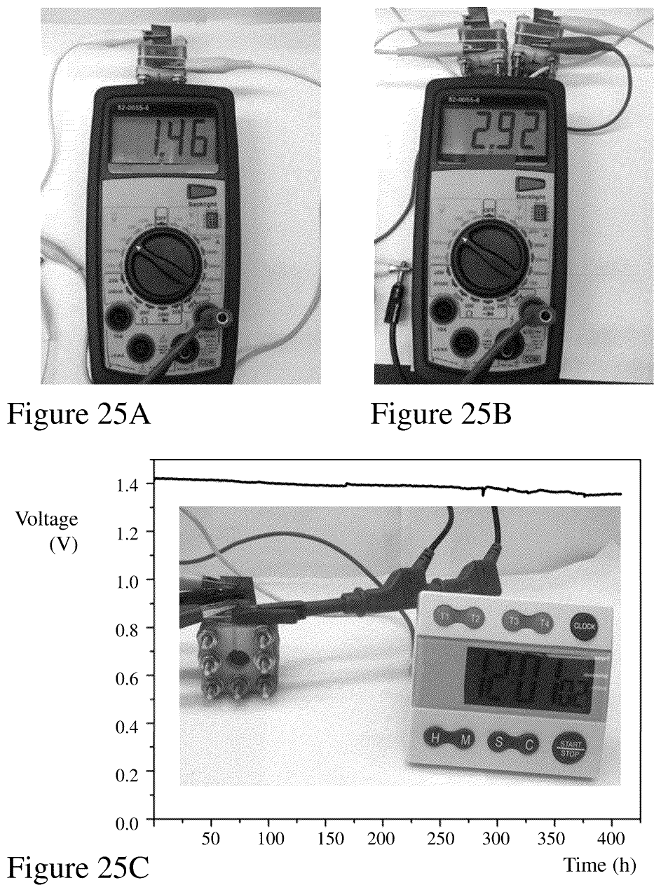

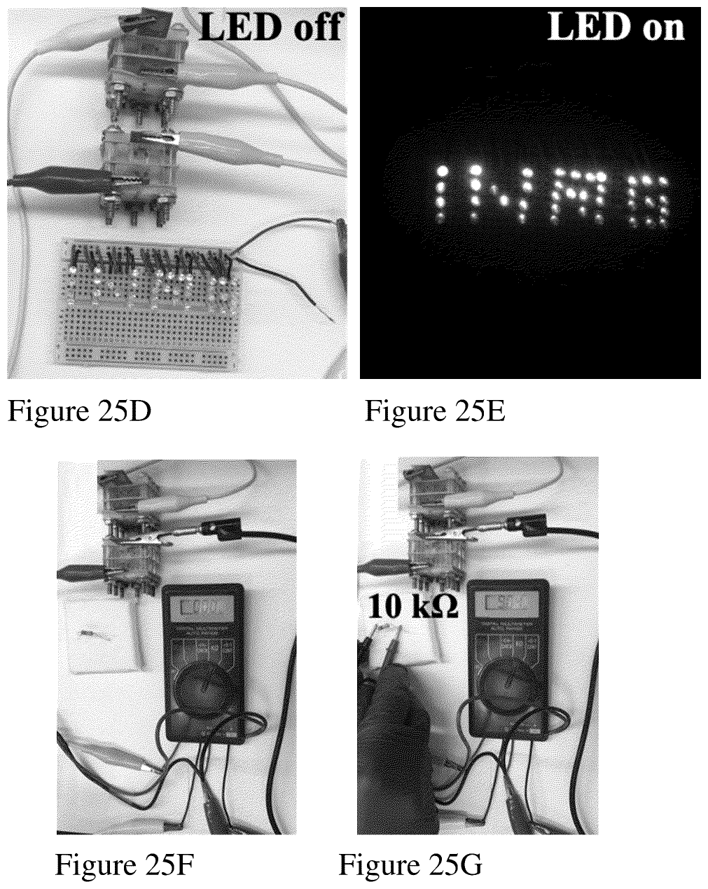

We tested some electronic applications by Func CSCs-0.2M/MnOx batteries. As shown in FIGS. 25A and 25B, the single and two series-connected Zn-air batteries delivered the OCP of ˜1.46 V and ˜2.92 V, respectively.

Proof-of-concept tests were further carried out to demonstrate the possibility of our Func CSCs-0.2M/MnOx batteries in several portable electronic applications. First, a single ZAB could successfully power a laboratory timer with a voltage around 1.4 V for 17 days (FIG. 25C). Then, two series-connected batteries are employed to successfully power LEDs for the INRS logo (depicted with LEDs off and on in FIGS. 25D and 25E respectively. A 3 V multimeter also could be functioned by two series-connected batteries which could well measure a resistor as high as 10 kΩ as shown in FIGS. 25F and 25G respectively.

### Post-Mortem Characterization

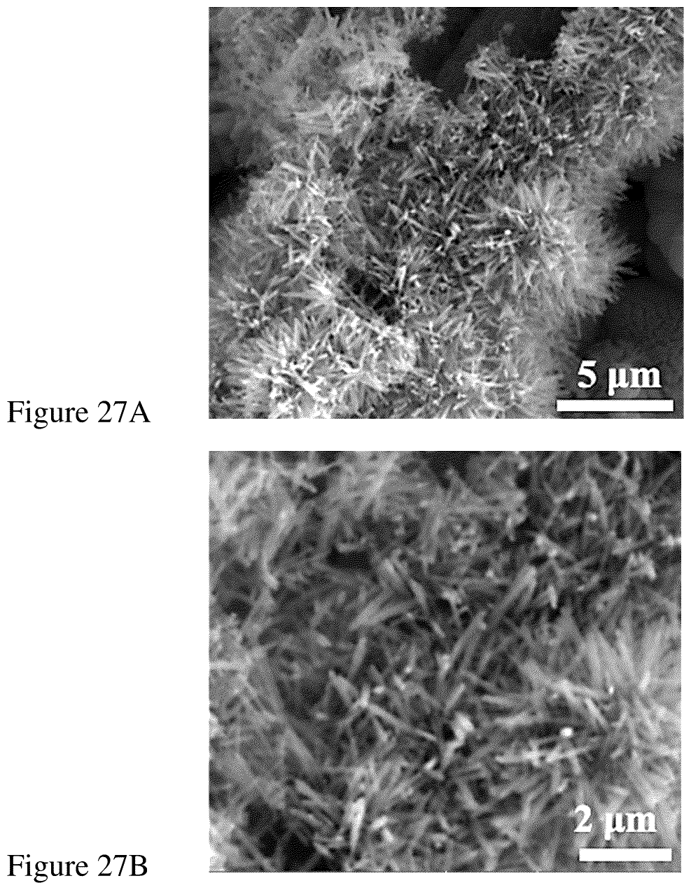

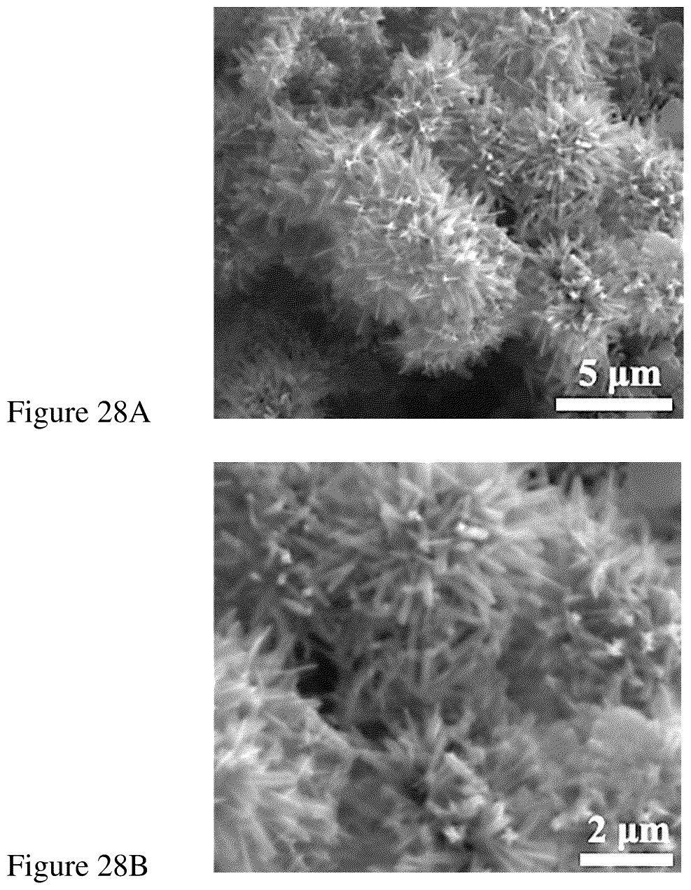

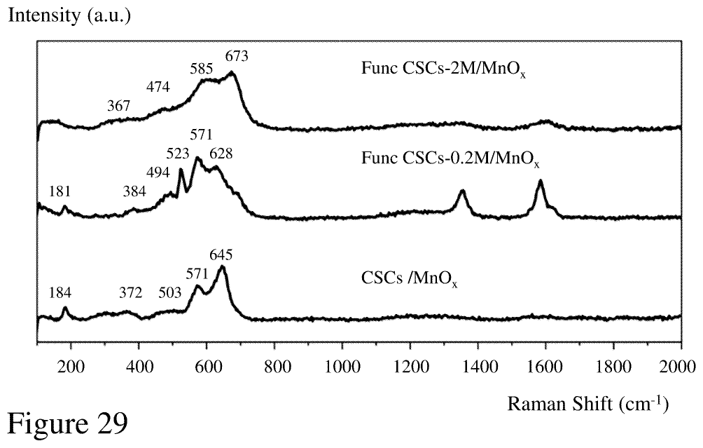

Post-mortem morphology examination (SEM and Raman) of the CSCs/MnOx-based cathodes were conducted to check the morphology and structure of the electrodes after battery cycling. The SEM images in FIG. 26A to 28B respectively show that the morphology of these CSCs/MnOx-based electrodes remained almost unchanged after battery cycling. The Raman spectra in FIG. 29 suggest that the α-MnOx structure remained. Both ex-situ SEM and Raman results demonstrate their excellent stability towards battery cycling.

Carbon Sphere Chain with Manganese Oxide Nanorod Doping and Doping Optimization

Within embodiments of the invention described and depicted above carbon sphere chains have been described with manganese oxide (MnOx) nanorods to provide an inventive electrocatalyst for use with an electrode within a battery. As noted within the description the MnOx nanorods these nanorods may be doped with a metal, for example with iron, nickel and cobalt. Subsequent to the experiments and development of the underlying CSCs/MnOx-based electrocatalyst the inventors performed additional experiments to optimize doping.

### Synthesis of Co- or Ni-doped CSCs/CP/MnOx.

The inventors prepared CSCs directly grown onto carbon paper (CSCs/CP) via the same CVD method outlined above for undoped CSCs/MnOx electrocatalysts. The electrochemical functionalization of the CSCs substrates was carried out with the cyclic voltammetry (CV) method in 2 mol L-1 HNO3 electrolyte for 15 cycles as outlined above yielding what the inventors notated as Func CSCs-2M/CP. The doped MnOx nanorods were grown onto the CSCs-based substrates through the same hydrothermal (HT) method.

Within the experiments presented above the nanorods were grown within an aqueous potassium permanganate solution (KMnO4) solution. Accordingly, the inventors added 0.42 mmol CoSO4·7H2O or NiSO4·6H2O were completely dissolved with 1.67 mmol KMnO4 in 18.75 mL deionized water (DI) (resistivity 18.2 MΩ·cm) followed by the addition of 0.42 mL concentrated hydrochloric (HCl) acid. The solutions were transferred to an autoclave reactor which was pre-placed with a piece of a substrate of CSCs/CP or Func CSCs-2M/CP. After the HT reaction at 140° C. for 12 hours, the samples were washed with DI water several times and then processed with an annealing process at 300° C. for 1 hour in air. To optimize the doping concentration, the inventors varied the Co and Ni content with the molar ratio of Co/KMnO4 or Ni/KMnO4 from 0.05 to 1.00 (0.05, 0.25. 0.50, and 1.00) with the designated substrate of Func CSCs-2M, which was denoted as Func CSCs-2M/CoyMnOx or Func CSCs-2M/NiyMnOx.

### SEM Images

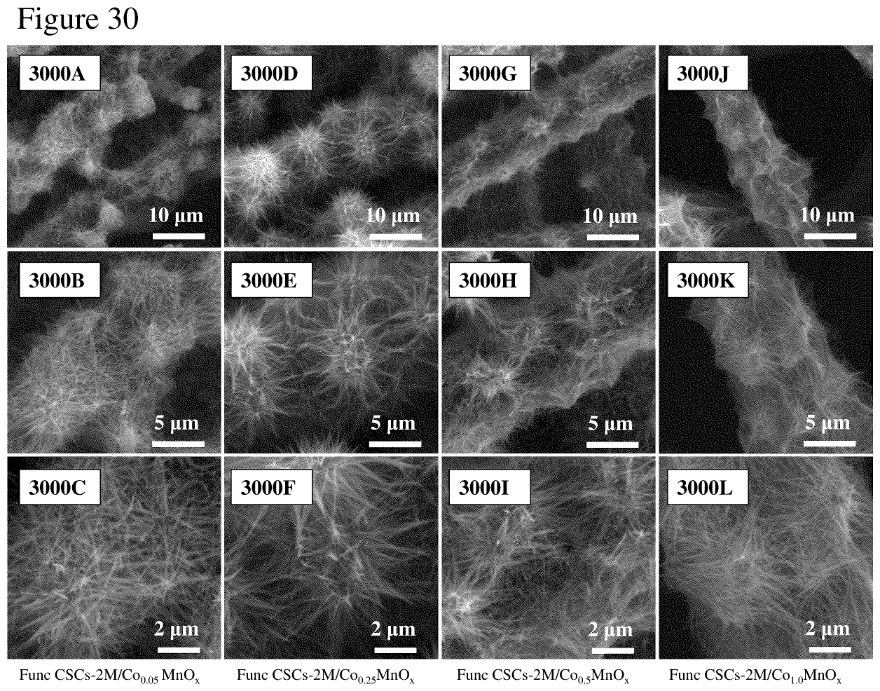

First to twelfth SEM images 3000A to 3000L in FIG. 30 respectively represent different magnifications for different doping levels of cobalt-doped Func CSCs-2M/MnOx samples are presented in FIG. 30. First to third Images 3000A to 3000C representing SEM images at 10 μm, 5 μm and 2 μm respectively for 0.05 molar ratio Func CSCs-2M/MnOx (Func CSCs-2M/Co_{0.05}MnOx), fourth to sixth Images 3000D to 3000F representing SEM images at 10 μm, 5 μm and 2 μm respectively for 0.25 molar ratio Func CSCs-2M/MnOx (Func CSCs-2M/Co_{0.25}MnOx), seventh to ninth Images 3000G to 3000I representing SEM images at 10 μm, 5 μm and 2 μm respectively for 0.50 molar ratio Func CSCs-2M/MnOx (Func CSCs-2M/Co_{0.50}MnOx), and tenth to twelfth Images 3000J to 3000L representing SEM images at 10 μm, 5 μm and 2 μm respectively for 1.00 molar ratio Func CSCs-2M/MnOx (Func CSCs-2M/Co_{1.0}MnOx).

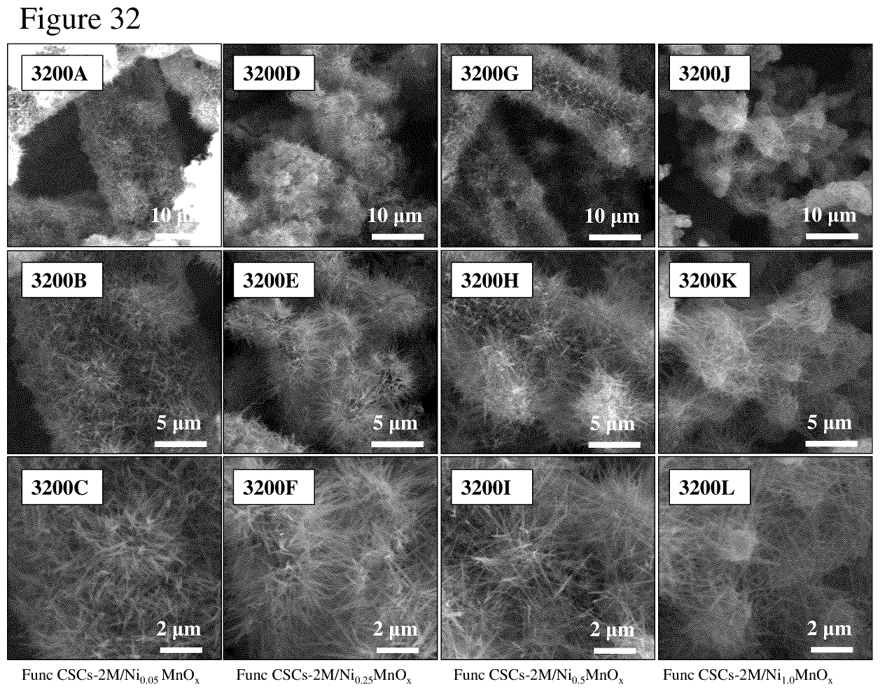

First to twelfth SEM images 3200A to 3200L in FIG. 32 respectively represent different magnifications for different doping levels of nickel-doped Func CSCs-2M/MnOx samples are presented in FIG. 32. First to third Images 3200A to 3200C representing SEM images at 10 μm, 5 μm and 2 μm respectively for 0.05 molar ratio Func CSCs-2M/MnOx (Func CSCs-2M/Ni_{0.05}MnOx), fourth to sixth Images 3200D to 3200F representing SEM images at 10 μm, 5 μm and 2 μm respectively for 0.25 molar ratio Func CSCs-2M/MnOx (Func CSCs-2M/Ni_{0.25}MnOx), seventh to ninth Images 3200G to 3200I representing SEM images at 10 μm, 5 μm and 2 μm respectively for 0.50 molar ratio Func CSCs-2M/MnOx (Func CSCs-2M/Ni_{0.50}MnOx), and tenth to twelfth Images 3200J to 3200L representing SEM images at 10 μm, 5 μm and 2 μm respectively for 1.00 molar ratio Func CSCs-2M/MnOx (Func CSCs-2M/Ni_{1.0}MnOx).

As evident in FIGS. 30 and 32 the Co- and Ni-doped MnOx samples revealed a morphology of nanowires radially grown on Func CSCs-2M substrates. The length of the doped MnOx nanorods or nanowires from SEM images mostly range from 2 μm to 4 μm. In addition, the nanowires in doped samples have a smaller diameter than the undoped Func CSCs-2M/MnOx samples, as listed in Table 1. Thus, the aspect ratio (length/diameter) of the doped samples is larger than the undoped ones.

TABLE 7
Diameter of nanorods or nanowires from SEM images

| As Prepared Samples | Diameter/nm |
|---|---|
| Func CSCs-2M/MnOₓ | ~135 |
| Func CSCs-2M/Co_{0.05}MnOₓ | ~85 |
| Func CSCs-2M/Co_{0.25}MnOₓ | ~70 |
| Func CSCs-2M/Co_{0.5}MnOₓ | ~65 |
| Func CSCs-2M/Co_{1.0}MnOₓ | ~65 |
| Func CSCs-2M/Ni_{0.05}MnOₓ | ~90 |
| Func CSCs-2M/Ni_{0.25}MnOₓ | ~75 |
| Func CSCs-2M/Ni_{0.5}MnOₓ | ~70 |
| Func CSCs-2M/Ni_{1.0}MnOₓ | ~70 |

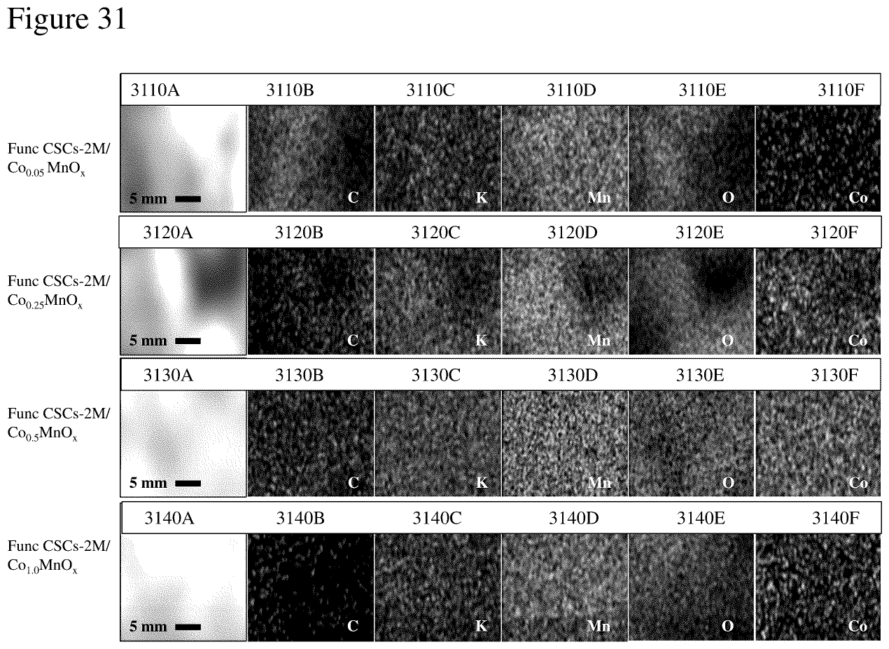

Referring to FIG. 31 there are depicted energy-dispersive X-ray spectroscopy (EDS) maps of cobalt-doped CSCs-2M/MnOx samples. First to sixth Images 3110A to 311F being SEM image and EDS images of C, K, Mn, O and Co respectively for 0.05 molar ratio Func CSCs-2M/MnOx (Func CSCs-2M/Co_{0.05}MnOx). Seventh to twelfth Images 3120A to 312F being SEM image and EDS images of C, K, Mn, O and Co respectively for 0.05 molar ratio Func CSCs-2M/MnOx (Func CSCs-2M/Co_{0.25}MnOx). Thirteenth to eighteenth Images 3130A to 313F being SEM image and EDS images of C, K, Mn, O and Co respectively for 0.50 molar ratio Func CSCs-2M/MnOx (Func CSCs-2M/Co_{0.50}MnOx). Nineteenth to twenty fourth Images 3140A to 3140F being SEM image and EDS images of C, K, Mn, O and Co respectively for 1.0 molar ratio Func CSCs-2M/MnOx (Func CSCs-2M/Co_{1.0}MnOx).

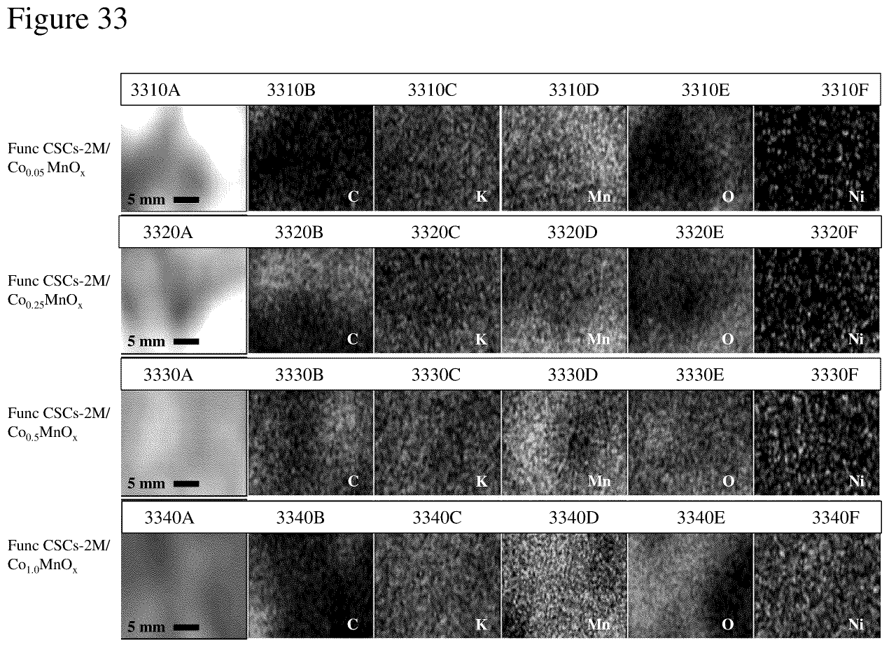

Similarly, FIG. 33 depicts energy-dispersive X-ray spectroscopy (EDS) maps of nickel-doped CSCs-2M/MnOx samples. First to sixth Images 3310A to 3310F being SEM image and EDS images of C, K, Mn, O and Ni respectively for 0.05 molar ratio Func CSCs-2M/MnOx (Func CSCs-2M/Ni_{0.05}MnOx). Seventh to twelfth Images 3320A to 332F being SEM image and EDS images of C, K, Mn, O and Ni respectively for 0.05 molar ratio Func CSCs-2M/MnOx (Func CSCs-2M/Ni_{0.25}MnOx). Thirteenth to eighteenth Images 3330A to 333F being SEM image and EDS images of C, K, Mn, O and Ni respectively for 0.50 molar ratio Func CSCs-2M/MnOx (Func CSCs-2M/Ni_{0.50}MnOx). Nineteenth to twenty fourth Images 3340A to 334F being SEM image and EDS images of C, K, Mn, O and Ni respectively for 1.0 molar ratio Func CSCs-2M/MnOx (Func CSCs-2M/Ni_{1.0}MnOx).

In each instance the mapping reveals the presence of the elements of C, K, Mn, O and Ni are evenly distributed on the surface of cobalt-doped Func CSCs-2M/MnOx samples, while the elements of C, K, Mn, O and Ni are evenly distributed on nickel-doped Func CSCs-2M/MnOx samples.

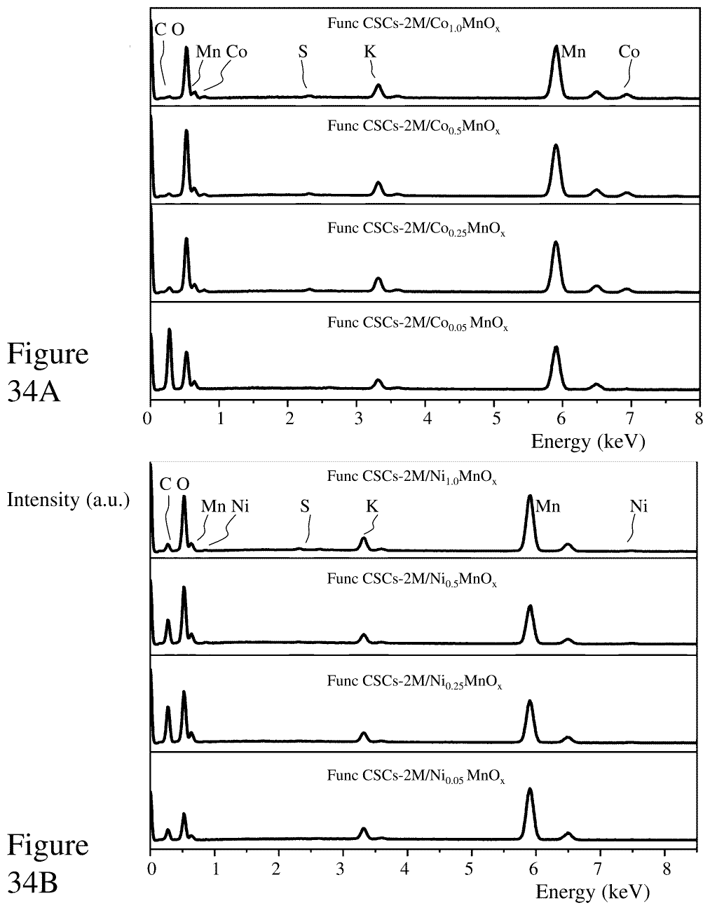

The EDS spectra depicted in FIGS. 34A and 34B for the cobalt and nickel doped Func CSCs-2M/MnOx samples further confirmed the presence of Co and Ni. In FIG. 34A the 0.783 eV and 6.943 eV peaks represent the characteristic X-ray energies (Lα1 and Kα1) of cobalt. In FIG. 34B the peaks at 0.853 eV and 7.483 eV represent the characteristic X-ray energies (Lα1 and Kα1) for nickel.

### Electrochemical Performance

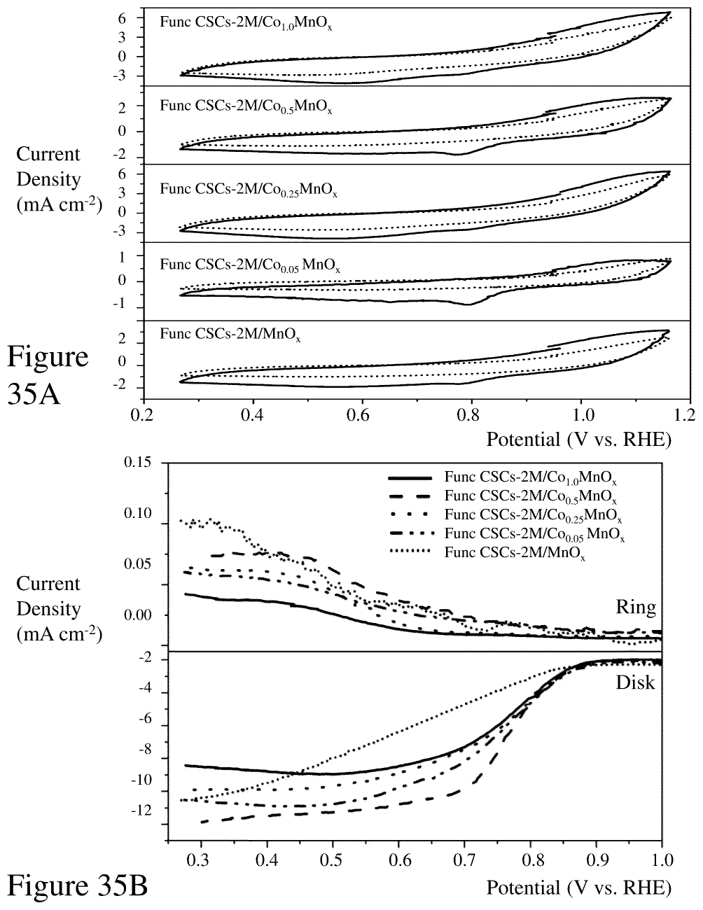

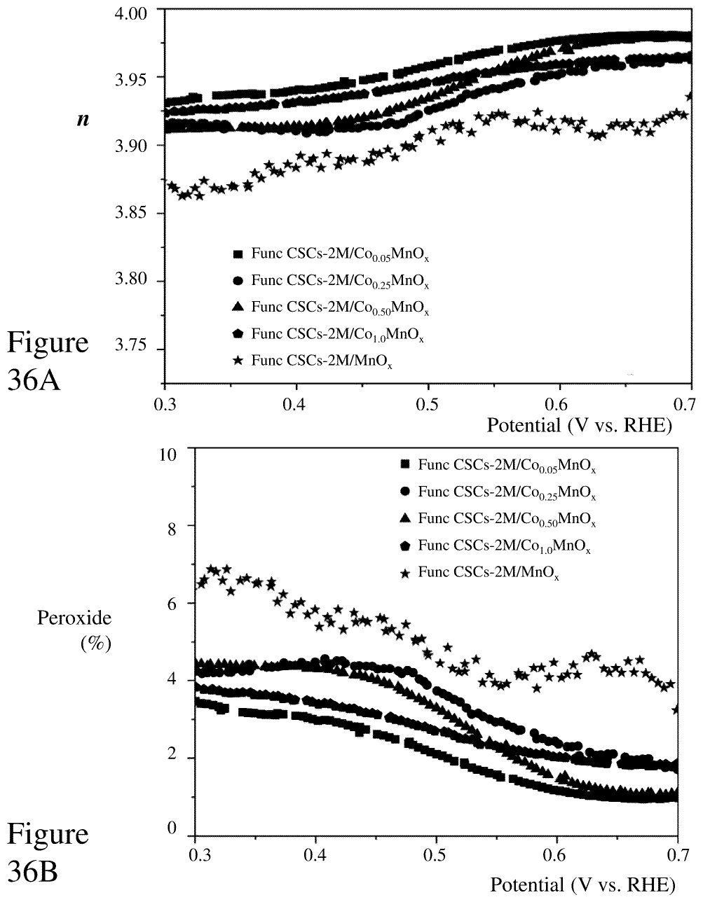

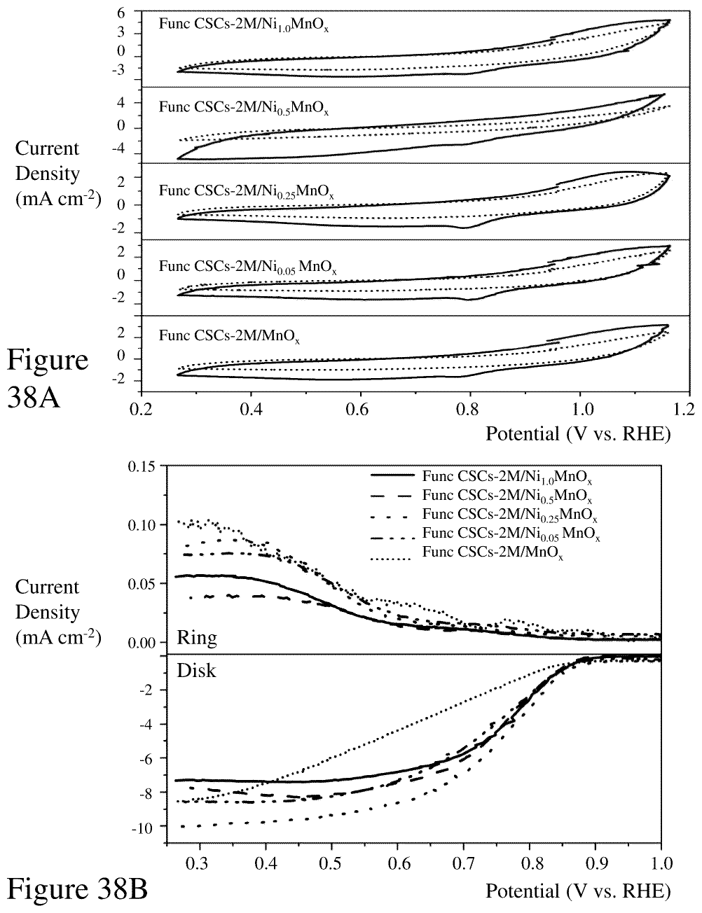

The inventors then proceed to establish measurements of the electrochemical performance of the nickel and cobalt doped Func CSCs-2M/MnOx samples. For ORR studies an initial study was conducted by recording cyclic voltammograms (CVs) in the absence of oxygen and presence of oxygen (N2-saturated) and presence of oxygen (O2-saturated) 0.1 M KOH electrolyte. These results are depicted in FIGS. 35A and 38A for the cobalt-doped Func CSCs-2M/MnOx and nickel-doped Func CSCs-2M/MnOx samples at the different dopant levels. These results being summarised in Table 8. Compared to the featureless profiles in N₂-saturated electrolyte, all four doped samples (CSCs/Co0.25MnOx, Func CSCs-2M/Co0.25MnOx, CSCs/Ni0.25MnOx, and Func CSCs-2M/Ni0.25MnOx) shows a cathodic peak around 0.79 V, ascribed to the electroreduction of oxygen.

In order to assess the ORR and OER electrochemical activity of as-prepared on-substrate samples, these were evaluated on a bipotentiostat equipped with RRDE. As outlined above different molar ratios of Co/Mn or Ni/Mn in raw chemical reagents (0.05, 0.25, 0.50, and 1.00) were investigated in Func CSCs-2M/MyMnOx (My=Co or Ni). These results are depicted in FIGS. 35B and 35B respectively for cobalt-doped Func CSCs-2M/MnOx and nickel-doped Func CSCs-2M/MnOx samples.

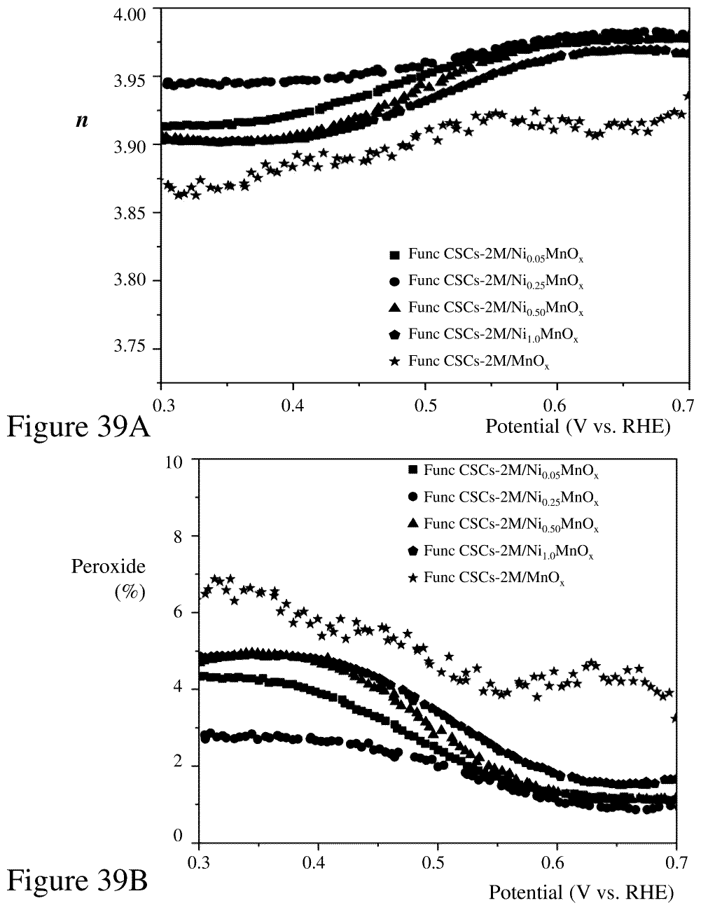

As evident from these figures both Co and Ni dopants greatly enhance the ORR activity compared to the undoped counterparts (Func CSCs-2M/MnOx) by over 160 mV positive in half-wave potential (E½). Further, as evident in FIGS. 36A and 39A higher charge transfer numbers (n) close to the theoretical value of 4.0 were achieved relative to the undoped samples. Similarly, both the Co and Ni doped samples yielded lower production of peroxide intermediates as evident from FIGS. 36B and 39B.

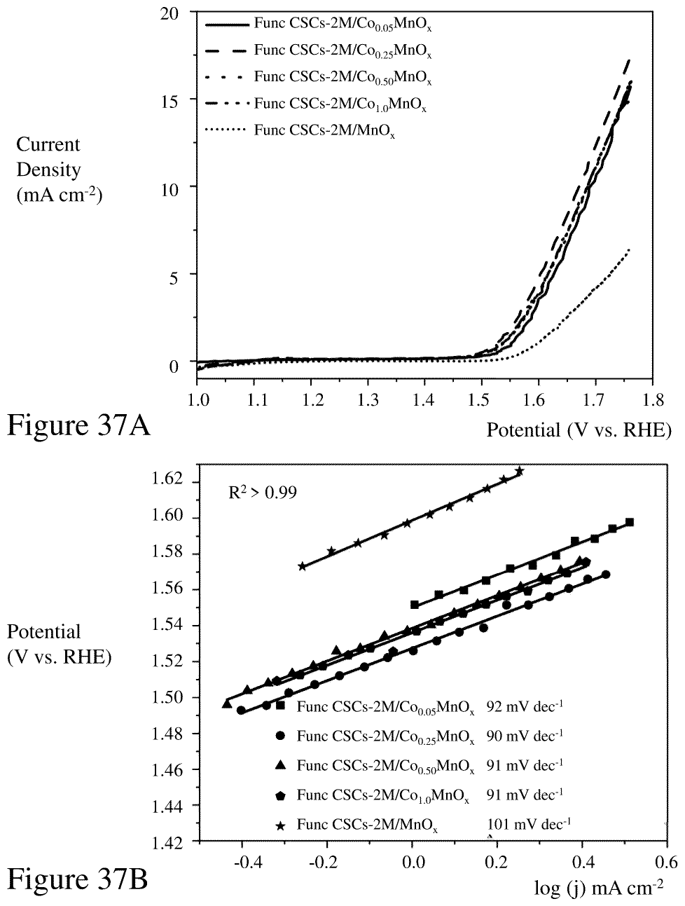

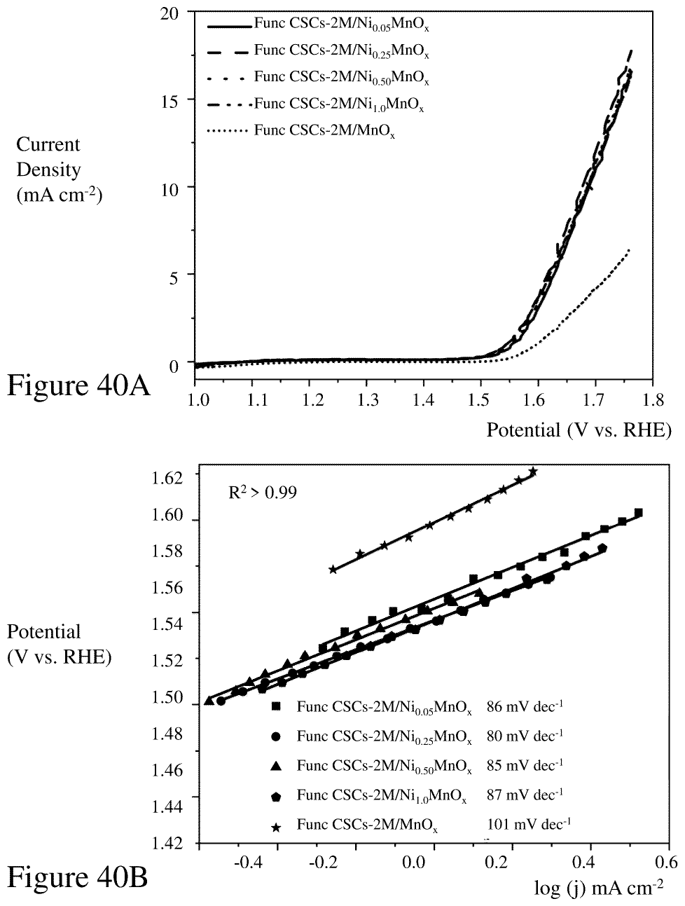

With respect to the OER activity, depicted in FIGS. 37A and 40A respectively for the Co and Ni doped samples, and summarised in Table 8 it is evident that these current densities exceeding 10 mA cm-2 at a maximum given the potential of 1.76 V. It has to be noted that undoped Func CSCs-2M/MnOx could not deliver current density as high as 10 mA cm-2. This demonstrates the higher performances obtained with the doped samples. From the various doping levels employed the inventors identified that the best performance was achieved for the ratio of 0.25 based upon these samples having the lowest potential at 10 mA cm-2, the highest current density at 1.7 V, and the lowest Tafel slope. The Tafel slopes for Co and Ni doped samples being depicted in FIGS. 37B and 40B respectively. It would be evident that based upon doping ratios employed of 0.05, 0.25 and 0.50 that additional experimentation may define a ratio offering enhanced performance to that of the ratio 0.25 between 0.05 and 0.25 or between 0.25 and 0.50.

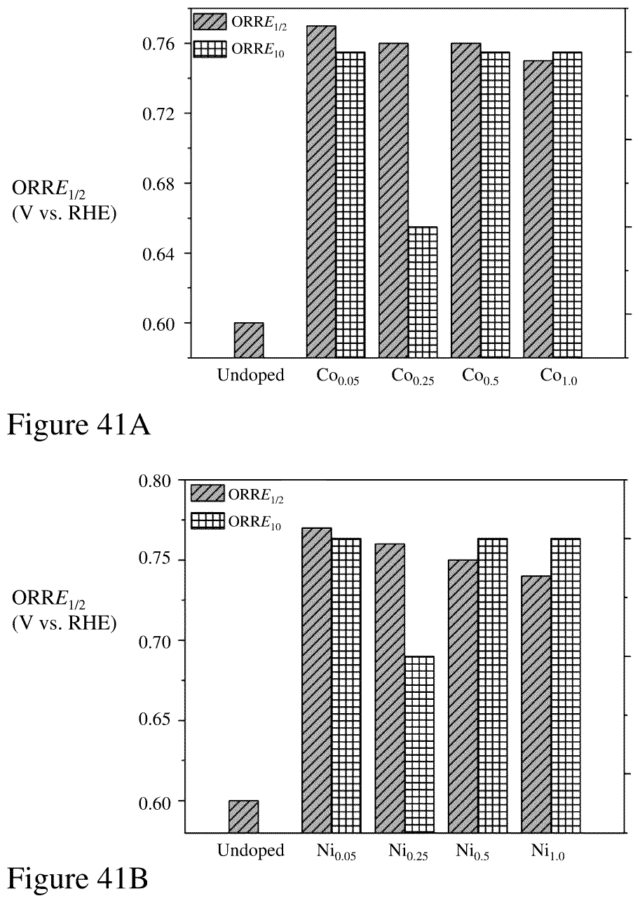

Both Co and Ni have a trend in ORR and OER activities, depicted in FIGS. 41A and 41B respectively. The ORR/OER bifunctionality is further evaluated by ΔE10-½, which is the potential difference in OER potential at 10 mA cm-2 and ORR half-wave potential. The ΔE10-½ values are presented in Table 8 which show a potential difference greater than 900 mV for the doped samples.

TABLE 8
Comparison of ORR/OER performance (RRDE) of optimization of CP/Func CSCs-2M/Co_{y}MnOₓ and CP/Func CSCs-2M/Ni_{y}MnOₓ electrodes

| | ORR | | | | | OER | | | | | |
|---|---|---|---|---|---|---|---|---|---|---|---|
| | | | Limiting | Electron | | Potential | Current | Tafel | | | |
| | Peak | Half-wave | current | transfer | Per- | at current | density | slope | | | |
| | potential | potential | density | number | oxides | density of | at 1.76 | (mV | ΔE_{2-1/2} | ΔE_{5-1/2} | ΔE_{10-1/2} |
| Catalyst | in CV/V | (E_{1/2})/V | (j_{L})/mA cm⁻² | (n) | % | 10 mA cm⁻²/V | V/mA cm⁻² | dec⁻¹) | (Volts) | (Volts) | (Volts) |
| Func CSCs- | 0.78 | 0.60 | 8.54 | 3.90 | 5.03 | — | 6.49 | 101 | 1.04 | 1.13 | — |
| 2M/MnOₓ | | | | | | | | | | | |
| Func CSCs- | 0.80 | 0.77 | 6.96 | 3.96 | 2.13 | 1.69 | 15.7 | 92 | 0.81 | 0.86 | 0.92 |
| 2M/Co_{0.05}MnOₓ | | | | | | | | | | | |
| Func CSCs- | 0.79 | 0.76 | 9.87 | 3.93 | 3.40 | 1.67 | 17.5 | 90 | 0.79 | 0.84 | 0.91 |
| 2M/Co_{0.25}MnOₓ | | | | | | | | | | | |
| Func CSCs- | 0.78 | 0.76 | 7.91 | 3.94 | 2.94 | 1.69 | 16.2 | 91 | 0.81 | 0.86 | 0.93 |
| 2M/Co_{0.5}MnOₓ | | | | | | | | | | | |
| Func CSCs- | 0.79 | 0.75 | 8.91 | 3.94 | 2.76 | 1.69 | 16.1 | 91 | 0.81 | 0.87 | 0.94 |
| 2M/Co_{1.0}MnOₓ | | | | | | | | | | | |
| Func CSCs- | 0.80 | 0.77 | 7.41 | 3.95 | 2.61 | 1.69 | 16.6 | 86 | 0.81 | 0.86 | 0.92 |
| 2M/Ni_{0.05}MnOₓ | | | | | | | | | | | |
| Func CSCs- | 0.79 | 0.76 | 8.30 | 3.96 | 1.97 | 1.68 | 17.7 | 80 | 0.81 | 0.86 | 0.92 |
| 2M/Ni_{0.25}MnOₓ | | | | | | | | | | | |
| Func CSCs- | 0.79 | 0.75 | 10.04 | 3.94 | 2.98 | 1.69 | 16.9 | 85 | 0.84 | 0.87 | 0.94 |
| 2M/Ni_{0.5}MnOₓ | | | | | | | | | | | |
| Func CSCs- | 0.79 | 0.74 | 8.58 | 3.93 | 3.30 | 1.69 | 16.4 | 87 | 0.83 | 0.88 | 0.95 |
| 2M/Ni_{1.0}MnOₓ | | | | | | | | | | | |

### Battery Performance

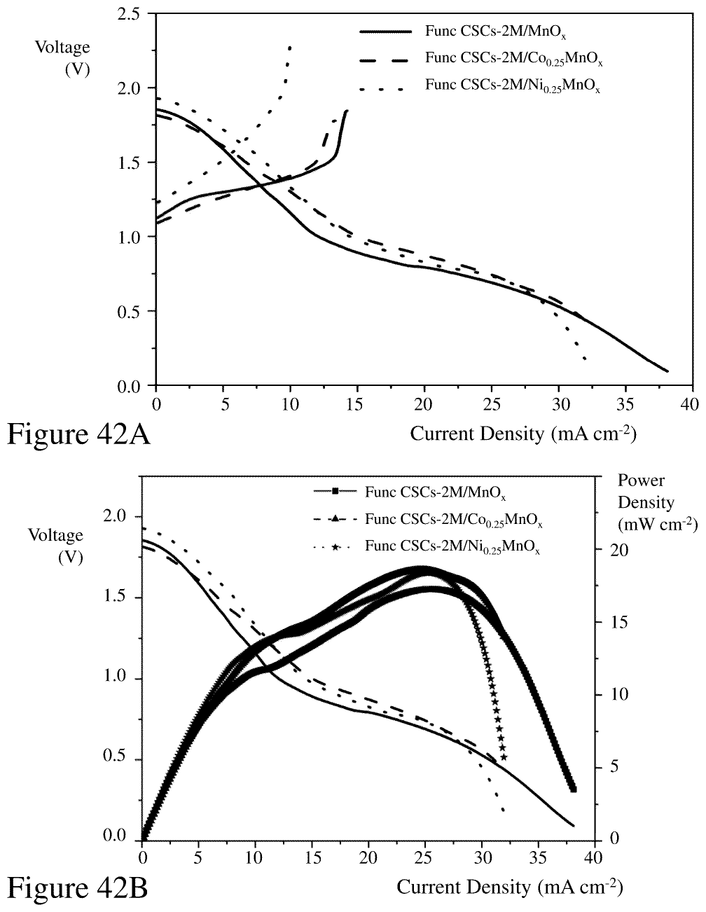

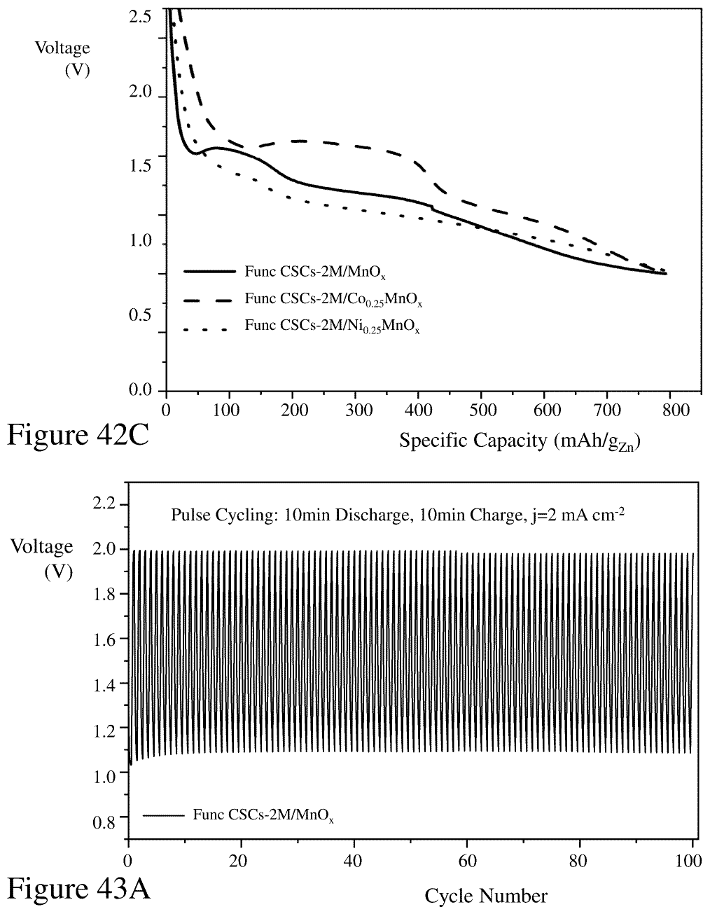

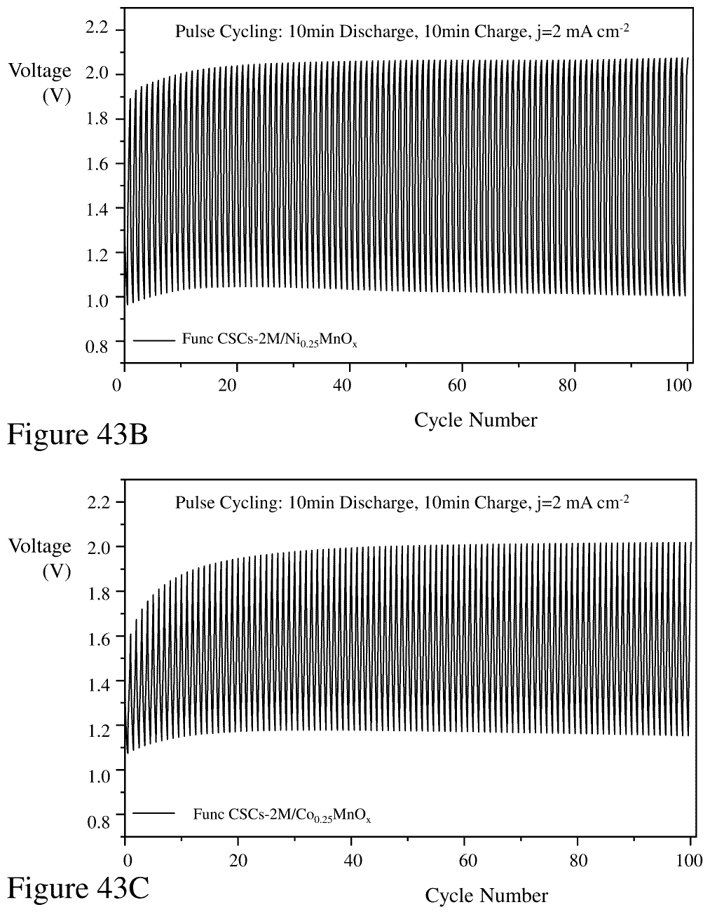

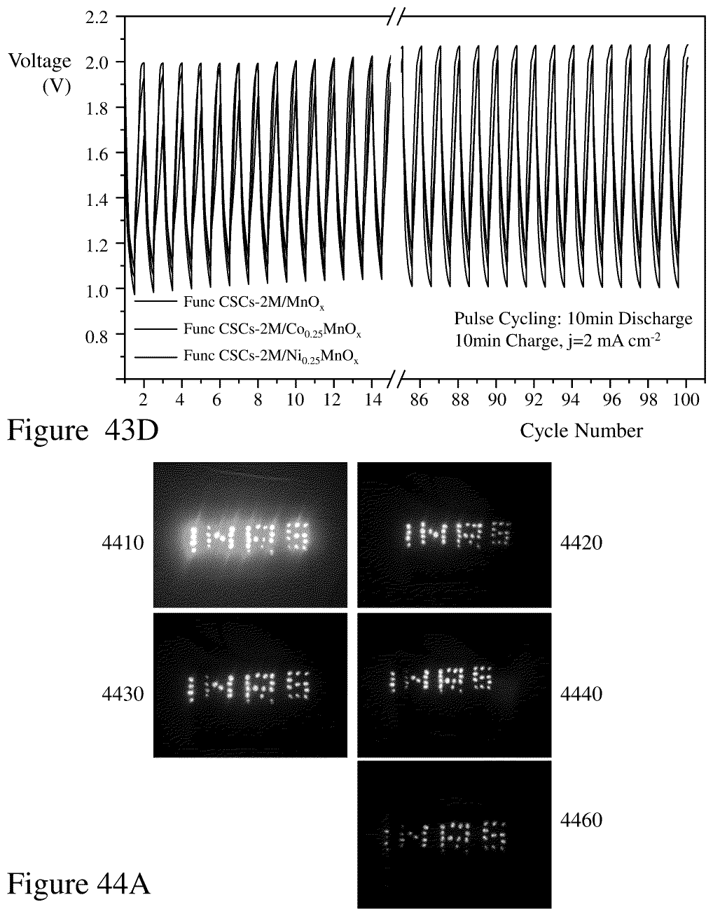

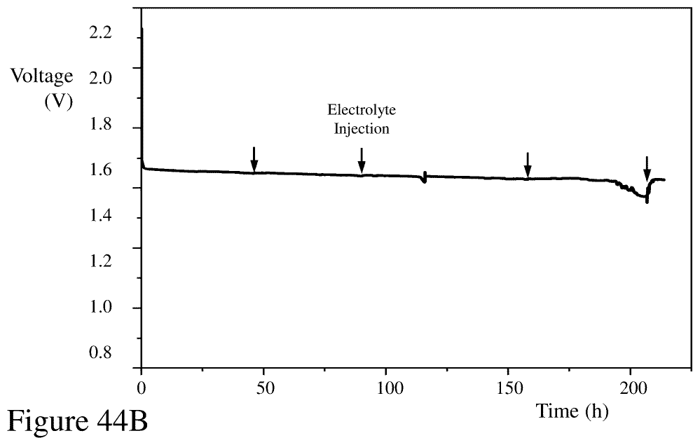

The as-prepared doped CSCs-based samples with the preferred doping content (y=0.25) were used as cathodes and were assembled in a homemade zinc-air battery. The results of the ZAB performance are presented in FIGS. 42A to 43D respectively and summarised in Table 9.

Referring to FIG. 42A there are depicted the discharge and charge polarization curves. As shown in FIG. 42B, the power density of ZAB-Func CSCs-2M/Co0.25MnOx, and ZAB-Func CSCs-2M/Ni0.25MnOx are 18.6, and 18.4 mW cm-2, respectively, which are higher than their undoped Func CSC-2M/MnOx, counterparts which demonstrated 17.3 mW cm-2). Accordingly, the power density of doped CSCs/MnOx-based batteries is improved by either Co or Ni doping. The specific capacity of the zinc-air battery was evaluated by a full-discharge test at a fixed current density of 2 mA cm-2. As shown in FIG. 42C, the specific capacity ranges from 791.53 to 805.59 mAh gZn-1, which is still very close to the theoretical value of 820 mAh gZn-1.

Now referring to FIGS. 43A to 43D there are depicted the results of galvanostatic charge and discharge (GCD) tests performed at a current density of 2 mA cm-2. The Co-doped cathode Func CSCs-2M/Co0.25MnOx exhibited a higher round-trip efficiency at the 100th cycle of 56.9%, which is more stable than their undoped counterparts as evident from the results in Table 9.

TABLE 9
Comparison of Zn-air batteries performance of doped CSCs/MnOx

| | Peak | | Discharge | Charge | | Round-trip | Discharge | Charge | | Round-trip |
|---|---|---|---|---|---|---|---|---|---|---|
| | power | Specific | voltage | voltage | Voltage | efficiency | voltage | voltage | Voltage | efficiency |
| | density/ | capacity/ | at 1^{st} | at 1^{st} | gap at 1^{st} | of 1^{st} | at 100^{th} | at 100^{th} | gap at 100^{th} | of 100^{th} |
| Catalyst | mW cm⁻² | mAh g_{Zn}⁻¹ | cycle/V | cycle/V | cycle/V | cycle/% | cycle/V | cycle/V | cycle/V | cycle/% |
| Func CSCs- | 17.3 | 792.0 | 1.03 | 2.00 | 0.97 | 51.5 | 1.09 | 1.98 | 0.89 | 55.1 |
| 2M/MnOₓ | | | | | | | | | | |
| Func CSCs- | 18.6 | 791.53 | 1.07 | 1.61 | 0.54 | 66.5 | 1.15 | 2.02 | 0.87 | 56.9 |
| 2M/Co_{0.25}MnOₓ | | | | | | | | | | |
| Func CSCs- | 18.4 | 805.59 | 0.96 | 1.89 | 0.93 | 50.8 | 1.00 | 2.08 | 1.08 | 48.1 |
| 2M/Ni_{0.25}MnOₓ | | | | | | | | | | |

Within the foregoing disclosure embodiments of the present invention have been described as comprising manganese oxide (MnOx) nanorods. However, other embodiments of the invention may employ nanorods of one or more other non-noble metal oxides discretely or in conjunction with the MnOx nanorods. These non-noble metal oxides may include, for example, titanium dioxide (TiO2), cerium oxide (CeO2), cobalt oxide (CoO), manganese (II,III) oxide (Mn3O4), tungsten oxide (WO3), iron oxide (Fe2O3), copper oxide (CuO), vanadium oxide (V2O5), zinc oxide (ZnO), and lanthanum oxide (La2O3).

Other embodiments of the invention may employ nanorods of one or more perovskites discretely or in conjunction with the non-noble metal oxide nanorods. Such perovskites being defined generally by a chemical formula ABX3, where A and B represent cations and X is an anion bonds to both. Such perovskites may include oxides, fluorides, chlorides, hydroxides, arsenides, and intermetallic compounds. Such perovskites may be natural perovskites or synthetic perovskites and may include metallic perovskites, hybrid organic-inorganic perovskites, and metal-free perovskites.

Other embodiments of the invention may employ carbon nanotubes (CNTs) discretely or in conjunction with one or more of nanorods of one or more non-noble metal oxides and nanorods of one or more perovskites.

Other embodiments of the invention may employ one or more catalysts in conjunction with one or more of CNTs, nanorods of one or more non-noble metal oxides and nanorods of one or more perovskites.

Within the foregoing disclosure embodiments of the present invention have been described as comprising nanorods. A nanorod as used herein refers to one morphology of nanoscale objects having a longitudinal dimension greater than a lateral dimension. A nanorod may, for example, have an aspect ratio of 2, 3, 5 or more and may include, but not be limited to, a nanowire, a nanopillar, a nanotube, a nanowhisker or another nanostructure. The cross-section of a nanorod may be uniform, non-uniform, a regular polygon, an irregular polygon, circular or elliptical.

Whilst the embodiments of the invention have been described and presented with respect to electrodes for batteries other embodiments of the invention may be employed within other applications by supporting other electrochemical reactions and/or processes.

Whilst the electrocatalyst has been described and presented with respect to its being formed upon an electrode comprising a current collector other embodiments of the invention may be employed with the electrocatalyst formed upon or disposed upon another surface or material.

Whilst the electrocatalyst has been described and presented with respect to its being formed upon an electrode comprising a current collector other embodiments of the invention may be employed with the electrocatalyst dispersed within a fluid.

The foregoing disclosure of the embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents. The scope of the claims should not be limited by the preferred embodiments set forth in the examples, but should be given the broadest interpretation consistent with the description as a whole.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A material comprising:
an electrocatalyst comprising carbon sphere chains attached on a catalytically active surface of a current collector; wherein
the carbon sphere chains extend away from the catalytically active surface;
the carbon sphere chains have functionalized surfaces that bear oxygen-containing functional groups; and
nanorods are attached to the functionalized surfaces of the carbon sphere chains by an end and extend away from said functionalized surfaces.

2. The material according to claim 1, wherein
at least one of:
the oxygen-containing functional groups have an I_{D}/I_{G} ratio greater than the I_{D}/I_{G} ratio of non-functionalized carbon sphere chains;
the nanorods are formed from at least one of a non-noble oxide, a perovskite and a carbon nanotube; and
the nanorods further comprise a catalyst disposed upon the nanorods.

3-4. (canceled)

5. The material according to claim 1, wherein
the current collector forms part of an electrode; and
at least one of:
the electrode forms part of one of a metal-air battery, a zinc-air battery, an air-breathing polymer electrolyte fuel cell and a water electrolyser;
the current collector is at least one of a carbon paper, a carbon cloth, a nickel foil, a titanium foil, a copper foil, a silicon substrate and a metal grid; and
the electrode is one of an oxygen reduction reaction (ORR) electrode, an oxygen evolution reaction (OER) electrode and a bifunctional ORR and OER electrode.

6. The material according to claim 1, wherein
at least one of:
the current collector comprises a layer of another material that is catalytically active toward the growth of carbon sphere chains;
the current collector comprises a layer of another material that is catalytically active toward the growth of carbon sphere chains where the another material comprises at least one of nickel, iron, cobalt and a nickel-cobalt alloy; and
the current collector comprises a layer of another material that is catalytically active toward the growth of carbon sphere chains where the layer of the material has a thickness of one of between 1 nm and 10 nm, between about 3 nm and 7 nm and between 4 nm and 6 nm.

7. (canceled)

8. The material according to claim 1, wherein
at least one of:
the carbon spheres in the carbon sphere chains have diameters between 300 nm and 1200 nm;
have a size distribution such that 80% having a size between 600 nm and about 800 nm;
the carbon spheres in the carbon sphere chains have a sphericity Ψ of one of 1, 0.95 or more, 0.98 or more, and 0.99 or more;
the carbon sphere chains have a specific surface area of one of between 1 and 10 m²/g and between 5 about 9 m²/g; and
the oxygen-containing functional groups are at least one of hydroxyl groups, quinonyl groups and carboxyl groups.

9-11. (canceled)

12. The material according to claim 1, wherein
the oxygen-containing functional groups have an I_{D}/I_{G} ratio greater than the I_{D}/I_{G} ratio of non-functionalized carbon sphere chains; and
the I_{D}/I_{G} ratio of the oxygen-functional bearing groups is one of greater than 2.0, greater than 2.1, and greater than 2.2.

13. The material according to claim 1, wherein
at least one of:
the functionalized surface of the carbon sphere chains further bears carbon nanobuds;
the nanorods are at least one of between 0.4 mm and 3 mm in length and between 10 nm and 200 nm in diameter.
the nanorods have a density of 3 or more nanorods per square μm².

14-15. (canceled)

16. The material according to claim 1, wherein
the nanorods are MnOx nanorods that have one of:
an α-MnO2 crystalline structure;
an α-MnO2 crystalline structure comprising potassium; and
an α-MnO2 crystalline structure of KMn₈O₁₆.

17. The material according to claim 1, wherein
the nanorods are MnOx nanorods; and
at least one of:
the atomic ratio Mn/K in the electrocatalyst is between 5.65 and 8;
the MnOx nanorods are doped with a metal; and
the MnOx nanorods are doped with one of iron, nickel and cobalt.

18. A method of manufacturing a material comprising:
providing a current collector having a surface that is catalytically active towards the growth of carbon sphere chains;
growing carbon sphere chains on the surface that is catalytically active, wherein the carbon sphere chains (CSCs) extend away from the current collector;
functionalizing surfaces of the CSCs so said surfaces of the CSCs bears oxygen-containing functional groups; and
growing nanorods on said surfaces of the CSCs, wherein the nanorods have an end attached to said surface and extend away from the surfaces of the CSCs.

19. The method according to claim 18, wherein
at least one of:
the oxygen-containing functional groups have an I_{D}/I_{G} ratio greater than the I_{D}/I_{G} ratio of non-functionalized carbon sphere chains; and
the nanorods are formed from at least one of a non-noble oxide, a perovskite and a carbon nanotube.

20. (canceled)

21. The material according to claim 18, further comprising
a catalyst is disposed upon the nanorods.

22. The method according to claim 18, wherein
either:
the current collector does not have a natural catalytically active surface and the method further comprises depositing a layer of a material that is catalytically active toward the growth of carbon sphere chains on a surface of the current collector prior to the step of growing the carbon sphere chains;
or:
the current collector does not have a natural catalytically active surface, the method further comprises depositing a layer of a material that is catalytically active toward the growth of carbon sphere chains on a surface of the current collector prior to the step of growing the carbon sphere chains and the layer of the material is deposited by pulsed laser deposition (PLD).

23-24. (canceled)

25. The method according to claim 18, wherein
one of:
the carbon sphere chains are grown by chemical vapor deposition (CVD);
functionalizing the surfaces of the CSCs is achieved by electrochemical oxidation with a cyclic voltammetry (CV) procedure; and
functionalizing the surfaces of the CSCs is achieved by oxidation.

26. (canceled)

27. The method according to claim 18, wherein
functionalizing the surfaces of the CSCs is achieved by electrochemical oxidation with a cyclic voltammetry (CV) procedure; and
the electrolyte employs a nitric acid (HNO₃) aqueous solution with a HNO₃ concentration of one of between 0.1 molar (M) and 2 M, 0.2 M, and 2M.

28. The method according to claim 18, wherein
at least one of:
the MnOx nanorods are grown by hydrothermal synthesis; and
the MnOx nanorods are doped with a metal and the MnOx nanorods are grown by hydrothermal synthesis within a manganese-containing aqueous solution containing a sulfate salt of the doping metal.

29. (canceled)

30. An electrocatalyst comprising:
a plurality of carbon sphere chains, each carbon sphere chain having a functionalized surface comprising oxygen-containing functional groups; and
a plurality of nanorods, each nanorod having an end attached to a region of the functionalized surface of a carbon sphere chain of the plurality of carbon sphere chains and extending away from the functionalized surface.

31. The electrocatalyst according to claim 30, wherein
at least one of:
the nanorods are formed from at least one of a non-noble oxide, a perovskite and a carbon nanotube; and
a catalyst is disposed upon the nanorods.

32. (canceled)

33. The electrocatalyst according to claim 30, wherein
at least one of:
the plurality of carbon sphere chains are attached to a surface of a current collector and the carbon sphere chains extend away from the surface; and
the oxygen-containing functional groups have an ID/IG ratio greater than the ID/IG ratio of non-functionalized carbon sphere chains.

34. (canceled)

35. The electrocatalyst according to claim 30, wherein
at least one of:
the electrocatalyst forms part of an electrode for one of a metal-air battery, a zinc-air battery, an air-breathing polymer electrolyte fuel cell and a water electrolyser; and
the electrocatalyst forms part of an electrode that is one of an oxygen reduction reaction (ORR) electrode, an oxygen evolution reaction (OER) electrode and a bifunctional ORR and OER electrode.

36-39. (canceled)
